(19) United States
(12) Patent Application Publication
(10) Pub. No.: US 2025/0193052 A1
(43) Pub. Date: Jun. 12, 2025

(54) WIRELESS SENSING IN NETWORK OF NETWORKS WITH CODED ADDRESSES TO IDENTIFY ORIGINATING DEVICES

(71) Applicants: Hung-Quoc Duc Lai, Parkville, MD (US); Chun-I Chen, Brookeville, MD (US); David N. Claffey, Somerville, MA (US); Joseph Gwin, Rockville, MD (US); Simon Xi, Rockville, MD (US); Daniel Bugos, Baltimore, MD (US); Mike Stoller, Rockville, MD (US); Beibei Wang, Clarksville, MD (US); K.J. Ray Liu, Potomac, MD (US); Oscar Chi-Lim Au, Rockville, MD (US)

(72) Inventors: Hung-Quoc Duc Lai, Parkville, MD (US); Chun-I Chen, Brookeville, MD (US); David N. Claffey, Somerville, MA (US); Joseph Gwin, Rockville, MD (US); Simon Xi, Rockville, MD (US); Daniel Bugos, Baltimore, MD (US); Mike Stoller, Rockville, MD (US); Beibei Wang, Clarksville, MD (US); K.J. Ray Liu, Potomac, MD (US); Oscar Chi-Lim Au, Rockville, MD (US)

(21) Appl. No.: 18/991,634

(22) Filed: Dec. 22, 2024

Related U.S. Application Data
(63) Continuation-in-part of application No. PCT/US22/45708, filed on Oct. 4, 2022.
(63) Continuation-in-part of application No. 17/827,902, filed on May 30, 2022.
(63) Continuation-in-part of application No. 17/838,228, filed on Jun. 12, 2022.
(63) Continuation-in-part of application No. 17/838,231, filed on Jun. 12, 2022.
(63) Continuation-in-part of application No. 17/838,244, filed on Jun. 12, 2022, now Pat. No. 12,216,190.
(63) Continuation-in-part of application No. 17/149,625, filed on Jan. 14, 2021.
(63) Continuation-in-part of application No. 17/537,432, filed on Nov. 29, 2021.
(63) Continuation-in-part of application No. 17/959,487, filed on Oct. 4, 2022, now Pat. No. 12,272,375.
(63) Continuation-in-part of application No. 17/960,080, filed on Oct. 4, 2022.
(63) Continuation-in-part of application No. 18/108,563, filed on Feb. 10, 2023.
(63) Continuation-in-part of application No. 18/199,963, filed on May 21, 2023.
(63) Continuation-in-part of application No. 18/379,622, filed on Oct. 12, 2023, now Pat. No. 12,256,360.
(63) Continuation-in-part of application No. 63/614,621, filed on Dec. 24, 2023.
(63) Continuation-in-part of application No. 18/391,529, filed on Dec. 20, 2023.
(63) Continuation-in-part of application No. 18/395,533, filed on Dec. 23, 2023.
(63) Continuation-in-part of application No. 18/395,539, filed on Dec. 23, 2023.
(63) Continuation-in-part of application No. 18/395,543, filed on Dec. 23, 2023.
(63) Continuation-in-part of application No. 18/395,537, filed on Dec. 23, 2023.
(63) Continuation-in-part of application No. 18/395,544, filed on Dec. 23, 2023.
(63) Continuation-in-part of application No. 18/401,684, filed on Jan. 1, 2024.
(63) Continuation-in-part of application No. 18/401,681, filed on Jan. 1, 2024.
(60) Provisional application No. 63/721,406, filed on Nov. 15, 2024.
(60) Provisional application No. 63/651,921, filed on May 24, 2024.

(51) Int. Cl. H04L 25/02; H04L 5/00; H04W 8/00

(52) U.S. Cl. CPC H04L 25/0224; H04L 5/0048; H04W 8/005

(57) ABSTRACT

Wireless sensing using classifier probing and refinement is described. In one example, a described method comprises: computing output analytics by a classifier based on input data constructed based on raw measurement data; mapping each output analytics to a respective mapped outcome; identifying at least one reference input data each associated with a reference output analytics and a reference mapped outcome; each reference input data being one of the input data for the classifier for which a respective reference outcome is available and is different from the reference mapped outcome; and for each reference input data for the classifier: computing a respective plurality of perturbed output analytics by the classifier, generating selected perturbed input data based on the plurality of perturbed output analytics; and re-training the classifier based on the selected perturbed input data and the associated reference outcome.

### CROSS-REFERENCE TO RELATED APPLICATIONS

The present application hereby incorporates by reference the entirety of the disclosures of, and claims priority to, each of the following cases:
(a) U.S. Provisional Patent application 63/721,406, entitled “METHOD, APPARATUS, AND SYSTEM FOR WIRELESS SENSING”, filed on Nov. 15, 2024,
(b) U.S. Provisional Patent application 63/651,921, entitled “METHOD, APPARATUS, AND SYSTEM FOR WIRELESS SENSING IN NETWORK OF NETWORKS WITH INTER-NETWORK SOUNDING”, filed on May 24, 2024.
(c) U.S. Provisional Patent application 63/614,621, entitled “METHOD, APPARATUS, AND SYSTEM FOR WIRELESS SENSING”, filed on Dec. 24, 2023.
(d) U.S. patent application Ser. No. 17/149,625, entitled “METHOD, APPARATUS, AND SYSTEM FOR WIRELESS MONITORING WITH MOTION LOCALIZATION”, filed on Jan. 14, 2021.
(c) U.S. patent application Ser. No. 17/537,432, entitled “METHOD, APPARATUS, AND SYSTEM FOR AUTOMATIC AND ADAPTIVE WIRELESS MONITORING AND TRACKING”, filed on Nov. 29, 2021,
(f) U.S. patent application Ser. No. 17/827,902, entitled “METHOD, APPARATUS, AND SYSTEM FOR SPEECH ENHANCEMENT AND SEPARATOIN BASED ON AUDIO AND RADIO SIGNALS”, filed on May 30, 2022.
(g) U.S. patent application Ser. No. 17/838,228, entitled “METHOD, APPARATUS, AND SYSTEM FOR WIRELESS SENSING BASED ON CHANNEL INFORMATION”, filed on Jun. 12, 2022.
(h) U.S. patent application Ser. No. 17/838,231, entitled “METHOD, APPARATUS, AND SYSTEM FOR IDENTIFYING AND QUALIFYING DEVICES FOR WIRELESS SENSING”, filed on Jun. 12, 2022,
(i) U.S. patent application Ser. No. 17/838,244, entitled “METHOD, APPARATUS, AND SYSTEM FOR WIRELESS SENSING BASED ON LINKWISE MOTION STATISTICS”, filed on Jun. 12, 2022,
(j) U.S. patent application Ser. No. 17/959,487, entitled “METHOD, APPARATUS, AND SYSTEM FOR VOICE ACTIVITY DETECTION BASED ON RADIO SIGNALS”, filed on Oct. 4, 2022.
(k) U.S. patent application Ser. No. 17/960,080, entitled “METHOD, APPARATUS, AND SYSTEM FOR ENHANCED WIRELESS MONITORING OF VITAL SIGNS”, filed on Oct. 4, 2022.
(l) PCT Patent application PCT/US22/45708, entitled “METHOD, APPARATUS, AND SYSTEM FOR WIRELESS SENSING MEASUREMENT AND REPORTING”, filed on Oct. 4, 2022.
(m) U.S. patent application Ser. No. 18/108,563, entitled “METHOD, APPARATUS, AND SYSTEM FOR WIRELESS SENSING BASED ON MULTIPLE GROUPS OF WIRELESS DEVICES”, filed on Feb. 10, 2023,
(n) U.S. patent application Ser. No. 18/199,963, entitled “METHOD, APPARATUS, AND SYSTEM FOR WIRELESS SENSING MEASUREMENT AND REPORTING”, filed on May 21, 2023.
(o) U.S. patent application Ser. No. 18/379,622, entitled “METHOD, APPARATUS, AND SYSTEM FOR WIRELESS PROXIMITY DETECTION”, filed on Oct. 12, 2023.
(p) U.S. patent application Ser. No. 18/391,529, entitled “METHOD, APPARATUS, AND SYSTEM FOR WIRELESS HUMAN AND NON-HUMAN MOTION DETECTION”, filed on Dec. 20, 2023.
(q) U.S. patent application Ser. No. 18/395,533, entitled “METHOD, APPARATUS, AND SYSTEM FOR WIRELESS SENSING MEASUREMENT AND REPORTING”, filed on Dec. 23, 2023.
(r) U.S. patent application Ser. No. 18/395,539, entitled “METHOD, APPARATUS, AND SYSTEM FOR WIRELESS SENSING MEASUREMENT AND REPORTING”, filed on Dec. 23, 2023.
U.S. patent application Ser. No. 18/395,543, entitled “METHOD, APPARATUS, AND SYSTEM FOR(s) WIRELESS SENSING MEASUREMENT AND REPORTING”, filed on Dec. 23, 2023.
(t) U.S. patent application Ser. No. 18/395,537, entitled “METHOD, APPARATUS, AND SYSTEM FOR WIRELESS SENSING MEASUREMENT AND REPORTING”, filed on Dec. 23, 2023.
(u) U.S. patent application Ser. No. 18/395,544, entitled “METHOD, APPARATUS, AND SYSTEM FOR WIRELESS SENSING MEASUREMENT AND REPORTING”, filed on Dec. 23, 2023.
(v) U.S. patent application Ser. No. 18/401,684, entitled “METHOD, APPARATUS, AND SYSTEM FOR WIRELESS SENSING MEASUREMENT AND REPORTING”, filed on Jan. 1, 2024.
(w) U.S. patent application Ser. No. 18/401,681, entitled “METHOD, APPARATUS, AND SYSTEM FOR WIRELESS SENSING BASED ON DEEP LEARNING”, filed on Jan. 1, 2024.

### TECHNICAL FIELD

The present teaching generally relates to wireless sensing. More specifically, the present teaching relates to wireless sensing in network of networks with coded addresses.

### BACKGROUND

With the proliferation of Internet of Things (IoT) applications, billions of household appliances, phones, smart devices, security systems, environment sensors, vehicles and buildings, and other radio-connected devices will transmit data and communicate with each other or people, and everything will be able to be measured and tracked all the time. Among the various approaches to measure what is happening in the surrounding environment, wireless sensing has received an increasing attention in recent years because of the ubiquitous deployment of wireless radio devices. In addition, human activities affect wireless signal propagations, therefore understanding and analyzing the way how wireless signals react to human activities can reveal rich information about the activities. As more bandwidth becomes available in the new generation of wireless systems, wireless sensing will make many smart IoT applications only imagined today possible in the near future. That is because when the bandwidth increases, one can see many more multipaths, in a rich-scattering environment such as in indoors or metropolitan area, which can be treated as hundreds of virtual antennas/sensors. Because there may be many IoT devices available for wireless sensing, an efficient and effective method for making use multiple devices for wireless sensing is desirable.

### SUMMARY

The present teaching generally relates to wireless sensing. More specifically, the present teaching relates to wireless sensing in network of networks with coded addresses.

In one embodiment, a method for wireless sensing using coded addresses to identify originating devices is described. The method comprises: associating a plurality of Type1 devices in a venue with a Type2 device in the venue, wherein: each of the plurality of Type1 devices is a heterogeneous wireless device having a first type, the Type2 device is a heterogeneous wireless device having a second type different from the first type, the Type2 device has a plurality of coded addresses each of which is associated with a respective Type1 device of the plurality of Type1 devices; transmitting, by the Type2 device, a plurality of time series of wireless trigger signals through a wireless channel in the venue to the plurality of Type1 devices to trigger wireless sounding, wherein: each respective time series of wireless trigger signals is transmitted to a respective Type1 device with a coded address of the Type2 device associated with the respective Type1 device, the coded address is embedded as a source address in each wireless trigger signal of the respective time series of wireless trigger signals; transmitting, by each Type1 device in response to each respective wireless trigger signal, a respective wireless sounding signal to the Type2 device with a respective associated coded address of the Type2 device, wherein the respective associated coded address is embedded as a destination address in the respective wireless sounding signal; receiving, by the Type2 device, a plurality of wireless sounding signals from the plurality of Type1 devices addressed to any of the coded addresses of the Type2 device; for each received wireless sounding signal: obtaining, by a processor of the Type2 device, a respective channel information (CI) of the wireless channel in the venue based on the received wireless sounding signal, comparing, by the processor, a received coded address of the Type2 device embedded as a destination address in the received wireless sounding signal with the plurality of coded addresses stored in a database, and identifying, by the processor, a respective Type1 device, whose associated stored coded address of the Type2 device matching the received coded address, as an originating device of the received wireless sounding signal and the respective CI; assembling, by the processor, a plurality of time series of CI (TSCI) associated with the plurality of Type1 devices, wherein each TSCI associated with a respective Type1 device comprises all CI originated from the respective Type1 device; and performing, by the processor, a wireless sensing task based on the plurality of TSCI associated with the plurality of Type1 devices.

In another embodiment, a wireless device in a venue is described. The wireless device comprises: a data storage storing a plurality of coded addresses of the wireless device, a transmitter, a receiver, and a processor communicatively coupled to the data storage, the transmitter and the receiver. The wireless device is associated a plurality of Type1 devices in the venue. Each of the plurality of Type1 devices is a heterogeneous wireless device having a first type. The wireless device is a Type2 device having a second type different from the first type. Each of the plurality of coded addresses is associated with a respective Type1 device of the plurality of Type1 devices. The transmitter is configured to transmit a plurality of time series of wireless trigger signals through a wireless channel in the venue to the plurality of Type1 devices to trigger wireless sounding. Each respective time series of wireless trigger signals is transmitted to a respective Type1 device with a coded address of the Type2 device associated with the respective Type1 device. The coded address is embedded as a source address in each wireless trigger signal of the respective time series of wireless trigger signals. The receiver is configured to receive a plurality of wireless sounding signals from the plurality of Type1 devices addressed to any of the coded addresses of the Type2 device. A respective wireless sounding signal is received, from each Type1 device in response to each respective wireless trigger signal, with a respective associated coded address of the Type2 device. The respective associated coded address is embedded as a destination address in the respective wireless sounding signal. The processor is configured to: for each received wireless sounding signal: obtain a respective channel information (CI) of the wireless channel in the venue based on the received wireless sounding signal, compare a received coded address of the Type2 device embedded as a destination address in the received wireless sounding signal with the plurality of coded addresses stored in the data storage, and identify a respective Type1 device, whose associated stored coded address of the Type2 device matching the received coded address, as an originating device of the received wireless sounding signal and the respective CI; assemble a plurality of time series of CI (TSCI) associated with the plurality of Type1 devices, wherein each TSCI associated with a respective Type1 device comprises all CI originated from the respective Type1 device; and perform a wireless sensing task based on the plurality of TSCI associated with the plurality of Type1 devices.

In yet another embodiment, a system for wireless sensing is described. The system comprises: a plurality of Type1 devices in a venue, wherein each of the plurality of Type1 devices is a heterogeneous wireless device having a first type; and a Type2 device in the venue. The Type2 device is a heterogeneous wireless device having a second type different from the first type. The Type2 device has a plurality of coded addresses each of which is associated with a respective Type1 device of the plurality of Type1 devices. The Type2 device is configured to transmit a plurality of time series of wireless trigger signals through a wireless channel in the venue to the plurality of Type1 devices to trigger wireless sounding. Each respective time series of wireless trigger signals is transmitted to a respective Type1 device with a coded address of the Type2 device associated with the respective Type1 device. The coded address is embedded as a source address in each wireless trigger signal of the respective time series of wireless trigger signals. Each Type1 device is configured to transmit, in response to each respective wireless trigger signal, a respective wireless sounding signal to the Type2 device with a respective associated coded address of the Type2 device. The respective associated coded address is embedded as a destination address in the respective wireless sounding signal. The Type2 device is configured to: receive a plurality of wireless sounding signals from the plurality of Type1 devices addressed to any of the coded addresses of the Type2 device; for each received wireless sounding signal: obtain a respective channel information (CI) of the wireless channel in the venue based on the received wireless sounding signal, compare a received coded address of the Type2 device embedded as a destination address in the received wireless sounding signal with the plurality of coded addresses stored in a database, and identify a respective Type1 device, whose associated stored coded address of the Type2 device matching the received coded address, as an originating device of the received wireless sounding signal and the respective CI; assemble a plurality of time series of CI (TSCI) associated with the plurality of Type1 devices, wherein each TSCI associated with a respective Type1 device comprises all CI originated from the respective Type1 device; and perform a wireless sensing task based on the plurality of TSCI associated with the plurality of Type1 devices.

Other concepts relate to software for implementing the present teaching on wireless sensing in network of networks with coded addresses. Additional novel features will be set forth in part in the description which follows, and in part will become apparent to those skilled in the art upon examination of the following and the accompanying drawings or may be learned by production or operation of the examples. The novel features of the present teachings may be realized and attained by practice or use of various aspects of the methodologies, instrumentalities and combinations set forth in the detailed examples discussed below.

### BRIEF DESCRIPTION OF DRAWINGS

The methods, systems, and/or devices described herein are further described in terms of example embodiments. These example embodiments are described in detail with reference to the drawings. These embodiments are non-limiting example embodiments, in which like reference numerals represent similar structures throughout the several views of the drawings.

FIG. 1 illustrates an example scenario for wireless sensing in a venue, according to some embodiments of the present disclosure.

FIG. 2 illustrates an example floor plan and placement of wireless devices for wireless sensing, according to some embodiments of the present disclosure.

FIG. 3 illustrates an example block diagram of a first wireless device of a system for wireless sensing, according to some embodiments of the present disclosure.

FIG. 4 illustrates an example block diagram of a second wireless device of a system for wireless sensing, according to some embodiments of the present disclosure.

FIG. 5 illustrates a flow chart of an example method for hybrid radio-plus-aux fall-down detection based on wireless sensing, according to some embodiments of the present disclosure.

FIG. 6 illustrates an example system for performing wireless sensing in a venue with multiple groups of devices with a per-room deployment, according to some embodiments of the present disclosure.

FIG. 7 illustrates an example system for performing wireless sensing in a venue with multiple groups of devices with a whole-home deployment, according to some embodiments of the present disclosure.

FIG. 8 illustrates a flow chart of an example method for performing wireless sensing in a venue with multiple groups of devices, according to some embodiments of the present disclosure.

FIG. 9 illustrates an example floor plan for wireless sensing to display sensing motion statistics and analytics, according to some embodiments of the present disclosure.

FIG. 10 illustrates a flow chart of an example method of a wireless sensing presentation system, according to some embodiments of the present disclosure.

FIG. 11 illustrates a flow chart of an example method for performing a selective sensing-by-proxy procedure, according to some embodiments of the present disclosure.

FIG. 12 illustrates an example system for performing wireless sensing in network of networks with inter-network sounding, according to some embodiments of the present disclosure.

FIG. 13 illustrates a flow chart of an example method for performing inter-network sounding, according to some embodiments of the present disclosure.

FIG. 14 illustrates a flow chart of an example method for performing wireless sensing in network of networks with inter-network sounding, according to some embodiments of the present disclosure.

FIG. 15A and FIG. 15B illustrate a flow chart of an example method for performing wireless sensing with coded addresses, according to some embodiments of the present disclosure.

### DETAILED DESCRIPTION

The symbol “/” disclosed herein means “and/or”. For example, “A/B” means “A and/or B.” In some embodiments, a method/device/system/software of a wireless monitoring system is disclosed. A time series of channel information (CI) of a wireless multipath channel is obtained using a processor, a memory communicatively coupled with processor and a set of instructions stored in memory. The time series of CI (TSCI) may be extracted from a wireless signal transmitted from a Type1 heterogeneous wireless device (e.g. wireless transmitter (TX), “Bot” device) to a Type2 heterogeneous wireless device (e.g. wireless receiver (RX), “Origin” device) in a venue through the channel. The channel is impacted by an expression/motion of an object in venue. A characteristics/spatial-temporal information (STI)/motion information (MI) of object/expression/motion may be computed/monitored based on the TSCI. A task may be performed based on the characteristics/STI/MI. A task-related presentation may be generated in a user-interface (UI) on a device of a user.

Expression may comprise placement, placement of moveable parts, location/speed/acceleration/position/orientation/direction/identifiable place/region/presence/spatial coordinate, static expression/presentation/state/size/length/width/height/angle/scale/curve/surface/area/volume/pose/posture/manifestation/body language, dynamic expression/motion/sequence/movement/activity/behavior/gesture/gait/extension/contraction/distortion/deformation, body expression (e.g. head/face/eye/mouth/tongue/hair/voice/neck/limbs/arm/hand/leg/foot/muscle/moveable parts), surface expression/shape/texture/material/color/electromagnetic (EM) characteristics/visual pattern/wetness/reflectance/translucency/flexibility, material property (e.g. living tissue/hair/fabric/metal/wood/leather/plastic/artificial material/solid/liquid/gas/temperature), expression change, and/or some combination.

Wireless multipath channel may comprise: communication channel, analog frequency channel (e.g. with carrier frequency near 700/800/900 MHz, or 1.8/1.9/2.4/3/5/6/27/60/70+GHz), coded channel (e.g. in CDMA), and/or channel of wireless/cellular network/system (e.g. WLAN, WiFi, mesh, 4G/LTE/5G/6G/7G/8G, Bluetooth, Zigbee, UWB, RFID, microwave). It may comprise multiple channels, which may be consecutive (e.g. adjacent/overlapping bands) or non-consecutive (e.g. non-overlapping bands. 2.4 GHz/5 GHz). While channel is used to transmit wireless signal and perform sensing measurements, data (e.g. TSCI/feature/component/characteristics/STI/MI/analytics/task outputs, auxiliary/non-sensing data/network traffic) may be communicated/transmitted in channel.

Wireless signal may comprise a series of probe signals. It may be any of: EM radiation, radio frequency (RF)/light/bandlimited/baseband signal, signal in licensed/unlicensed/ISM band, wireless/mobile/cellular/optical communication/network/mesh/downlink/uplink/unicast/multicast/broadcast signal. It may be compliant to standard/protocol (e.g. WLAN, WWAN, WPAN, WBAN, international/national/industry/defacto, IEEE/802/802.11/15/16, WiFi, 802.11n/ac/ax/be/bf, 3G/4G/LTE/5G/6G/7G/8G, 3GPP/Bluetooth/BLE/Zigbee/NFC/RFID/UWB/WiMax). A probe signal may comprise any of: protocol/standard/beacon/pilot/sounding/excitation/illumination/handshake/synchronization/reference/source/motion probe/detection/sensing/management/control/data/null-data/beacon/pilot/request/response/association/reassociation/disassociation/authentication/action/report/poll/announcement/extension/enquiry/acknowledgement frame/packet/signal, and/or null-data-frame (NDP)/RTS/CTS/QoS/CF-Poll/CF-Ack/block acknowledgement/reference/training/synchronization. It may comprise line-of-sight (LOS)/non-LOS components (or paths/links). It may have data embedded. Probe signal may be replaced by (or embedded in) data signal. Each frame/packet/signal may comprise: preamble/header/payload. It may comprise: training sequence, short (STF)/long (LTF) training field, L-STF/L-LTF/L-SIG/HE-STF/HE-LTF/HE-SIG-A/HE-SIG-B, channel estimation field (CEF). It may be used to transfer power wirelessly from Type1 device to Type2 device. Sounding rate of signal may be adjusted to control amount of transferred power. Probe signals may be sent in burst.

TSCI may be extracted/obtained (e.g. by IC/chip) from wireless signal at a layer of Type2 device (e.g. layer of OSI reference model, PHY/MAC/data link/logical link control/network/transport/session/presentation/application layer, TCP/IP/internet/link layer). It may be extracted from received wireless/derived signal. It may comprise wireless sensing measurements obtained in communication protocol (e.g. wireless/cellular communication standard/network, 4G/LTE/5G/6G/7G/8G, WiFi, IEEE 802.11/11bf/15/16). Each CI may be extracted from a probe/sounding signal, and may be associated with time stamp. TSCI may be associated with starting/stopping time/duration/amount of CI/sampling/sounding frequency/period. A motion detection/sensing signal may be recognized/identified base on probe signal. TSCI may be stored/retrieved/accessed/preprocessed/processed/postprocessed/conditioned/analyzed/monitored. TSCI/features/components/characteristics/STI/MI/analytics/task outcome may be communicated to edge/cloud server/Type1/Type2/hub/data aggregator/another device/system/network.

Type1/Type2 device may comprise components (hardware/software) such as electronics/chip/integrated circuit (IC)/RF circuitry/antenna/modem/TX/RX/transceiver/RF interface (e.g. 2.4/5/6/27/60/70+GHz radio/front/back haul radio)/network/interface/processor/memory/module/circuit/board/software/firmware/connectors/structure/enclosure/housing/structure. It may comprise access point (AP)/base-station/mesh/router/repeater/hub/wireless station/client/terminal/“Origin Satellite”/“Tracker Bot”, and/or internet-of-things (IoT)/appliance/wearable/accessory/peripheral/furniture/amenity/gadget/vehicle/module/wireless- enabled/unicast/multicast/broadcasting/node/hub/target/sensor/portable/mobile/cellular/communication/motion-detection/source/destination/standard-compliant device. It may comprise additional attributes such as auxiliary functionality/network connectivity/purpose/brand/model/appearance/form/shape/color/material/specification. It may be heterogeneous because the above (e.g. components/device types/additional attributes) may be different for different Type1 (or Type2) devices.

Type1/Type2 devices may/may not be authenticated/associated/collocated. They may be same device. Type1/Type2/portable/nearby/another device, sensing/measurement session/link between them, and/or object/expression/motion/characteristics/STI/MI/task may be associated with an identity/identification/identifier (ID) such as UUID, associated/unassociated STA ID (ASID/USID/AID/UID). Type2 device may passively observe/monitor/receive wireless signal from Type1 device without establishing connection (e.g. association/authentication/handshake) with, or requesting service from, Type1 device. Type1/Type2 device may move with object/another object to be tracked.

Type1 (TX) device may function as Type2 (RX) device temporarily/sporadically/continuously/repeatedly/interchangeably/alternately/simultaneously/contemporaneously/concurrently; and vice versa. Type1 device may be Type2 device. A device may function as Type1/Type2 device temporarily/sporadically/continuously/repeatedly/simultaneously/concurrently/contemporaneously. There may be multiple wireless nodes each being Type1/Type2 device. TSCI may be obtained between two nodes when they exchange/communicate wireless signals. Characteristics/STI/MI of object may be monitored individually based on a TSCI, or jointly based on multiple TSCI.

Motion/expression of object may be monitored actively with Type1/Type2 device moving with object (e.g. wearable devices/automated guided vehicle/AGV), or passively with Type1/Type2 devices not moving with object (e.g. both fixed devices).

Task may be performed with/without reference to reference/trained/initial database/profile/baseline that is trained/collected/processed/computed/transmitted/stored in training phase. Database may be re-training/updated/reset.

Presentation may comprise UI/GUI/text/message/form/webpage/visual/image/video/graphics/animation/graphical/symbol/emoticon/sign/color/shade/sound/music/speech/audio/mechanical/gesture/vibration/haptics presentation. Time series of characteristic/STI/MI/task outcome/another quantity may be displayed/presented in presentation. Any computation may be performed/shared by processor (or logic unit/chip/IC)/Type1/Type2/user/nearby/another device/local/edge/cloud server/hub/data/signal analysis subsystem/sensing initiator/response/SBP initiator/responder/AP/non-AP. Presentation may comprise any of: monthly/weekly/daily/simplified/detailed/cross-sectional/small/large/form-factor/color-coded/comparative/summary/web view, animation/voice announcement/another presentation related to periodic/repetition characteristics of repeating motion/expression.

Multiple Type1 (or Type 2) devices may interact with a Type2 (or Type1) device. The multiple Type1 (or Type2) devices may be synchronized/asynchronous, and/or may use same/different channels/sensing parameters/settings (e.g. sounding frequency/bandwidth/antennas). Type2 device may receive another signal from Type1/another Type1 device. Type1 device may transmit another signal to Type2/another Type2 device. Wireless signals sent (or received) by them may be sporadic/temporary/continuous/repeated/synchronous/simultaneous/concurrent/contemporaneous. They may operate independently/collaboratively. Their data (e.g. TSCI/feature/characteristics/STI/MI/intermediate task outcomes) may be processed/monitored/analyzed independently or jointly/collaboratively.

Any devices may operate based on some state/internal state/system state. Devices may communicate directly, or via another/nearby/portable device/server/hub device/cloud server. Devices/system may be associated with one or more users, with associated settings. Settings may be chosen/selected/pre-programmed/changed/adjusted/modified/varied over time. The method may be performed/executed in shown order/another order. Steps may be performed in parallel/iterated/repeated. Users may comprise human/adult/older adult/man/woman/juvenile/child/baby/pet/animal/creature/machine/computer module/software. Step/operation/processing may be different for different devices (e.g. based on locations/orientation/direction/roles/user-related characteristics/settings/configurations/available resources/bandwidth/power/network connection/hardware/software/processor/co-processor/memory/battery life/antennas/directional antenna/power setting/device parameters/characteristics/conditions/status/state). Any/all device may be controlled/coordinated by a processor (e.g. associated with Type1/Type2/nearby/portable/another device/server/designated source). Some device may be physically in/of/attached to a common device.

Type1 (or Type2) device may be capable of wirelessly coupling with multiple Type2 (or Type1) devices. Type1 (or Type2) device may be caused/controlled to switch/establish wireless coupling (e.g. association/authentication) from Type2 (or Type1) device to another Type2 (or another Type1) device. The switching may be controlled by server/hub device/processor/Type1 device/Type2 device. Radio channel may be different before/after switching. A second wireless signal may be transmitted between Type1 (or Type2) device and second Type2 (or second Type1) device through the second channel. A second TSCI of second channel may be extracted/obtained from second signal. The first/second signals, first/second channels, first/second Type1 device, and/or first/second Type2 device may be same/similar/co-located.

Type1 device may transmit/broadcast wireless signal to multiple Type2 devices, with/without establishing connection (association/authentication) with individual Type2 devices. It may transmit to a particular/common MAC address, which may be MAC address of some device (e.g. dummy receiver). Each Type2 device may adjust to particular MAC address to receive wireless signal. Particular MAC address may be associated with venue, which may be recorded in an association table of an Association Server (e.g. hub device). Venue may be identified by Type1 device/Type2 device based on wireless signal received at particular MAC address.

For example. Type2 device may be moved to a new venue. Type1 device may be newly set up in venue such that Type1 and Type2 devices are not aware of each other. During set up, Type1 device may be instructed/guided/caused/controlled (e.g. by dummy receiver, hardware pin setting/connection, stored setting, local setting, remote setting, downloaded setting, hub device, and/or server) to send wireless signal (e.g. series of probe signals) to particular MAC address. Upon power up, Type2 device may scan for probe signals according to a table of MAC addresses (e.g. stored in designated source, server, hub device, cloud server) that may be used for broadcasting at different locations (e.g. different MAC address used for different venue such as house/office/enclosure/floor/multi-storey building/store/airport/mall/stadium/hall/station/subway/lot/area/zone/region/district/city/country/continent). When Type2 device detects wireless signal sent to particular MAC address, it can use the table to identify venue.

Channel may be selected from a set of candidate/selectable/admissible channels. Candidate channels may be associated with different frequency bands/bandwidth/carrier frequency/modulation/wireless standards/coding/encryption/payload characteristics/network/ID/SSID/characteristics/settings/parameters. Particular MAC address/selected channel may be changed/adjusted/varied/modified over time (e.g. according to time table/rule/policy/mode/condition/situation/change). Selection/change may be based on availability/collision/traffic pattern/co-channel/inter-channel interference/effective bandwidth/random selection/pre-selected list/plan. It may be done by a server (e.g. hub device). They may be communicated (e.g. from/to Type1/Type2/hub/another device/local/edge/cloud server).

Wireless connection (e.g. association/authentication) between Type1 device and nearby/portable/another device may be established (e.g. using signal handshake). Type1 device may send first handshake signal (e.g. sounding frame/probe signal/request-to-send RTS) to the nearby/portable/another device. Nearby/portable/another device may reply to first signal by sending second handshake signal (e.g. command/clear-to-send/CTS) to Type1 device, triggering Type1 device to transmit/broadcast wireless signal to multiple Type2 devices without establishing connection with the Type2 devices. Second handshake signals may be response/acknowledge (e.g. ACK) to first handshake signal. Second handshake signal may contain information of venue/Type1 device. Nearby/portable/another device may be a dummy device with purpose (e.g. primary purpose, secondary purpose) to establish wireless connection with Type1 device, to receive first signal, or send second signal. Nearby/portable/another device may be physically attached to Type1 device.

In another example, nearby/portable/another device may send third handshake signal to Type1 device triggering Type1 device to broadcast signal to multiple Type2 devices without establishing connection with them. Type1 device may reply to third signal by transmitting fourth handshake signal to the another device.

Nearby/portable/another device may be used to trigger multiple Type1 devices to broadcast. It may have multiple RF circuitries to trigger multiple transmitters in parallel. Triggering may be sequential/partially sequential/partially/fully parallel. Parallel triggering may be achieved using additional device(s) to perform similar triggering in parallel to nearby/portable/another device. After establishing connection with Type1 device, nearby/portable/another device may suspend/stop communication with Type1 device. It may enter an inactive/hibernation/sleep/stand-by/low-power/OFF/power-down mode. Suspended communication may be resumed. Nearby/portable/another device may have the particular MAC address and Type1 device may send signal to particular MAC address.

The (first) wireless signal may be transmitted by a first antenna of Type1 device to some first Type2 device through a first channel in a first venue. A second wireless signal may be transmitted by a second antenna of Type1 device to some second Type2 device through a second channel in a second venue. First/second signals may be transmitted at first/second (sounding) rates respectively, perhaps to first/second MAC addresses respectively. Some first/second channels/signals/rates/MAC addresses/antennas/Type2 devices may be same/different/synchronous/asynchronous. First/second venues may have same/different sizes/shape/multipath characteristics. First/second venues/immediate areas around first/second antennas may overlap. First/second channels/signals may be WiFi+LTE (one being WiFi, one being LTE), or WiFi+WiFi, or WiFi (2.4 GHz)+WiFi (5 GHz), or WiFi (5 GHz, channel=al, BW=a2)+WiFi (5 GHz/channel=b1, BW=b2). Some first/second items (e.g. channels/signals/rates/MAC addresses/antennas/Type1/Type2 devices) may be changed/adjusted/varied/modified over time (e.g. based on time table/rule/policy/mode/condition/situation/another change).

Each Type1 device may be signal source of multiple Type2 devices (i.e. it sends respective probe signal to respective Type2 device). Each respective Type2 device may choose asynchronously the Type1 device from among all Type1 devices as its signal source. TSCI may be obtained by each respective Type2 device from respective series of probe signals from Type1 device. Type2 device may choose Type1 device from among all Type1 devices as its signal source (e.g. initially) based on identity/identification/identifier of Type1/Type2 device, task, past signal sources, history, characteristics, signal strength/quality, threshold for switching signal source, and/or information of user/account/profile/access info/parameters/input/requirement/criteria.

Database of available/candidate Type1 (or Type2) devices may be initialized/maintained/updated by Type2 (or Type1) device. Type2 device may receive wireless signals from multiple candidate Type1 devices. It may choose its Type1 device (i.e. signal source) based on any of: signal quality/strength/regularity/channel/traffic/characteristics/properties/states/task requirements/training task outcome/MAC addresses/identity/identifier/past signal source/history/user instruction/another consideration.

An undesirable/bad/poor/problematic/unsatisfactory/unacceptable/intolerable/faulty/demanding/undesirable/inadequate/lacking/inferior/unsuitable condition may occur when (1) timing between adjacent probe signals in received wireless signal becomes irregular, deviating from agreed sounding rate (e.g. time perturbation beyond acceptable range), and/or (2) processed/signal strength of received signal is too weak (e.g. below third threshold, or below fourth threshold for significant percentage of time), wherein processing comprises any lowpass/bandpass/highpass/median/moving/weighted average/linear/nonlinear/smoothing filtering. Any thresholds/percentages/parameters may be time-varying. Such condition may occur when Type1/Type2 device become progressively far away, or when channel becomes congested.

Some settings (e.g. Type1-Type2 device pairing/signal source/network/association/probe signal/sounding rate/scheme/channel/bandwidth/system state/TSCI/TSMA/task/task parameters) may be changed/varied/adjusted/modified. Change may be according to time table/rule/policy/mode/condition (e.g. undesirable condition)/another change. For example, sounding rate may normally be 100 Hz, but changed to 1000 Hz in demanding situations, and to 1 Hz in low power/standby situation.

Settings may change based on task requirement (e.g. 100 Hz normally and 1000 Hz momentarily for 20 seconds). In task, instantaneous system may be associated adaptively/dynamically to classes/states/conditions (e.g. low/normal/high priority/emergency/critical/regular/privileged/non-subscription/subscription/paying/non-paying). Settings (e.g. sounding rate) may be adjusted accordingly. Change may be controlled by: server/hub/Type1/Type2 device. Scheduled changes may be made according to time table. Changes may be immediate when emergency is detected, or gradual when developing condition is detected.

Characteristics/STI/MI may be monitored/analyzed individually based on a TSCI associated with a particular Type1/Type2 device pair, or jointly based on multiple TSCI associated multiple Type1/Type2 pairs, or jointly based on any TSCI associated with the particular Type2 device and any Type1 devices, or jointly based on any TSCI associated with the particular Type1 device and any Type2 devices, or globally based on any TSCI associated with any Type1/Type2 devices.

A classifier/classification/recognition/detection/estimation/projection/feature extraction/processing/filtering may be applied (e.g. to CI/CI-feature/characteristics/STI/MI), and/or trained/re-trained/updated. In a training stage, training may be performed based on multiple training TSCI of some training wireless multipath channel, or characteristic/STI/MI computed from training TSCI, the training TSCI obtained from training wireless signals transmitted from training Type1 devices and received by training Type2 devices. Re-training/updating may be performed in an operating stage based on training TSCI/current TSCI. There may be multiple classes (e.g. groupings/categories/events/motions/expression/activities/objects/locations) associated with venue/regions/zones/location/environment/home/office/building/warehouse/facility object/expression/motion/movement/process/event/manufacturing/assembly-line/maintenance/repairing/navigation/object/emotional/mental/state/condition/stage/gesture/gait/action/motion/presence/movement/daily/activity/history/event.

Classifier may comprise linear/nonlinear/binary/multiclass/Bayes classifier/Fisher linear discriminant/logistic regression/Markov chain/Monte Carlo/deep/neural network/perceptron/self-organization maps/boosting/meta algorithm/decision tree/random forest/genetic programming/kernel learning/KNN/support vector machine (SVM).

Feature extraction/projection may comprise any of: subspace projection/principal component analysis (PCA)/independent component analysis (ICA)/vector quantization/singular value decomposition (SVD)/eigen-decomposition/eigenvalue/time/frequency/orthogonal/non-orthogonal decomposition, processing/preprocessing/postprocessing. Each CI may comprise multiple components (e.g. vector/combination of complex values). Each component may be preprocessed to give magnitude/phase or a function of such.

Feature may comprise: output of feature extraction/projection, amplitude/magnitude/phase/energy/power/strength/intensity, presence/absence/proximity/likelihood/histogram, time/period/duration/frequency/component/decomposition/projection/band, local/global/maximum (max)/minimum (min)/zero-crossing, repeating/periodic/typical/habitual/one-time/atypical/abrupt/mutually-exclusive/evolving/transient/changing/time/related/correlated feature/pattern/trend/profile/events/tendency/inclination/behavior, cause-and-effect/short-term/long-term/correlation/statistics/frequency/period/duration, motion/movement/location/map/coordinate/height/speed/acceleration/angle/rotation/size/volume, suspicious/dangerous/alarming event/warning/belief/proximity/collision, tracking/breathing/heartbeat/gait/action/event/statistical/hourly/daily/weekly/monthly/yearly parameters/statistics/analytics, well-being/health/disease/medical statistics/analytics, an early/instantaneous/contemporaneous/delayed indication/suggestion/sign/indicator/verifier/detection/symptom of a state/condition/situation/disease/biometric, baby/patient/machine/device/temperature/vehicle/parking lot/venue/lift/elevator/spatial/road/fluid flow/home/room/office/house/building/warehouse/storage/system/ventilation/fan/pipe/duct/people/human/car/boat/truck/airplane/drone/downtown/crowd/impulsive event/cyclo-stationary/environment/vibration/material/surface/3D/2D/local/global, and/or another measurable quantity/variable. Feature may comprise monotonic function of feature, or sliding aggregate of features in sliding window.

Training may comprise AI/machine/deep/supervised/unsupervised/discriminative training/auto-encoder/linear discriminant analysis/regression/clustering/tagging/labeling/Monte Carlo computation.

A current event/motion/expression/object in venue at current time may be classified by applying classifier to current TSCI/characteristics/STI/MI obtained from current wireless signal received by Type2 device in venue from Type1 devices in an operating stage. If there are multiple Type1/Type2 devices, some/all (or their locations/antenna locations) may be a permutation of corresponding training Type1/Type2 devices (or locations/antenna locations). Type1/Type2 device/signal/channel/venue/object/motion may be same/different from corresponding training entity. Classifier may be applied to sliding windows. Current TSCI/characteristics/STI/MI may be augmented by training TSCI/characteristics/STI/MI (or fragment/extract) to bootstrap classification/classifier.

A first section/segment (with first duration/starting/ending time) of a first TSCI (associated with first Type1-Type2 device pair) may be aligned (e.g. using dynamic time warping/DTW/matched filtering, perhaps based on some mismatch/distance/similarity score/cost, or correlation/autocorrelation/cross-correlation) with a second section/segment (with second duration/starting/ending time) of a second TSCI (associated with second Type1-Type2 device pair), with each CI in first section mapped to a CI in second section. First/second TSCI may be preprocessed. Some similarity score (component/item/link/segment-wise) may be computed. The similarity score may comprise any of: mismatch/distance/similarity score/cost. Component-wise similarity score may be computed between a component of first item (CI/feature/characteristics/STI/MI) of first section and corresponding component of corresponding mapped item (second item) of second section. Item-wise similarity score may be computed between first/second items (e.g. based on aggregate of corresponding component-wise similarity scores). An aggregate may comprise any of: sum/weighted sum, weighted average/robust/trimmed mean/arithmetic/geometric/harmonic mean, median/mode. Link-wise similarity score may be computed between first/second items associated with a link (TX-RX antenna pair) of first/second Type1-Type2 device pairs (e.g. based on aggregate of corresponding item-wise similarity scores). Segment-wise similarity score may be computed between first/second segments (e.g. based on aggregate of corresponding link-wise similarity scores). First/second segment may be sliding.

In DTW, a function of any of: first/second segment, first/second item, another first (or second) item of first (or second) segment, or corresponding timestamp/duration/difference/differential, may satisfy a constraint. Time difference between first/second items may be constrained (e.g. upper/lower bounded). First (or second) section may be entire first (or second) TSCI. First/second duration/starting/ending time may be same/different.

In one example, first/second Type1-Type2 device pairs may be same and first/second TSCI may be same/different. When different, first/second TSCI may comprise a pair of current/reference, current/current or reference/reference TSCI. For “current/reference”, first TSCI may be current TSCI obtained in operating stage and second TSCI may be reference TSCI obtained in training stage. For “reference/reference”, first/second TSCI may be two TSCI obtained during training stage (e.g. for two training events/states/classes). For “current/current”, first/second TSCI may be two TSCI obtained during operating stage (e.g. associated with two different antennas, or two measurement setups). In another example, first/second Type1-Type2 device pairs may be different, but share a common device (Type1 or Type2).

Aligned first/second segments (or portion of each) may be represented as first/second vectors. Portion may comprise all items (for “segment-wise”), or all items associated with a TX-RX link (for “link-wise”), or an item (for “item-wise”), or a component of an item (for “component-wise”). Similarity score may comprise combination/aggregate/function of any of: inner product/correlation/autocorrelation/correlation indicator/covariance/discriminating score/distance/Euclidean/absolute/L_k/weighted distance (between first/second vectors). Similarity score may be normalized by vector length. A parameter derived from similarity score may be modeled with a statistical distribution. A scale/location/another parameter of the statistical distribution may be estimated.

Recall there may be multiple sliding segments. Classifier may be applied to a sliding first/second segment pair to obtain a tentative classification result. It may associate current event with a particular class based on one segment pair/tentative classification result, or multiple segment pairs/tentative classification results (e.g. associate if similarity scores prevail (e.g. being max/min/dominant/matchless/most significant/excel) or significant enough (e.g. higher/lower than some threshold) among all candidate classes for N consecutive times, or for a high/low enough percentage, or most/least often in a time period).

Channel information (CI) may comprise any of: signal strength/amplitude/phase/timestamp, spectral power measurement, modem parameters, dynamic beamforming information, transfer function components, radio state, measurable variables, sensing data/measurement, coarse/fine-grained layer information (e.g. PHY/MAC/datalink layer), digital gain/RF filter/frontend-switch/DC offset/correction/IQ-compensation settings, environment effect on wireless signal propagation, channel input-to-output transformation, stable behavior of environment, state profile, wireless channel measurements/received signal strength indicator (RSSI)/channel state information (CSI)/channel impulse response (CIR)/channel frequency response (CFR)/characteristics of frequency components (e.g. subcarriers)/channel characteristics/channel filter response, auxiliary information, data/meta/user/account/access/security/session/status/supervisory/device/network/household/neighborhood/environment/real-time/sensor/stored/encrypted/compressed/protected data, identity/identifier/identification.

Each CI may be associated with timestamp/arrival time/frequency band/signature/phase/amplitude/trend/characteristics, frequency-like characteristics, time/frequency/time-frequency domain element, orthogonal/non-orthogonal decomposition characteristics of signal through channel. Timestamps of TSCI may be irregular and may be corrected (e.g. by interpolation/resampling) to be regular, at least for a sliding time window.

TSCI may be/comprise a link-wise TSCI associated with an antenna of Type1 device and an antenna of Type2 device. For Type1 device with M antennas and Type2 device with N antennas, there may be MN link-wise TSCI.

CI/TSCI may be preprocessed/processed/postprocessed/stored/retrieved/transmitted/received. Some modem/radio state parameter may be held constant. Modem parameters may be applied to radio subsystem and may represent radio state. Motion detection signal (e.g. baseband signal, packet decoded/demodulated from it) may be obtained by processing (e.g. down-converting) wireless signal (e.g. RF/WiFi/LTE/5G/6G signal) by radio subsystem using radio state represented by stored modem parameters. Modem parameters/radio state may be updated (e.g. using previous modem parameters/radio state). Both previous/updated modem parameters/radio states may be applied in radio subsystem (e.g. to process signal/decode data). In the disclosed system, both may be obtained/compared/analyzed/processed/monitored.

Each CI may comprise N1 CI components (CIC) (e.g. time/frequency domain component, decomposition components), each with corresponding CIC index. Each CIC may comprise a real/imaginary/complex quantity, magnitude/phase/Boolean/flag, and/or some combination/subset. Each CI may comprise a vector/matrix/set/collection of CIC. CIC of TSCI associated with a particular CIC index may form a CIC time series. TSCI may be divided into N1 time series of CIC (TSCIC), each associated with respective CIC index. Characteristics/STI/MI may be monitored based on TSCIC. Some TSCIC may be selected based on some criteria/cost function/signal quality metric (e.g. SNR, interference level) for further processing.

Multi-component characteristics/STI/MI of multiple TSCIC (e.g. two components with indices 6 and 7, or three components indexed at 6, 7, 10) may be computed. In particular, k-component characteristics may be a function of k TSCIC with k corresponding CIC indices. With k=1, it is single-component characteristics which may constitute/form a one-dimensional (1D) function as CIC index spans all possible values. For k=2, two-component characteristics may constitute/form a 2D function. In special case, it may depend only on difference between the two indices. In such case, it may constitute 1D function. A total characteristics may be computed based on one or more multi-component characteristics (e.g. weighted average/aggregate). Characteristics/STI/MI of object/motion/expression may be monitored based on any multi-component characteristics/total characteristics.

Characteristics/STI/MI may comprise: instantaneous/short-/long- term/historical/repetitive/repeated/repeatable/recurring/periodic/pseudoperiodic/regular/habitual/incremental/average/initial/final/current/past/future/predicted/changing/deviational/change/time/frequency/orthogonal/non- orthogonal/transform/decomposition/deterministic/stochastic/probabilistic/dominant/key/prominent/representative/characteristic/significant/insignificant/indicative/common/averaged/shared/typical/prototypical/persistent/abnormal/a brupt/impulsive/sudden/unusual/unrepresentative/atypical/suspicious/dangerous/alarming/evolving/transient/one-time quantity/characteristics/analytics/feature/information, cause-and-effect, correlation indicator/score, auto/cross correlation/covariance, autocorrelation function (ACF), spectrum/spectrogram/power spectral density, time/frequency function/transform/projection, initial/final/temporal/change/trend/pattern/tendency/inclination/behavior/activity/history/profile/event, location/position/localization/spatial coordinate/change on map/path/navigation/tracking, linear/rotational/horizontal/vertical/location/distance/displacement/height/speed/velocity/acceleration/change/angular speed, direction/orientation, size/length/width/height/azimuth/area/volume/capacity, deformation/transformation, object/motion direction/angle/shape/form/shrinking/expanding, behavior/activity/movement, occurrence, fall-down/accident/security/event. period/frequency/rate/cycle/rhythm/count/quantity, timing/duration/interval, starting/initiating/ending/current/past/next time/quantity/information, type/grouping/classification/composition, presence/absence/proximity/approaching/receding/entrance/exit, identity/identifier, head/mouth/eye/breathing/heart/hand/handwriting/arm/body/gesture/leg/gait/organ characteristics, tidal volume/depth of breath/airflow rate/inhale/exhale time/ratio, gait/walking/tool/machine/complex motion, signal/motion characteristic/information/feature/statistics/parameter/magnitude/phase/degree/dynamics/anomaly/variability/detection/estimation/recognition/identification/indication, slope/derivative/higher order derivative of function/feature/mapping/transformation of another characteristics, mismatch/distance/similarity score/cost/metric, Euclidean/statistical/weighted distance, L1/L2/Lk norm, inner/outer product, tag, test quantity, consumed/unconsumed quantity, state/physical/health/well-being/emotional/mental state, output responses, any composition/combination, and/or any related characteristics/information/combination.

Test quantities may be computed. Characteristics/STI/MI may be computed/monitored based on CI/TSCI/features/similarity scores/test quantities. Static (or dynamic) segment/profile may be identified/computed/analyzed/monitored/extracted/obtained/marked/presented/indicated/highlighted/stored/communicated by analyzing CI/TSCI/features/functions of features/test quantities/characteristics/STI/MI (e.g. target motion/movement presence/detection/estimation/recognition/identification). Test quantities may be based on CI/TSCI/features/functions of features/characteristics/STI/MI. Test quantities may be processed/tested/analyzed/compared.

Test quantity may comprise any/any function of: data/vector/matrix/structure, characteristics/STI/MI, CI information (CII, e.g. CI/CIC/feature/magnitude/phase), directional information (DI, e.g. directional CII), dominant/representative/characteristic/indicative/key/archetypal/example/paradigmatic/prominent/common/shared/typical/prototypical/averaged/regular/persistent/usual/normal/atypical/unusual/abnormal/unrepresentative data/vector/matrix/structure, similarity/mismatch/distance score/cost/metric, auto/cross correlation/covariance, sum/mean/average/weighted/trimmed/arithmetic/geometric/harmonic mean, variance/deviation/absolute/square deviation/averaged/median/total/standard deviation/derivative/slope/variation/total/absolute/square variation/spread/dispersion/variability, divergence/skewness/kurtosis/range/interquartile range/coefficient of variation/dispersion/L-moment/quartile coefficient of dispersion/mean absolute/square difference/Gini coefficient/relative mean difference/entropy/maximum (max)/minimum (min)/median/percentile/quartile, variance-to-mean ratio, max-to-min ratio, variation/regularity/similarity measure, transient event/behavior, statistics/mode/likelihood/histogram/probability distribution function (pdf)/moment generating function/expected function/value, behavior, repeatedness/periodicity/pseudo-periodicity, impulsiveness/suddenness/occurrence/recurrence, temporal profile/characteristics, time/timing/duration/period/frequency/trend/history, starting/initiating/ending time/quantity/count, motion classification/type, change, temporal/frequency/cycle change, etc.

Identification/identity/identifier/ID may comprise: MAC address/ASID/USID/AID/UID/UUID, label/tag/index, web link/address, numeral/alphanumeric ID, name/password/account/account ID, and/or another ID. ID may be assigned (e.g. by software/firmware/user/hardware, hardwired, via dongle). ID may be stored/retrieved (e.g. in database/memory/cloud/edge/local/hub server, stored locally/remotely/permanently/temporarily). ID may be associated with any of: user/customer/household/information/data/address/phone number/social security number, user/customer number/record/account, timestamp/duration/timing. ID may be made available to Type1/Type2 device/sensing/SBP initiator/responder. ID may be for registration/initialization/communication/identification/verification/detection/recognition/authentication/access control/cloud access/networking/social networking/logging/recording/cataloging/classification/tagging/association/pairing/transaction/electronic transaction/intellectual property control (e.g. by local/cloud/server/hub, Type1/Type2/nearby/user/another device, user).

Object may be person/pet/animal/plant/machine/user, baby/child/adult/older person. expert/specialist/leader/commander/manager/personnel/staff/officer/doctor/nurse/worker/teacher/technician/serviceman/repairman/passenger/patient/customer/student/traveler/inmate/high-value person/, object to be tracked, vehicle/car/AGV/drone/robot/wagon/transport/remote-controlled machinery/cart/moveable objects/goods/items/material/parts/components/machine/lift/elevator, merchandise/goods/cargo/people/items/food/package/luggage/equipment/cleaning tool in/on workflow/assembly-line/warehouse/factory/store/supermarket/distribution/logistic/transport/manufacturing/retail/wholesale/business center/facility/hub, phone/computer/laptop/tablet/dongle/plugin/companion/tool/peripheral/accessory/wearable/furniture/appliance/amenity/gadget, IoT/networked/smart/portable devices, watch/glasses/speaker/toys/stroller/keys/wallet/purse/handbag/backpack, goods/cargo/luggage/equipment/motor/machine/utensil/table/chair/air-conditioner/door/window/heater/fan, light/fixture/stationary object/television/camera/audio/video/surveillance equipment/parts, ticket/parking/toll/airplane ticket, credit/plastic/access card, object with fixed/changing/no form, mass/solid/liquid/gas/fluid/smoke/fire/flame, signage, electromagnetic (EM) source/medium, and/or another object.

Object may have multiple parts, each with different movement (e.g. position/location/direction change). Object may be a person walking forward. While walking, his left/right hands may move in different directions, with different instantaneous motion/speed/acceleration.

Object may/may not be communicatively coupled with some network, such as WiFi, MiFi, 4G/LTE/5G/6G/7G/8G, Bluetooth/NFC/BLE/WiMax/Zigbee/mesh/adhoc network. Object may be bulky machinery with AC power supply that is moved during installation/cleaning/maintenance/renovation. It may be placed on/in moveable platforms such as elevator/conveyor/lift/pad/belt/robot/drone/forklift/car/boat/vehicle. Type1/Type2 device may attach to/move with object.

Type1/Type2 device may be part of/embedded in portable/another device (e.g. module/device with module, which may be large/sizeable/small/heavy/bulky/light, e.g. coin-sized/cigarette-box-sized). Type1/Type2/portable/another device may/may not be attached to/move with object, and may have wireless (e.g. via Bluetooth/BLE/Zigbee/NFC/WiFi) or wired (e.g. USB/micro-USB/Firewire/HDMI) connection with a nearby device for network access (e.g. via WiFi/cellular network). Nearby device may be object/phone/AP/IoT/device/appliance/peripheral/amenity/furniture/vehicle/gadget/wearable/networked/computing device. Nearby device may be connected to some server (e.g. cloud server via network/internet). It may/may not be portable/moveable, and may/may not move with object. Type1/Type2/portable/nearby/another device may be powered by battery/solar/DC/AC/other power source, which may be replaceable/non-replaceable, and rechargeable/non-rechargeable. It may be wirelessly charged.

Type1/Type2/portable/nearby/another device may comprise any of: computer/laptop/tablet/pad/phone/printer/monitor/battery/antenna, peripheral/accessory/socket/plug/charger/switch/adapter/dongle, internet-of-thing (IoT), TV/sound bar/HiFi/speaker/set-top box/remote control/panel/gaming device, AP/cable/broadband/router/repeater/extender, appliance/utility/fan/refrigerator/washer/dryer/microwave/oven/stove/range/light/lamp/tube/pipe/tap/lighti ng/air-conditioner/heater/smoke detector, wearable/watch/glasses/goggle/button/bracelet/chain/jewelry/ring/belt/clothing/garment/fabric/shirt/pant/dress/glove/handwear/shoe/footwear/ha t/headwear/bag/purse/wallet/makeup/cosmetic/ornament/book/magazine/paper/stationary/signage/poster/display/printed matter, furniture/fixture/table/desk/chair/sofa/bed/cabinet/shelf/rack/storage/box/bucket/basket/packaging/carriage/tile/shingle/brick/block/mat/panel/curtain/cushion/pad/carpet/material/building material/glass, amenity/sensor/clock/pot/pan/ware/container/bottle/can/utensil/plate/cup/bowl/toy/ball/tool/pen/racket/lock/bell/camera/microphone/painting/frame/mirror/coffee-maker/door/window, food/pill/medicine, embeddable/implantable/gadget/instrument/equipment/device/apparatus/machine/controller/mechanical tool, garage-opener, key/plastic/payment/credit card/ticket, solar panel, key tracker, fire-extinguisher, garbage can/bin, WiFi-enabled device, smart device/machine/machinery/system/house/office/building/warehouse/facility/vehicle/car/bicycle/motorcycle/boat/vessel/airplane/cart/wagon, home/vehicle/office/factory/building/manufacturing/production/computing/security/another device.

One/two/more of Type1/Type2/portable/nearby/another device/server may determine an initial characteristics/STI/MI of object, and/or may share intermediate information. One of Type1/Type2 device may move with object (e.g. “Tracker Bot”). The other one of Type1/Type2 device may not move with object (e.g. “Origin Satellite”, “Origin Register”). Either may have known characteristics/STI/MI. Initial STI/MI may be computed based on known STI/MI.

Venue may be any space such as sensing area, room/house/home/office/workplace/building/facility/warehouse/factory/store/vehicle/property, indoor/outdoor/enclosed/semi-enclosed/open/semi-open/closed/over-air/floating/underground space/area/structure/enclosure, space/area with wood/glass/metal/material/structure/frame/beam/panel/column/wall/floor/door/ceiling/window/cavity/gap/opening/reflection/refraction medium/fluid/construction material/fixed/adjustable layout/shape, human/animal/plant body/cavity/organ/bone/blood/vessel/air-duct/windpipe/teeth/soft/hard/rigid/non-rigid tissue, manufacturing/repair/maintenance/mining/parking/storage/transportation/shipping/logistic/sports/entertainment/amusement/public/recreational/government/community/seniors/elderly care/geriatric/space facility/terminal/hub, distribution center/store, machine/engine/device/assembly line/workflow, urban/rural/suburban/metropolitan area, staircase/escalator/elevator/hallway/walkway/tunnel/cave/cavern/channel/duct/pipe/tube/lift/well/pathway/roof/basement/den/alley/road/path/highway/sewage/ventilation system/network, car/truck/bus/van/container/ship/boat/submersible/train/tram/airplane/mobile home, stadium/city/playground/park/field/track/court/gymnasium/hall/mart/market/supermarket/plaza/square/construction site/hotel/museum/school/hospital/university/garage/mall/airport/train/bus station/terminal/hub/platform, valley/forest/wood/terrain/landscape/garden/park/patio/land, and/or gas/oil/water pipe/line. Venue may comprise inside/outside of building/facility. Building/facility may have one/multiple floors, with a portion underground.

A event may be monitored based on TSCI. Event may be object/motion/gesture/gait related, such as fall-down, rotation/hesitation/pause, impact (e.g. person hitting sandbag/door/bed/window/chair/table/desk/cabinet/box/another person/animal/bird/fly/ball/bowling/tennis/soccer/volley ball/football/baseball/basketball), two-body action (e.g. person releasing balloon/catching fish/molding clay/writing paper/typing on computer), car moving in garage, person carrying smart phone/walking around venue, autonomous/moveable object/machine moving around (e.g. vacuum cleaner/utility/self-driving vehicle/car/drone).

Task may comprise: (a) sensing task, any of: monitoring/sensing/detection/recognition/estimation/verification/identification/authentication/classification/locationing/guidance/navigation/tracking/counting of/in any of: object/objects/vehicle/machine/tool/human/baby/elderly/patient/intruder/pet presence/proximity/activity/daily-activity/well-being/breathing/vital sign/heartbeat/health condition/sleep/sleep stage/walking/location/distance/speed/acceleration/navigation/tracking/exercise/safety/danger/fall-down/intrusion/security/life- threat/emotion/movement/motion/degree/pattern/periodic/repeated/cyclo-stationary/stationary/regular/transient/sudden/suspicious motion/irregularity/trend/change/breathing/human biometrics/environment informatics/gait/gesture/room/region/zone/venue, (b) computation task, any of: signal processing/preprocess/postprocessing/conditioning/denoising/calibration/analysis/feature extraction/transformation/mapping/supervised/unsupervised/semi-supervised/discriminative/machine/deep learning/training/clustering/training/PCA/eigen-decomposition/frequency/time/functional decomposition/neural network/map-based/model-based processing/correction/geometry estimation/analytics computation, (c) IoT task, any of: smart task for venue/user/object/human/pet/house/home/office/workplace/building/facility/warehouse/factory/store/vehicle/property/structure/assembly-line/IoT/device/system, energy/power management/transfer, wireless power transfer, interacting/engage with user/object/intruder/human/animal (e.g. presence/motion/gesture/gait/activity/behavior/voice/command/instruction/query/music/sound/image/vide o/location/movement/danger/threat detection/recognition/monitoring/analysis/response/execution/synthesis, generate/retrieve/play/display/render/synthesize dialog/exchange/response/presentation/experience/media/multimedia/expression/sound/speech/music/image/imaging/video/animation/webpage/text/message/notification/reminder/enquiry/warning, detect/recognize/monitor/interpret/analyze/record/store user/intruder/object input/motion/gesture/location/activity), activating/controlling/configuring (e.g. turn on/off/control/lock/unlock/open/close/adjust/configure) a device/system (e.g. vehicle/drone/electrical/mechanical/air-conditioning/heating/lighting/ventilation/clearning/entertainment/loT/security/siren/access system/device/door/window/garage/lift/elevator/escalator/speaker/television/light/peripheral/accessory/wearable/furniture/appliance/amenity/gadget/alarm/camera/gaming/coffee/cooking/heater/fan/housekeeping/home/office machine/device/robot/vacuum cleaner/assembly line), (d) miscellaneous task, any of: transmission/coding/encryption/storage/analysis of data/parameters/analytics/derived data, upgrading/administration/configuration/coordination/broadcasting/synchronization/networking/encryption/communication/protection/compression/storage/database/archiving/query/cloud computing/presentation/augmented/virtual reality/other processing/task. Task may be performed by some of: Type1/Type2/nearby/portable/another device, and/or hub/local/edge/cloud server.

Task may also comprise: detect/recognize/monitor/locate/interpret/analyze/record/store user/visitor/intruder/object/pet, interact/engage/converse/dialog/exchange with user/object/visitor/intruder/human/baby/pet, detect/locate/localize/recognize/monitor/analyze/interpret/learn/train/respond/execute/synthesize/generate/record/store/summarize health/well-being/daily-life/activity/behavior/pattern/exercise/food-intake/restroom visit/work/play/rest/sleep/relaxation/danger/routine/timing/habit/trend/normality/normalcy/anomaly/regularity/irregularity/change/presence/motion/gesture/gait/expression/emotion/state/stage/voice/command/instruction/question/quer y/music/sound/location/movement/fall-down/threat/discomfort/sickness/environment/, generate/retrieve/play/display/render/synthesize dialog/exchange/response/presentation/report/experience/media/multimedia/expression/sound/speech/music/image/imaging/video/animation/webpage/text/message/notification/reminder/enquiry/warning, detect/recognize/monitor/interpret/analyze/record/store user/intruder/object input/motion/gesture/location/activity), detect/check/monitor/locate/manage/control/adjust/configure/lock/unlock/arm/disarm/open/close/fully/partially/activate/turn on/off some system/device/object (e.g. vehicle/robot/drone/electrical/mechanical/air-conditioning/heating/ventilation/HVAC/lighting/cleaning/entertainment/IoT/security/siren/access systems/devices/items/components, door/window/garage/lift/elevator/escalator/speaker/television/light/peripheral/accessory/wearable/furniture/appliance/amenity/gadget/alarm/camera/gaming/coffee/cooking/heater/fan/housekeeping/home/office machine/device/vacuum cleaner/assembly line/window/garage/door/blind/curtain/panel/solar panel/sun shade), detect/monitor/locate user/pet do something (e.g. sitting/sleeping on sofa/in bedroom/running on treadmill/cooking/watching TV/eating in kitchen/dining room/going upstairs/downstairs/outside/inside/using rest room), do something (e.g. generate message/response/warning/clarification/notification/report) automatically upon detection, do something for user automatically upon detecting user presence, turn on/off/wake/control/adjust/dimlight/music/radio/TV/HiFi/STB/computer/speaker/smart device/air-conditioning/ventilation/heating system/curtains/light shades, turn on/off/pre-heat/control coffee-machine/hot-water-pot/cooker/oven/microwave oven/another cooking device, check/manage temperature/setting/weather forecast/telephone/message/mail/system check, present/interact/engage/dialog/converse (e.g. through smart speaker/display/screen; via webpage/email/messaging system/notification system).

When user arrives home by car, task may be to, automatically, detect user/car approaching, open garage/door upon detection, turn on driveway/garage light as user approaches garage, and/or turn on air conditioner/heater/fan. As user enters house, task may be to, automatically, turn on entrance light/off driveway/garage light, play greeting message to welcome user, turn on user's favorite music/radio/news/channel, open curtain/blind, monitor user's mood, adjust lighting/sound environment according to mood/current/imminent event (e.g. do romantic lighting/music because user is scheduled to eat dinner with girlfriend soon) on user's calendar, warm food in microwave that user prepared in morning, do diagnostic check of all systems in house, check weather forecast for tomorrow/news of interest to user, check calendar/to-do list, play reminder, check telephone answering/messaging system/email, give verbal report using dialog system/speech synthesis, and/or remind (e.g. using audible tool such as speakers/HiFi/speech synthesis/sound/field/voice/music/song/dialog system, using visual tool such as TV/entertainment system/computer/notebook/tablet/display/light/color/brightness/patterns symbols, using haptic/virtual reality/gesture/tool, using smart device/appliance/material/furniture/fixture, using server/hub device/cloud/fog/edge server/home/mesh network, using messaging/notification/communication/scheduling/email tool, using UI/GUI, using scent/smell/fragrance/taste, using neural/nervous system/tool, or any combination) user of someone's birthday/call him, prepare/give report. Task may turn on air conditioner/heater/ventilation system in advance, and/or adjust temperature setting of smart thermostat in advance. As user moves from entrance to living room, task may be to turn on living room light, open living room curtain, open window, turn off entrance light behind user, turn on TV/set-top box, set TV to user's favorite channel, and/or adjust an appliance according to user's preference/conditions/states (e.g. adjust lighting, choose/play music to build romantic atmosphere).

When user wakes up in morning, task may be to detect user moving around in bedroom, open blind/curtain/window, turn off alarm clock, adjust temperature from night-time to day-time profile, turn on bedroom light, turn on restroom light as user approaches restroom, check radio/streaming channel and play morning news, turn on coffee machine, preheat water, and/or turn off security system. When user walks from bedroom to kitchen, task may be to turn on kitchen/hallway lights, turn off bedroom/restroom lights, move music/message/reminder from bedroom to kitchen, turn on kitchen TV, change TV to morning news channel, lower kitchen blind, open kitchen window, unlock backdoor for user to check backyard, and/or adjust temperature setting for kitchen.

When user leaves home for work, task may be to detect user leaving, play farewell/have-a-good-day message, open/close garage door, turn on/off garage/driveway light, close/lock all windows/doors (if user forgets), turn off appliance (e.g. stove/microwave/oven), turn on/arm security system, adjust light/air-conditioning/heating/ventilation systems to “away” profile to save energy, and/or send alerts/reports/updates to user's smart phone.

Motion may comprise any of: no-motion, motion sequence, resting/non-moving motion, movement/change in position/location, daily/weekly/monthly/yearly/repeating/activity/behavior/action/routine, transient/time-varying/fall-down/repeating/repetitive/periodic/pseudo-periodic motion/breathing/heartbeat, deterministic/non-deterministic/probabilistic/chaotic/random motion, complex/combination motion, non-/pseudo-/cyclo-/stationary random motion, change in electro-magnetic characteristics, human/animal/plant/body/machine/mechanical/vehicle/drone motion, air-/wind-/weather-/water-/fluid-/ground/sub-surface/seismic motion, man-machine interaction, normal/abnormal/dangerous/warning/suspicious motion, imminent/rain/fire/flood/tsunami/explosion/collision, head/facial/eye/mouth/tongue/neck/finger/hand/arm/shoulder/upper/lower/body/chest/abdominal/hip/leg/foot/joint/knee/elbow/skin/below-skin/subcutaneous tissue/blood vessel/intravenous/organ/heart/lung/stomach/intestine/bowel/eating/breathing/talking/singing/dancing/coordinated motion, facial/eye/mouth expression, and/or hand/arm/gesture/gait/UI/keystroke/typing stroke.

Type1/Type2 device may comprise heterogeneous IC, low-noise amplifier (LNA), power amplifier, transmit-receive switch, media access controller, baseband radio, and/or 2.4/3.65/4.9/5/6/sub-7/over-7/28/60/76 GHz/another radio. Heterogeneous IC may comprise processor/memory/software/firmware/instructions. It may support broadband/wireless/mobile/mesh/cellular network. WLAN/WAN/MAN, standard/IEEE/3GPP/WiFi/4G/LTE/5G/6G/7G/8G, IEEE 802.11/a/b/g/n/ac/ad/af/ah/ax/ay/az/be/bf/15/16, and/or Bluetooth/BLE/NFC/Zigbee/WiMax.

Processor may comprise any of: general-/special-/purpose/embedded/multi-core processor, microprocessor/microcontroller, multi-/parallel/CISC/RISC processor, CPU/GPU/DSP/ASIC/FPGA, and/or logic circuit. Memory may comprise non-/volatile, RAM/ROM/EPROM/EEPROM, hard disk/SSD, flash memory, CD-/DVD-ROM, magnetic/optical/organic/storage system/network, network/cloud/edge/local/external/internal storage, and/or any non-transitory storage medium. Set of instructions may comprise machine executable codes in hardware/IC/software/firmware, and may be embedded/pre-loaded/loaded upon-boot-up/on-the-fly/on-demand/pre-installed/installed/downloaded.

Processing/preprocessing/postprocessing may be applied to data (e.g. TSCI/feature/characteristics/STI/MI/test quantity/intermediate/data/analytics) and may have multiple steps. Step/pre-/post-/processing may comprise any of: computing function of operands/LOS/non-LOS/single-link/multi-link/component/item/quantity, magnitude/norm/phase/feature/energy/timebase/similarity/distance/characterization score/measure computation/extraction/correction/cleaning, linear/nonlinear/FIR/IIR/MA/AR/ARMA/Kalman/particle filtering, lowpass/bandpass/highpass/median/rank/quartile/percentile/mode/selective/adaptive filtering. interpolation/intrapolation/extrapolation/decimation/subsampling/upsampling/resampling, matched filtering/enhancement/restoration/denoising/smoothing/conditioning/spectral analysis/mean subtraction/removal, linear/nonlinear/inverse/frequency/time transform, Fourier transform (FT)/DTFT/DFT/FFT/wavelet/Laplace/Hilbert/Hadamard/trigonometric/sine/cosine/DCT/power-of-2/sparse/fast/frequency transform, zero/cyclic/padding, graph-based transform/processing, decomposition/orthogonal/non-orthogonal/over-complete projection/eigen-decomposition/SVD/PCA/ICA/compressive sensing, grouping/folding/sorting/comparison/soft/hard/thresholding/clipping, first/second/high order derivative/integration/convolution/multiplication/division/addition/subtraction, local/global/maximization/minimization, recursive/iterative/constrained/batch processing, least mean square/absolute error/deviation, cost function optimization, neural network/detection/recognition/classification/identification/estimation/labeling/association/tagging/mapping/remapping/training/clustering/machine/supervised/unsupervised/semi-supervised learning/network, vector/quantization/encryption/compression/matching pursuit/scrambling/coding/storing/retrieving/transmitting/receiving/time-domain/frequency- domain/normalization/scaling/expansion/representing/merging/combining/splitting/tracking/monitoring/shape/silhouette/motion/activity/analysis, pdf/histogram estimation/importance/Monte Carlo sampling, error detection/protection/correction, doing nothing, time-varying/adaptive processing, conditioning/weighted/averaging/over selected components/links, arithmetic/geometric/harmonic/trimmed mean/centroid/medoid computation, morphological/logical operation/permutation/combination/sorting/AND/OR/XOR/union/intersection, vector operation/addition/subtraction/multiplication/division, and/or another operation. Processing may be applied individually/jointly. Acceleration using GPU/DSP/coprocessor/multicore/multiprocessing may be applied.

Function may comprise: characteristics/feature/magnitude/phase/energy, scalar/vector/discrete/continuous/polynomial/exponential/logarithmic/trigonometric/transcendental/logical/piecewise/linear/algebraic/nonlinear/circular/piecewise linear/real/complex/vector- valued/inverse/absolute/indicator/limiting/floor/rounding/sign/composite/sliding/moving function, derivative/integration, function of function, one-to-one/one-to-many/many-to-one/many-to-many function, mean/mode/median/percentile/max/min/range/statistics/histogram, local/global max/min/zero-crossing, variance/variation/spread/dispersion/deviation/standard deviation/divergence/range/interquartile range/total variation/absolute/total deviation, arithmetic/geometric/harmonic/trimmed mean/square/cube/root/power, thresholding/clipping/rounding/truncation/quantization/approximation, time function processed with an operation (e.g. filtering), sine/cosine/tangent/cotangent/secant/cosecant/elliptical/parabolic/hyperbolic/game/zeta function, probabilistic/stochastic/random/ergodic/stationary/deterministic/periodic/repeated function, inverse/transformation/frequency/discrete time/Laplace/Hilbert/sine/cosine/triangular/wavelet/integer/power-of-2/sparse transform, orthogonal/non-orthogonal/eigen projection/decomposition/eigenvalue/singular value/PCA/ICA/SVD/compressive sensing, neural network, feature extraction, function of moving window of neighboring items of time series, filtering function/convolution, short-time/discrete transform/Fourier/cosine/sine/Hadamard/wavelet/sparse transform, matching pursuit, approximation, graph-based processing/transform/graph signal processing. classification/identification/class/group/category/labeling, processing/preprocessing/postprocessing, machine/learning/detection/estimation/feature extraction/learning network/feature extraction/denoising/signal enhancement/coding/encryption/mapping/vector quantization/remapping/lowpass/highpass/bandpass/matched/Kalman/particle/FIR/IIR/MA/AR/ARMA/median/mode/adaptive filtering, first/second/high order derivative/integration/zero crossing/smoothing, up/down/random/importance/Monte Carlo sampling/resampling/converting, interpolation/extrapolation, short/long term statistics/auto/cross correlation/moment generating function/time averaging/weighted averaging, special/Bessel/Beta/Gamma/Gaussian/Poisson/integral complementary error function.

Sliding time window may have time-varying width/size. It may be small/large at beginning to enable fast/accurate acquisition and increase/decrease over time to steady-state size comparable to motion frequency/period/transient motion duration/characteristics/STI/MI to be monitored. Window size/time shift between adjacent windows may be constant/adaptively/dynamically/automatically changed/adjusted/varied/modified (e.g. based on battery life/power consumption/available computing power/change in amount of targets/nature of motion to be monitored/user request/choice/instruction/command).

Characteristics/STI/MI may be determined based on characteristic value/point of function and/or associated argument of function (e.g. time/frequency). Function may be outcome of a regression. Characteristic value/point may comprise local/global/constrained/significant/first/second/i\hat{ }th maximum/minimum/extremum/zero-crossing (e.g. with positive/negative time/frequency/argument) of function. Local signal-to-noise-ratio (SNR) or SNR-like parameter may be computed for each pair of adjacent local max (peak)/local min (valley) of function, which may be some function (e.g. linear/log/exponential/monotonic/power/polynomial) of fraction or difference of a quantity (e.g. power/magnitude) of local max over the quantity of local min. Local max (or min) may be significant if its SNR is greater than threshold and/or if its amplitude is greater (or smaller) than another threshold. Local max/min may be selected/identified/computed using persistence-based approach. Some significant local max/min may be selected based on selection criterion (e.g. quality criterion/condition, strongest/consistent significant peak in a range). Unselected significant peaks may be stored/monitored as “reserved” peaks for use in future selection in future sliding time windows. E.g. a particular peak (e.g. at particular argument/time/frequency) may appear consistently over time. Initially, it may be significant but not selected (as other peaks may be stronger). Later, it may become stronger/dominant consistently. When selected, it may be back-traced in time and selected in earlier time to replace previously selected peaks (momentarily strong/dominant but not persistent/consistent). Consistency of peak may be measured by trace, or duration of being significant. Alternatively, local max/min may be selected based on finite state machine (FSM). Decision thresholds may be time-varying, adjusted adaptively/dynamically (e.g. based on back-tracing timing/FSM, or data distribution/statistics).

A similarity score (SS)/component SS may be computed based on two temporally adjacent CI/CIC, of one TSCI or of two different TSCI. The pair may come from same/different sliding window(s). SS or component SS may comprise: time reversal resonating strength (TRRS), auto/cross correlation/covariance, inner product of two vectors, L1/L2/Lk/Euclidean/statistical/weighted/distance score/norm/metric/quality metric, signal quality condition, statistical characteristics, discrimination score, neural network/deep learning network/machine learning/training/discrimination/weighted averaging/preprocessing/denoising/signal conditioning/filtering/time correction/timing compensation/phase offset compensation/transformation/component-wise operation/feature extraction/FSM, and/or another score.

Any threshold may be fixed (e.g. 0, 0.5, 1, 1.5, 2), pre-determined and/or adaptively/dynamically determined (e.g. by FSM, or based on time/space/location/antenna/path/link/state/battery life/remaining battery life/available resource/power/computation power/network bandwidth). Threshold may be applied to test quantity to differentiate two events/conditions/situations/states, A and B. Data (e.g. CI/TSCI/feature/similarity score/test quantity/characteristics/STI/MI) may be collected under A/B in training situation. Test quantity (e.g. its distribution) computed based on data may be compared under A/B to choose threshold based on some criteria (e.g. maximum likelihood (ML), maximum aposterior probability (MAP), discriminative training, minimum Type1 (or 2) error for given Type 2 (or 1) error, quality criterion, signal quality condition). Threshold may be adjusted (e.g. to achieve different sensitivity), automatically/semi-automatically/manually/adaptively/dynamically, once/sometimes/often/periodically/repeatedly/occasionally/sporadically/on-demand (e.g. based on object/movement/location direction/action/characteristics/STI/MI/size/property/trait/habit/behavior/venue/feature/fixture/furniture/barrier/material/machine/living thing/thing/boundary/surface/medium/map/constraint/model/event/state/situation/condition/time/timing/duration/state/history/user/preference). An iterative algorithm may stop after N iterations, after time-out period, or after test quantity satisfies a condition (e.g. updated quantity greater than threshold) which may be fixed/adaptively/dynamically adjusted.

Searching for local extremum may comprise constrained/minimization/maximization, statistical/dual/constraint/convex/global/local/combinatorial/infinite-dimensional/multi-objective/multi-modal/non-differentiable/particle-swarm/simulation-based optimization, linear/nonlinear/quadratic/higher-order regression, linear/nonlinear/stochastic/constraint/dynamic/mathematical/disjunctive/convex/semidefinite/conic/cone/interior/fractional/integer/sequential/quadratic programming, conjugate/gradient/subgradient/coordinate/reduced descent, Newton's/simplex/iterative/point/ellipsoid/quasi-Newton/interpolation/memetic/genetic/evolutionary/pattern-/gravitational-search method/algorithm, constraint satisfaction, calculus of variations, optimal control, space mapping, heuristics/metaheuristics, numerical analysis, simultaneous perturbation stochastic approximation, stochastic tunneling, dynamic relaxation, hill climbing, simulated annealing, differential evolution, robust/line/Tabu/reactive search/optimization, curve fitting, least square, variational calculus, and/or variant. It may be associated with an objective/loss/cost/utility/fitness/energy function.

Regression may be performed using regression function to fit data, or function (e.g. ACF/transform/mapped) of data, in regression window. During iterations, length/location of regression window may be changed. Regression function may be linear/quadratic/cubic/polynomial/another function. Regression may minimize any of: mean/weighted/absolute/square deviation, error, aggregate/component/weighted/mean/sum/absolute/square/high-order/another error/cost (e.g. in projection domain/selected axes/orthogonal axes), robust error (e.g. first error (e.g. square) for smaller error magnitude, second error (e.g. absolute) for larger error magnitude), and/or weighted sum/mean of multiple errors (e.g. absolute/square error). Error associated with different links/path may have different weights (e.g. link with less noise may have higher weight). Regression parameter (e.g. time-offset associated with max/min regression error of regression function in regression window, location/width of window) may be initialized and/or updated during iterations (e.g. based on target value/range/profile, characteristics/STI/MI/test quantity, object motion/quantity/count/location/state, past/current trend, location/amount/distribution of local extremum in previous windows, carrier/subcarrier frequency/bandwidth of signal, amount of antennas associated with the channel, noise characteristics, histogram/distribution/central/F-distribution, and/or threshold). When converged, current time offset may be at center/left/right (or fixed relative location) of regression window.

In presentation, information may be displayed/presented (e.g. with venue map/environmental model). Information may comprise: current/past/corrected/approximate/map/location/speed/acceleration/zone/region/area/segmentation/coverage-area, direction/path/trace/history/traffic/summary, frequently-visited areas, customer/crowd event/distribution/behavior, crowd-control information, acceleration/speed/vital-sign/breathing/heart-rate/activity/emotion/sleep/state/rest information, motion-statistics/MI/STI, presence/absence of motion/people/pets/object/vital sign, gesture (e.g. hand/arm/foot/leg/body/head/face/mouth/eye)/meaning/control (control of devices using gesture), location-based gesture-control/motion-interpretation, identity/identifier (ID) (e.g. of object/person/user/pet/zone/region, device/machine/vehicle/drone/car/boat/bicycle/TV/air-con/fan/, self-guided machine/device/vehicle), environment/weather information, gesture/gesture control/motion trace, earthquake/explosion/storm/rain/fire/temperature, collision/impact/vibration. event/door/window/open/close/fall-down/accident/burning/freezing/water-/wind-/air-movement event, repeated/pseudo-periodic event (e.g. running on treadmill, jumping up/down, skipping rope, somersault), and/or vehicle event. Location may be one/two/three dimensional (e.g. expressed/represented as 1D/2D/3D rectangular/polar coordinates), relative (e.g. w.r.t. map/environmental model) or relational (e.g. at/near/distance-from a point, halfway between two points, around corner, upstairs, on table top, at ceiling, on floor, on sofa).

Information (e.g. location) may be marked/displayed with some symbol. Symbol may be time-varying/flashing/pulsating with changing color/intensity/size/orientation. Symbol may be a number reflecting instantaneous quantity (e.g. analytics/gesture/state/status/action/motion/breathing/heart rate, temperature/network traffic/connectivity/remaining power). Symbol/size/orientation/color/intensity/rate/characteristics of change may reflect respective motion. Information may be in text or presented visually/verbally (e.g. using pre-recorded voice/voice synthesis)/mechanically (e.g. animated gadget, movement of movable part).

User device may comprise smart phone/tablet/speaker/camera/display/TV/gadget/vehicle/appliance/device/IoT, device with UI/GUI/voice/audio/record/capture/sensor/playback/display/animation/VR/AR (augmented reality)/voice (assistance/recognition/synthesis) capability, and/or tablet/laptop/PC.

Map/floor plan/environmental model (e.g. of home/office/building/store/warehouse/facility) may be 2-/3-/higher-dimensional. It may change/evolve over time (e.g. rotate/zoom/move/jump on screen). Walls/windows/doors/entrances/exits/forbidden areas may be marked. It may comprise multiple layers (overlays). It may comprise maintenance map/model comprising water pipes/gas pipes/wiring/cabling/air ducts/crawl-space/ceiling/underground layout.

Venue may be segmented/subdivided/zoned/grouped into multiple zones/regions/sectors/sections/territories/districts/precincts/localities/neighborhoods/areas/stretches/expance such as bedroom/living/dining/rest/storage/utility/warehouse/conference/work/walkway/kitchen/foyer/garage/first/second floor/offices/reception room/area/regions. Segments/regions/areas may be presented in map/floor plan/model with presentation characteristic (e.g. brightness/intensity/luminance/color/chrominance/texture/animation/flashing/rate).

An example of disclosed system/apparatus/method. Stephen and family want to install disclosed wireless motion detection system to detect motion in their 2000 sqft two-storey town house in Seattle, Washington. Because his house has two storeys, Stephen decides to use one Type2 device (named A) and two Type1 devices (named B and C) in ground floor. His ground floor has three rooms: kitchen, dining and living rooms arranged in straight line, with dining room in middle. He put A in dining room, and B in kitchen and C in living room, partitioning ground floor into 3 zones (dining room, living room, kitchen). When motion is detected by AB pair and/or AC pair, system would analyze TSCI/feature/characteristics/STI/MI and associate motion with one of 3 zones.

When Stephen and family go camping in holiday, he uses mobile phone app (e.g. Android phone app or iPhone app) to turn on motion detection system. If system detects motion, warning signal is sent to Stephen (e.g. SMS, email, push message to mobile phone app). If Stephen pays monthly fee (e.g. $10/month), a service company (e.g. security company) will receive warning signal through wired (e.g. broadband)/wireless (e.g. WiFi/LTE/5G) network and perform security procedure (e.g. call Stephen to verify any problem, send someone to check on house, contact police on behalf of Stephen).

Stephen loves his aging mother and cares about her well-being when she is alone in house. When mother is alone in house while rest of family is out (e.g. work/shopping/vacation), Stephen turns on motion detection system using his mobile app to ensure mother is ok. He uses mobile app to monitor mother's movement in house. When Stephen uses mobile app to see that mother is moving around house among the three regions, according to her daily routine, Stephen knows that mother is ok. Stephen is thankful that motion detection system can help him monitor mother's well-being while he is away from house.

On typical day, mother would wake up at 7 am, cook her breakfast in kitchen for 20 minutes, eat breakfast in dining room for 30 minutes. Then she would do her daily exercise in living room, before sitting down on sofa in living room to watch favorite TV show. Motion detection system enables Stephen to see timing of movement in 3 regions of house. When motion agrees with daily routine, Stephen knows roughly that mother should be doing fine. But when motion pattern appears abnormal (e.g. no motion until 10 am, or in kitchen/motionless for too long), Stephen suspects something is wrong and would call mother to check on her. Stephen may even get someone (e.g. family member/neighbor/paid personnel/friend/social worker/service provider) to check on mother.

One day Stephen feels like repositioning a device. He simply unplugs it from original AC power plug and plugs it into another AC power plug. He is happy that motion detection system is plug-and-play and the repositioning does not affect operation of system. Upon powering up, it works right away.

Sometime later, Stephen decides to install a similar setup (i.e. one Type2 and two Type1 devices) in second floor to monitor bedrooms in second floor. Once again, he finds that system set up is extremely easy as he simply needs to plug Type2 device and Type1 devices into AC power plug in second floor. No special installation is needed. He can use same mobile app to monitor motion in both ground/second floors. Each Type2 device in ground/second floors can interact with all Type1 devices in both ground/second floors. Stephen has more than double capability with combined systems.

Disclosed system can be applied in many applications. Type1/Type2 devices may be any WiFi-enabled devices (e.g. smart IoT/appliance/TV/STB/speaker/refrigerator/stove/oven/microwave/fan/heater/air-con/router/phone/computer/tablet/accessory/plug/pipe/lamp/smoke detector/furniture/fixture/shelf/cabinet/door/window/lock/sofa/table/chair/piano/utensil/wearable/watch/tag/key/ticket/belt/wallet/pen/hat/necklace/implantable/phone/eyeglasses/glass panel/gaming device) at home/office/facility, on table, at ceiling, on floor, or at wall. They may be placed in conference room to count people. They may form a well-being monitoring system to monitor daily activities of older adults and detect any sign of symptoms (e.g. dementia, Alzheimer's disease). They may be used in baby monitors to monitor vital signs (breathing) of babies. They may be placed in bedrooms to monitor sleep quality and detect any sleep apnea. They may be placed in cars to monitor well-being of passengers and drivers, detect sleepy drivers or babies left in hot cars. They may be used in logistics to prevent human trafficking by monitoring any human hidden in trucks/containers. They may be deployed by emergency service at disaster area to search for trapped victims in debris. They may be deployed in security systems to detect intruders.

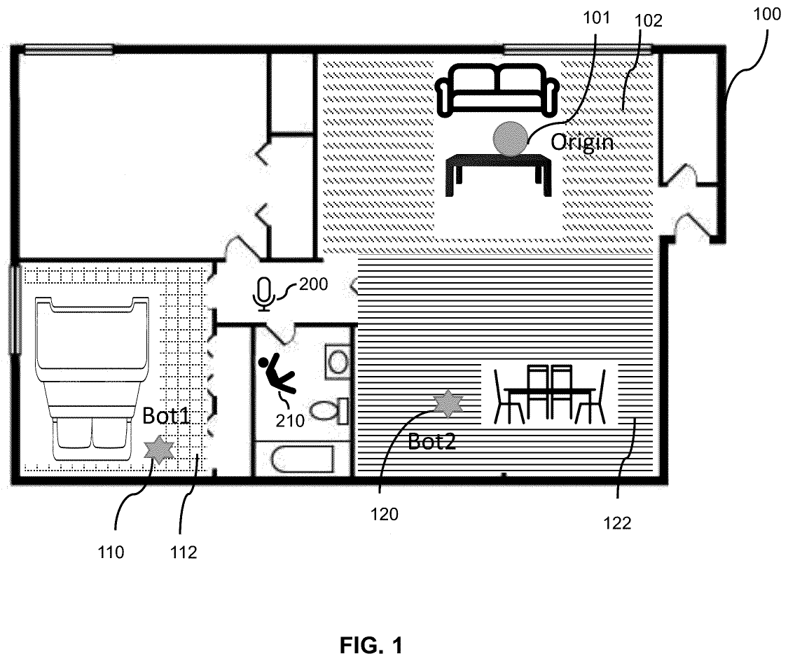

FIG. 1 illustrates an example scenario where a motion/event/activity (e.g. fall/abrupt/impulsive/transient/impactful motion, motion that generates sound/vibration/pressure change, or target motion) is detected (or monitored) based on wireless signal or auxiliary signal or both in a venue, according to one embodiment of the present teaching. For example, as shown in FIG. 1, in a 2-bedroom apartment 100, Origin 101 (Type2 device) may be placed in the living-room area 102, Bot 1 110 (e.g. Type1 device) may be placed in a bedroom1-area 112, and Bot 2 120 (e.g. Type1 device) may be placed in the dining-room area 122. A sensor 200 (e.g. microphone/camera/light sensor/pressure sensor) may also be placed somewhere in the apartment 100 to capture auxiliary sensing signals (e.g. sound/image/video/light/pressure/vibration). During the motion/event/activity (e.g. a person 210 falls down making sound that is picked up by microphone sensor 200), each of Bot 1 110 and Bot 2 120 can transmit a wireless (sounding/probe) signal to the Origin 101, which can obtain channel information of a wireless multipath channel based on the wireless signal. A motion information (MI) or radio-based MI (RMI) can be computed based on the channel information. During the motion/event/activity, the sensor 200 can capture an associated auxiliary signal. An aux-based motion information (AMI) can be computed based on the auxiliary signal. The motion/event/activity can be detected/monitored individually based on the RMI alone (radio-based), individually based on the AMI alone (aux-based), or jointly based on both the RMI and AMI (radio-aux-based, e.g. sequentially radio-based followed by aux-based, or sequentially aux-based followed by radio-based, or simultaneously/contemporaneously by both radio-based and aux-based).

If object motion/activity is detected based on wireless signals transmitted by both Bot 1 110 and Bot 2 120, localization may be performed such that a location of the activity/motion/event or the object (e.g. person/user) may be determined the living-room area 102. If detection is based only on wireless signals transmitted by Bot 1 110, the location may be determined to be in the bedroom-1 area 112. If detection is based only on wireless signals transmitted by Bot 2 120, the location may be determined in the dining-room area 122. If target motion/event/activity cannot be detected based on wireless signals transmitted by either Bot 1 110 or Bot 2 120, then it may be determined that nobody and no object is in the apartment 100. The corresponding area where the activity/motion/event/person/user is detected may be marked with a predetermined pattern.

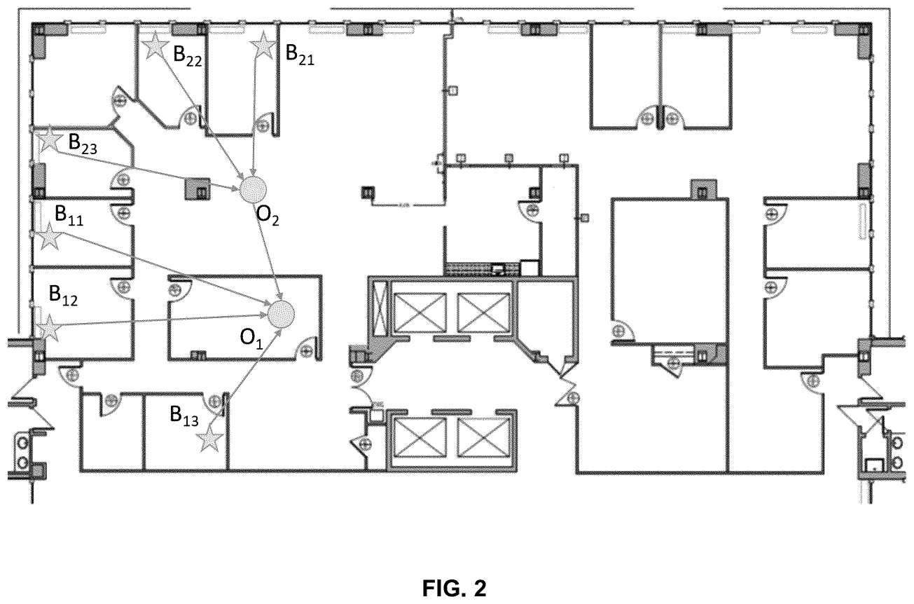

FIG. 2 illustrates an example floor plan and placement of wireless devices for wireless monitoring with motion/event/activity detection and localization, according to some embodiments of the present disclosure. In the example shown in FIG. 2, there are two origins O1 and O2. Each origin is associated with three bots. For example, O1 is associated with bots B11, B12, and B13 (together constitute a first origin group); and O2 is associated with bots B21, B22, and B23 (together constitute a second origin group). Each device of the bots and origins is fixed at a different location. In one embodiment, the origin O1 is called a master origin; and the origin O2 is called a child origin, where the child origin can transmit statistics and information to the master origin for combination.

In some embodiments, the floor plan and placement of wireless devices in FIG. 2 can be used to perform multi-person or multi-object motion localization based on motion statistics. When there are two or more origins, motion statistics (or RMI) measured from different links of different origins are combined to contribute together to the motion localization. For each activated bot, it is determined which origin the bot is associated with, e.g. based on a smoothed motion statistics in a time window. For example, when the smoothed motion statistics of Bot k with respect to Origin j is larger than a threshold, Bot k is determined to be associated with Origin j. The same threshold can be used for other origins. Thus, for each origin, a set of activated bots associated with the origin can be determined. A likelihood is calculated for each activated bot k to detect a motion, and is smoothed over a time window. For each origin group including an origin and its associated bots (e.g. O1, B11, B12, B13), an average motion statistics is computed for the origin group across all the associated bots. Each calculation or computation above can be performed at the origin or the bot.

When there is any motion detected in the environment, an origin group with the highest average motion statistics is chosen. When the average motion statistics of the chosen origin group is larger than a threshold, the motion is determined to be around the origin of the group. Otherwise, when the average motion statistics of the chosen origin group is not larger than a threshold, the motion is determined to be around the bot with the highest likelihood within the origin group.

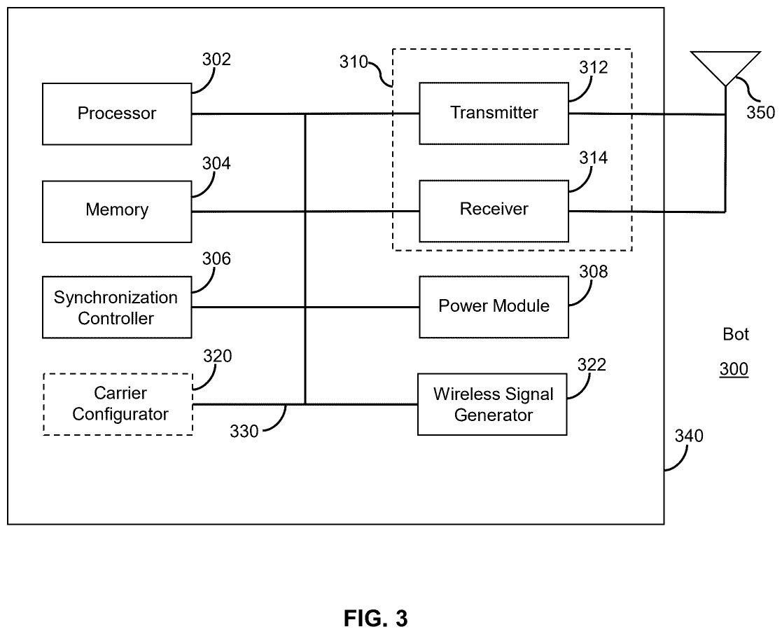

FIG. 3 illustrates an example block diagram of a first wireless device, e.g. a Bot 300, of a wireless sensing system, according to one embodiment of the present teaching. The Bot 300 is an example of a device that can be configured to implement the various methods described herein. As shown in FIG. 3. the Bot 300 includes a housing 340 containing a processor 302, a memory 304, a transceiver 310 comprising a transmitter 312 and receiver 314, a synchronization controller 306, a power module 308, an optional carrier configurator 320 and a wireless signal generator 322.

In this embodiment, the processor 302 controls the general operation of the Bot 300 and can include one or more processing circuits or modules such as a central processing unit (CPU) and/or any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable circuits, devices and/or structures that can perform calculations or other manipulations of data.

The memory 304, which can include both read-only memory (ROM) and random access memory (RAM), can provide instructions and data to the processor 302. A portion of the memory 304 can also include non-volatile random access memory (NVRAM). The processor 302 typically performs logical and arithmetic operations based on program instructions stored within the memory 304. The instructions (a.k.a., software) stored in the memory 304 can be executed by the processor 302 to perform the methods described herein. The processor 302 and the memory 304 together form a processing system that stores and executes software. As used herein, “software” means any type of instructions, whether referred to as software, firmware, middleware, microcode, etc. which can configure a machine or device to perform one or more desired functions or processes. Instructions can include code (e.g., in source code format, binary code format, executable code format, or any other suitable format of code). The instructions, when executed by the one or more processors, cause the processing system to perform the various functions described herein.

The transceiver 310, which includes the transmitter 312 and receiver 314, allows the Bot 300 to transmit and receive data to and from a remote device (e.g., an Origin or another Bot). An antenna 350 is typically attached to the housing 340 and electrically coupled to the transceiver 310. In various embodiments, the Bot 300 includes (not shown) multiple transmitters, multiple receivers, and multiple transceivers. In one embodiment, the antenna 350 is replaced with a multi-antenna array 350 that can form a plurality of beams each of which points in a distinct direction. The transmitter 312 can be configured to wirelessly transmit signals having different types or functions, such signals being generated by the processor 302. Similarly, the receiver 314 is configured to receive wireless signals having different types or functions, and the processor 302 is configured to process signals of a plurality of different types.

The Bot 300 in this example may serve as Bot 1 110 or Bot 2 120 in FIG. 1 for detecting object motion in a venue. For example, the wireless signal generator 322 may generate and transmit, via the transmitter 312, a wireless signal through a wireless multipath channel impacted by a motion of an object in the venue. The wireless signal carries information of the channel. Because the channel was impacted by the motion, the channel information includes motion information that can represent the motion of the object. As such, the motion can be indicated and detected based on the wireless signal. The generation of the wireless signal at the wireless signal generator 322 may be based on a request for motion detection from another device, e.g. an Origin, or based on a system pre-configuration. That is, the Bot 300 may or may not know that the wireless signal transmitted will be used to detect motion.

The synchronization controller 306 in this example may be configured to control the operations of the Bot 300 to be synchronized or un-synchronized with another device, e.g. an Origin or another Bot. In one embodiment, the synchronization controller 306 may control the Bot 300 to be synchronized with an Origin that receives the wireless signal transmitted by the Bot 300. In another embodiment, the synchronization controller 306 may control the Bot 300 to transmit the wireless signal asynchronously with other Bots. In another embodiment, each of the Bot 300 and other Bots may transmit the wireless signals individually and asynchronously.

The carrier configurator 320 is an optional component in Bot 300 to configure transmission resources, e.g. time and carrier, for transmitting the wireless signal generated by the wireless signal generator 322. In one embodiment, each CI of the time series of CI has one or more components each corresponding to a carrier or sub-carrier of the transmission of the wireless signal. The detection of the motion may be based on motion detections on any one or any combination of the components.

The power module 308 can include a power source such as one or more batteries, and a power regulator, to provide regulated power to each of the above-described modules in FIG. 3. In some embodiments, if the Bot 300 is coupled to a dedicated external power source (e.g., a wall electrical outlet), the power module 308 can include a transformer and a power regulator.

The various modules discussed above are coupled together by a bus system 330. The bus system 330 can include a data bus and, for example, a power bus, a control signal bus, and/or a status signal bus in addition to the data bus. It is understood that the modules of the Bot 300 can be operatively coupled to one another using any suitable techniques and mediums.

Although a number of separate modules or components are illustrated in FIG. 3, persons of ordinary skill in the art will understand that one or more of the modules can be combined or commonly implemented. For example, the processor 302 can implement not only the functionality described above with respect to the processor 302, but also implement the functionality described above with respect to the wireless signal generator 322. Conversely, each of the modules illustrated in FIG. 3 can be implemented using a plurality of separate components or elements.

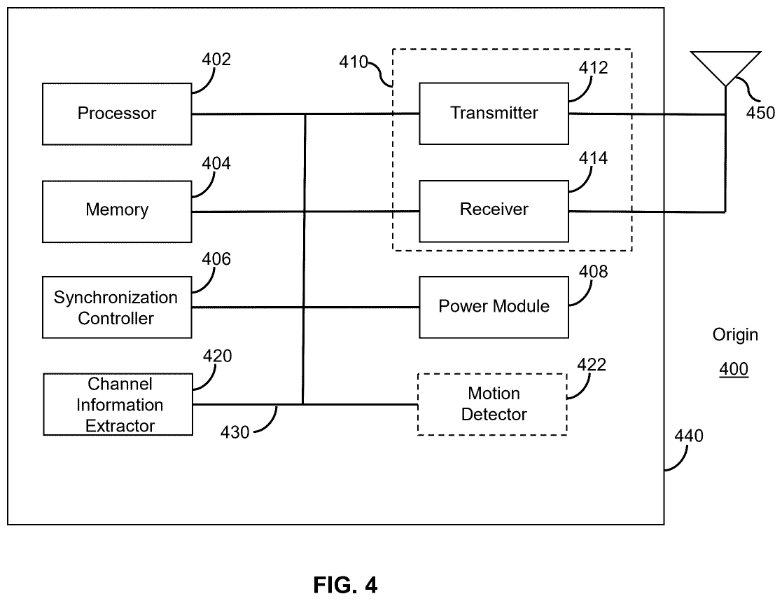

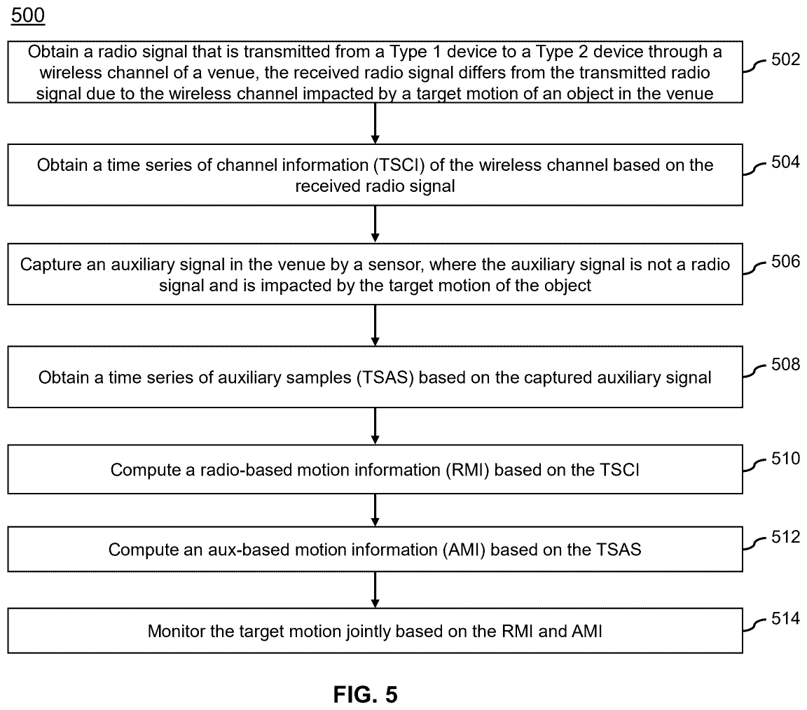

FIG. 4 illustrates an example block diagram of a second wireless device, e.g. an Origin 400, of a wireless sensing system, according to one embodiment of the present teaching. The Origin 400 is an example of a device that can be configured to implement the various methods described herein. The Origin 400 in this example may serve as Origin 101 in FIG. 1 for detecting object motion in a venue. As shown in FIG. 4, the Origin 400 includes a housing 440 containing a processor 402, a memory 404, a transceiver 410 comprising a transmitter 412 and a receiver 414, a power module 408, a synchronization controller 406, a channel information extractor 420, and an optional motion detector 422.

In this embodiment, the processor 402, the memory 404, the transceiver 410 and the power module 408 work similarly to the processor 302, the memory 304, the transceiver 310 and the power module 308 in the Bot 300. An antenna 450 or a multi-antenna array 450 is typically attached to the housing 440 and electrically coupled to the transceiver 410.

The Origin 400 may be a second wireless device that has a different type from that of the first wireless device (e.g. the Bot 300). In particular, the channel information extractor 420 in the Origin 400 is configured for receiving the wireless signal through the wireless multipath channel impacted by the motion of the object in the venue, and obtaining a time series of channel information (CI) of the wireless multipath channel based on the wireless signal. The channel information extractor 420 may send the extracted CI to the optional motion detector 422 or to a motion detector outside the Origin 400 for detecting object motion in the venue.

The motion detector 422 is an optional component in the Origin 400. In one embodiment, it is within the Origin 400 as shown in FIG. 4. In another embodiment, it is outside the Origin 400 and in another device, which may be a Bot, another Origin, a cloud server, a fog server, a local server, and an edge server. The optional motion detector 422 may be configured for detecting the motion of the object in the venue based on motion information related to the motion of the object. The motion information associated with the first and second wireless devices is computed based on the time series of CI by the motion detector 422 or another motion detector outside the Origin 400.

The synchronization controller 406 in this example may be configured to control the operations of the Origin 400 to be synchronized or un-synchronized with another device, e.g. a Bot, another Origin, or an independent motion detector. In one embodiment, the synchronization controller 406 may control the Origin 400 to be synchronized with a Bot that transmits a wireless signal. In another embodiment, the synchronization controller 406 may control the Origin 400 to receive the wireless signal asynchronously with other Origins. In another embodiment, each of the Origin 400 and other Origins may receive the wireless signals individually and asynchronously. In one embodiment, the optional motion detector 422 or a motion detector outside the Origin 400 is configured for asynchronously computing respective heterogeneous motion information related to the motion of the object based on the respective time series of CI.

The various modules discussed above are coupled together by a bus system 430. The bus system 430 can include a data bus and, for example, a power bus, a control signal bus, and/or a status signal bus in addition to the data bus. It is understood that the modules of the Origin 400 can be operatively coupled to one another using any suitable techniques and mediums.

Although a number of separate modules or components are illustrated in FIG. 4, persons of ordinary skill in the art will understand that one or more of the modules can be combined or commonly implemented. For example, the processor 402 can implement not only the functionality described above with respect to the processor 402, but also implement the functionality described above with respect to the channel information extractor 420. Conversely, each of the modules illustrated in FIG. 4 can be implemented using a plurality of separate components or elements.

In one embodiment, in addition to the Bot 300 and the Origin 400, the system may also comprise: an assistance device, a third wireless device, e.g. another Bot, configured for transmitting an additional heterogeneous wireless signal through an additional wireless multipath channel impacted by the motion of the object in the venue, or a fourth wireless device, e.g. another Origin, that has a different type from that of the third wireless device. The fourth wireless device may be configured for: receiving the additional heterogeneous wireless signal through the additional wireless multipath channel impacted by the motion of the object in the venue, and obtaining a time series of additional channel information (CI) of the additional wireless multipath channel based on the additional heterogeneous wireless signal. The additional CI of the additional wireless multipath channel is associated with a different protocol or configuration from that associated with the CI of the wireless multipath channel. For example, the wireless multipath channel is associated with LTE, while the additional wireless multipath channel is associated with Wi-Fi. In this case, the optional motion detector 422 or a motion detector outside the Origin 400 is configured for detecting the motion of the object in the venue based on both the motion information associated with the first and second wireless devices and additional motion information associated with the third and fourth wireless devices computed by at least one of: an additional motion detector and the fourth wireless device based on the time series of additional CI.

In some embodiments, the present teaching discloses systems and methods for wireless sensing based on a network comprising local groups of wireless devices.

In some embodiments, a combination of local subsystems with a main system is disclosed. One aspect of the present teaching is about performing wireless sensing in a venue with multiple groups of devices, establishing (a) a local wireless sensing subsystem based on each group of devices, and (b) a main wireless sensing system in the venue linking/connecting all the local wireless sensing subsystems.

Grouping of devices. For a venue, a user may define a number of groups and assign each device in the venue to a group. The user may use a user device (e.g. smart phone, computer, tablet or other smart device) to connect/interact with each device to assign the device to the groups. For example, each group of devices may be associated with a certain area/zone (e.g. bedroom, kitchen, living room) in the venue (e.g. a house). There may be multi-tier or hierarchical grouping. In a high level, there may be no subdivision such that all devices are in the same group (e.g. all devices in a house considered as one group). In the next level, the group may be subdivided into two or more subgroups (e.g. a “first-floor” subgroup comprising devices in first floor of the house, a “second-floor” subgroup comprising devices in second floor). In the next level, a subgroup may be subdivided into two or more sub-sub-groups (e.g. second-floor devices subdivided into sub-subgroups such as “bedroom 1”, “bedroom 2”, etc.: first-floor devices subdivided into sub-subgroups such as “kitchen”, “living room”, “dining room”, etc.) and so on.

Network of networks configuration. The main wireless sensing system comprises a network of devices in a star configuration with a device in the center of the star configuration (called “main center device”) and a number of devices at the vertices of the star configuration (called “main terminal devices”) linked/connected radially to the main center device. Similarly, each subsystem comprises a network (or sub-network, called “local sub-network”) of devices in a star configuration with a corresponding local device in the center of the star configuration (called “local center device”) and a number of devices at the vertices of the star configuration (called “local terminal devices”) linked/connected radially to the local center devices.

In some embodiments, the user may designate each device to the roles of main center device, main terminal devices, local center devices and local terminal devices. A device may be designated to multiple roles (e.g. both a main terminal device and a local terminal device). If the user does not differentiate the devices in a particular into local center device and local terminal device, a certain algorithm may be applied to automatically choose one of a group of devices to be local center device. For example, a criterion for the choice of local center device may be the ability to be an access point (AP), or the ability to multi-cast/broadcast. The device with recent multi-cast may be chosen.

Wireless sensing in local subsystems/networks. Wireless sensing measurements take place in the subsystems (local sub-networks). The devices may be configured to perform wireless sensing in each link (or branch) of each subsystem (local sub-network). In other words, pairwise wireless sensing is performed between the local center device and each local terminal device. In each link, a first device (either the local center device or the local terminal device) functions as a Type1 device to transmit a wireless signal (e.g. a train of sounding signals, null-data-packet, NDP, NDP announcement, NDPA, NDPA sounding, trigger-based (TB) sensing, non-TB sensing, trigger frame (TF) sounding, NDPA sounding, initiator-to responder (I2R) sounding, responder-to-initiator (R2I) sounding) to the second device. The second device (either the local terminal device or the local center device) obtains information of the wireless channel (channel information or CI, such as CSI, CIR, CFR, etc.) based on the received wireless signal. It may perform some WiFi sensing computational tasks based on the CI to obtain raw sensing data. It may transmit/report the raw sensing data to the first device. It may transmit/report the CI to the first device which would perform some WiFi sensing computational tasks based on the CI to obtain raw sensing data.

In some embodiments, if the local center device is the first device in multiple links in the local sub-network, it may broadcast, multi-cast and/or unicast the wireless signal(s) to the local terminal devices in the multiple links. In some embodiments, if the local center device is the second device in multiple links, the local terminal devices in the multiple links may transmit the respective wireless signals simultaneously and/or sequentially. Such transmission may be in response to some signal (e.g. trigger signal, trigger frame, polling signal) from the local center device.

In some embodiments, the main center device may establish a local subsystem (local sub-network) with itself being the local center device of the star configuration of the local subsystem and may take part in wireless sensing accordingly.

Details of sensing setup and signaling. More than one wireless signals may be simultaneously transmitted using different frequency bands, different frequency subbands, different frequency carriers, different antennas, and/or different beamforming/beamformer. The configuration of the devices, configuration (e.g. sensing session setup, sensing measurement setup, sensing-by-proxy (SBP) setup) of each pair of devices performing pairwise wireless sensing, transmission of the wireless signal, and/or the obtaining of channel information may be based on a standard (e.g. 802.11, 802.11bf, 4G, 5G, 6G, 7G, 8G, etc.). The transmission of the wireless signal may be in response or correlated to another wireless signal or wireless handshake/procedure (e.g. trigger signal, request, SBP request, sensing session set up, sensing measurement set up). The transmission of the wireless signal may be associated with an identification (ID, e.g. session ID, measurement ID, session setup ID, measurement setup ID, measurement instance ID, time code, etc.).

Main network and local sub-network linkage. In some embodiments of the present teaching, a local sub-network may be linked to the main network in 3 possible methods: (a) via the local center device of the local sub-network, (b) via the local terminal devices of the local sub-network, or (c) via both the local center device and at least one terminal device.

In Method (a), the local center device of the local sub-network is linked/connected to the main center device in the main network. In other words, the local center device is also a main terminal device. The local center device may function as the second device such that the wireless signals may be transmitted from the local terminal devices to the local center device. TB sensing with TF sounding may be used. Non-TB sensing with I2R sounding may be used. Alternatively, the local center device may function as the first device such that the wireless signal(s) may be broadcasted/multi-casted/unicasted/transmitted from the local center device to the local terminal devices. TB sounding may be used. NDPA sounding may be used. The CI obtained by the local terminal device, or raw sensing data computed based on the CI by the local terminal device, may be transmitted/reported to the local center device.

In Method (b), each local terminal device is linked/connected to the main center device. In other words, each local terminal device is also a main terminal device. The local center device may function as the first device such that the wireless signal(s) may be broadcasted, multi-casted or unicasted from the local center device to the local terminal devices. Alternatively, the local center device may function as the second device such that the wireless signals are transmitted from the local terminal devices to the local center device. The CI obtained by the local center device, or raw sensing data computed based on the CI by the local center device, may be transmitted/reported to the local terminal device.

In Method (c), both the local center device and at least one local terminal device are linked/connected to the main center device. Method (c) is a hybrid between (a) and (b). The local center device may function as the first device such that the wireless signal(s) may be broadcasted, multi-casted or unicasted from the local center device to the local terminal devices. The local center device may function as the second device in some links such that the wireless signals are transmitted from the local terminal devices to the local center device.

Center devices being AP. Note that each center device may be an access point of the corresponding network. For example, a local center device may be the access point (AP) of the corresponding local sub-network, while the main center device may be AP of the main network. The center device may have broadband/internet access.

Local terminal device network usage. For Method (a), (b) or (c) in which a local device in a local sub-network (either local center device or local terminal device) may be simultaneously a main terminal device, the local device may be associated with the local sub-network using one channel or one band (e.g. a 2.4 GHz channel, a 5 GHz channel, a 60 GHz channel, a millimeter wave channel, a UWB channel) and a second network of the main center device using a second channel or a second band (e.g. a 2.4 GHz channel, a 5 GHz channel, a 60 GHz channel, a millimeter wave channel, a UWB channel) simultaneously. The local device may be a dual-band, tri-band, quad-band or higher-band device. It may use the first network to perform wireless sensing (transmit or receive wireless signal and obtain raw sensing result/data computed based on CI obtained from the wireless signal) and use the second network to transmit the raw sensing data to the main center device.

Main center device network usage. The main center device may simultaneous be a local center device associated with its own or “personal” local sub-network. In addition to be AP for the main network, it may simultaneously be the AP of its personal local sub-network. It may use a first channel or a first band for the main network and use a second channel or a second band for the personal local sub-network. The first channel and the second channel may be the same or different. The personal local sub-network and the main network may be the same network.

The main center device may use the main network to receive raw sensing data (or result) from the local sub-networks and to send configuration or software update information to the local terminal devices. Configuration or software update information for the local center device may be sent by the main center device to the local center device directly using the main network. The configuration or software update information for the local center device may also be sent by the main center device to a local terminal device using the main network enroute to the local center device via the local sub-network.

In some embodiments, the main center device may use its personal local sub-network to perform wireless sensing. The resulting raw sensing data obtained in the wireless sensing may be transmitted/reported to the main center device via the personal local sub-networks or the main network.

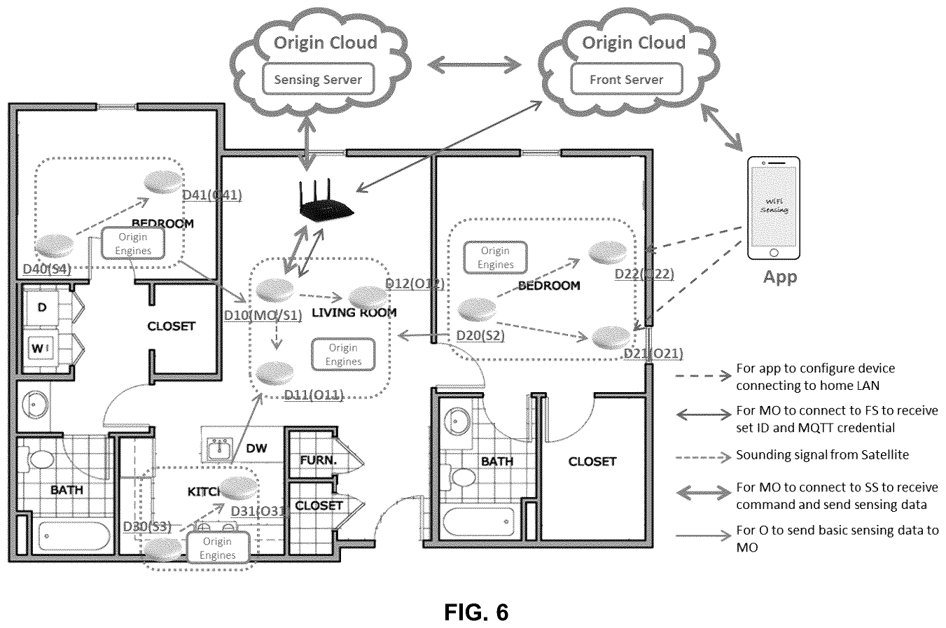

An example of performing wireless sensing in a venue with multiple groups of devices based on the disclosed method is illustrated in FIG. 6. The venue is a house with four zones, including two bedroom areas, a living room area and a kitchen area. The house has a WiFi router that has broadband connection to two cloud servers: a sensing server and a front server. The WiFi router establishes a home WiFi network with SSID MYHOME. The wireless sensing system comprises four subsystems formed by ten WiFi devices in the house. Three of the devices D10, D11, and D12 together form the first subgroup of devices that constitute a first subsystem or local sub-network to monitor a first zone (the living room area). Another three devices D20, D21, and D22 together form the second subgroup of devices that constitute a second subsystem or local sub-network to monitor a second zone (a bedroom area). Two devices D30 and D31 together form the third subgroup of devices that constitute a third subsystem to monitor a third zone (the kitchen area). Two devices D40 and D41 together form the fourth subgroup of devices that constitute a fourth subsystem (local sub-network) to monitor a fourth zone (another bedroom area).

In some embodiments, among the devices, D10 is the designated main center device, called master origin (MO), of the main network and the designated local center device of the first local sub-network. D11 and D12 are the designated local terminal devices of the first local sub-network. D10 has a dual band WiFi router chip with a 2.4 GHz band radio and a 5 GHz band radio. D10 is configured to be an AP to establish the first local sub-network with an SSID of “SENSE-SUBNET-01” using the 5 GHz radio. Each of D11 and D12 is a WiFi-enabled IoT device and is configured to associate with D10 and join the SENSE-SUBNET-01 network using the 5 GHz radio. Wireless sensing is performed in the first local sub-network with D10 broadcasting/multi-casting/unicasting a series of sounding signals to D11 and D12, each of which extracts CSI from the received sounding signals and performs at least one sensing computation task based on the CSI (e.g. motion detection, breathing detection, fall-down detection, etc.) to obtain raw sensing results (e.g. labels such as “motion detected”, “motion not detected”, “breathing detected”, “breathing not detected”, “fall-down detected”, “fall-down not detected”, motion statistics, breathing rate, etc.). In FIG. 6, a device marked “(O ##)” is an Origin (or Type2 device): a device marked “(S #)” (e.g. “S1” or “S2” or “S3” or “S4”) is a Satellite. In some embodiments, a Satellite is basically Tx or transmitter or Type1 device; while an Origin is basically Rx or receiver or Type2 device.

In some embodiments, all the devices (D10, D11, D12, D20, D21, D22, D30, D31, D40, D41) are configured to associate with the MYHOME home WiFi network using the 2.4 GHz. radio. The subsystems report/transmit raw sensing results to the main center device (D10) or cloud server using MYHOME home WiFi network.

In a similar manner, each of the other local sub-networks has a designated local center device (e.g. D20 for the second local sub-network, D30 for the third and D40 for the fourth) and a number of designated local terminal devices. The designated local center device is configured to be an AP to establish the corresponding local sub-network with a corresponding SSID (“SENSE-SUBNET-02” for the second local sub-network. “SENSE-SUBNET-03” for the third. “SENSE-SUBNET-04” for the fourth) using the 5 GHz. radio. Each designated local terminal device is configured to associate with the corresponding local center device and join the corresponding local sub-network. To perform the wireless sensing, the local center device transmits/broadcasts/multi-casts/unicasts a series of sounding signals to the local terminal device(s). Each local terminal device obtains CSI from the received sounding signals. performs at least one sensing computation task based on the CSI to obtain raw sensing results. The raw sensing results may be reported/transmitted to the main center device (D10) or cloud servers using the MYHOME home WiFi network. In some embodiments, the main center device (D10) may be configured to combine/process/fuse the raw sensing results and/or to report/transmit the results to the cloud servers.

In some embodiments, a plurality of wireless devices (a set of heterogeneous wireless devices) in a venue (e.g. home) may be grouped into N+1 groups/networks (N>2), comprising a “main group” (Tier-1 network) and N “subgroups” (Tier-2/3/ . . . /K networks). The groups/networks may be overlapping. e.g. two groups/networks may share a common device (i.e. a device may be in both the main group and a subgroup). A subgroup (Tier-2/Tier-3/ . . . /Tier-K network) may/may not be a subset of the main group. Each subgroup (Tier-K network for some K>1) may comprise at least one device (called “particular wireless devices”) being also in the main group (Tier-1 network).

In some embodiments, one of the N+1 groups may be a “main” group (first subset) of wireless devices, and may constitute a “main wireless sensing system”. with one device being “main center device” (first device) and the others in the group being “main terminal device(s)” (Tier-1 devices). All devices in the main group may be communicatively coupled in a “main” wireless network/Tier-1 network (e.g. home WiFi network “MyHome”) via a “main” wireless channel (first wireless channel) based on a “main” protocol (first protocol. e.g. 2.4 GHz. WiFi. 802.11 standard. 20 MHz channel). All devices in the main group may be associated with a “main” access-point (AP. e.g. home AP) and the “main” wireless network may be a wireless network associated with the main AP (e.g. home WiFi network).

In some embodiments, each of N remaining groups may be a “subgroup” (or Tier-2 group) of wireless devices, and may constitute a “sub-system” or a local system. with one device being “local center device” and the others in the subgroup being “local terminal device(s)”. All devices in a respective subgroup may be communicatively coupled in a respective wireless network or a respective local sub-network via a respective “local” wireless channel based on a respective “local” protocol (e.g. one subgroup may use 5 GHz, WiFi, 802.11 standard, 20 MHz channel; another subgroup may use 5 GHz, WiFi, 80 MHz. channel). The respective local center device may function as a respective AP and the respective wireless network or respective local sub-network may be the associated wireless network.

In a subgroup, the local center device may be either the main center device, or a main terminal device. None, one, more than one, or all, of local terminal device(s) of the subgroup may be either the main center device, or a main terminal device. Wireless channels used by the main group (e.g. 2.4 GHz. WiFi) may be different from those used by the subgroups (e.g. 5 GHz. WiFi).

Except for the main group, each group (Tier-K network, K>1) may be used to perform wireless sensing measurement (sensing measurement setup, transmission of wireless sounding signals, extraction of channel information (TSCI), polling/reporting/termination, computation of pairwise sensing analytics, aggregation of pairwise sensing analytics to compute combined sensing analytics). A gateway device in each group/Tier-K network may be used to report sensing results obtained/computed in the Tier-K network to a device in a Tier-(K−1) network.

The N+1 networks may be configured to form a network of networks, with a multi-tier structure. A Tier-K network reports sensing results to a Tier-(K−1) network, for any K>1. Tier-1 network may be the main network. The N groups may form N sub-networks (performing sensing measurements), and one group may be in a main network (enabling communication of sensing results/analytics/TSCI).

A gateway device may comprise multiple radios (e.g. 2.4 GHz radio and 5 GHz. radio), and may use them to join more than one networks. For example, a Tier-3 gateway device (e.g. third particular wireless device) may use 5 GHz/6 GHz. radio to join a Tier-3 network for performing/obtaining sensing measurements (e.g. TSCI, pairwise sensing analytics) and may use 2.4 GHz radio to join Tier-1 network (e.g. first network, home network)) and use the Tier-1 network to send sensing results computed in the Tier-3 network from the Tier-3 network to a gateway device of a Tier-2 network (e.g. second particular wireless device) via the Tier-1 network. Similarly, the Tier-2 network may use its own 2.4 GHz radio to join the Tier-1 network and to use its 5 GHz/6 GHz radio to perform/obtain sensing measurements.

In some embodiments, a gateway device links/connects two networks: a Tier-(K−1) network and a Tier-K network (e.g. Tier-1 network and Tier-2 network). Sensing results obtained in the Tier-K network may be transmitted from the Tier-K network to the Tier-(K−1) network (via the Tier-1 network).

In some embodiments, first combined analytics is associated with first wireless network (Tier-1). First device may compute first combined analytics by aggregating combined analytics from Tier-2 networks. Second combined analytics/particular device are associated with second wireless network (Tier-2). Third combined analytics/particular device are associated with third wireless network (Tier-3). Fourth combined analytics/particular device are associated with fourth wireless network (Tier-3). Fifth combined analytics/particular device are associated with fifth wireless network (Tier-2).

In some embodiments, pairwise sensing analytics may comprise a characteristics/spatial-temporal information (STI)/motion information (MI) of an object or a motion of the object. Pairwise sensing analytics may be based on a similarity score between a pair of temporally adjacent CI of a TSCI. The combined sensing analytics may be simply the pairwise sensing analytics (e.g. in the case of only 2 sensing devices in second network (Tier-K network).

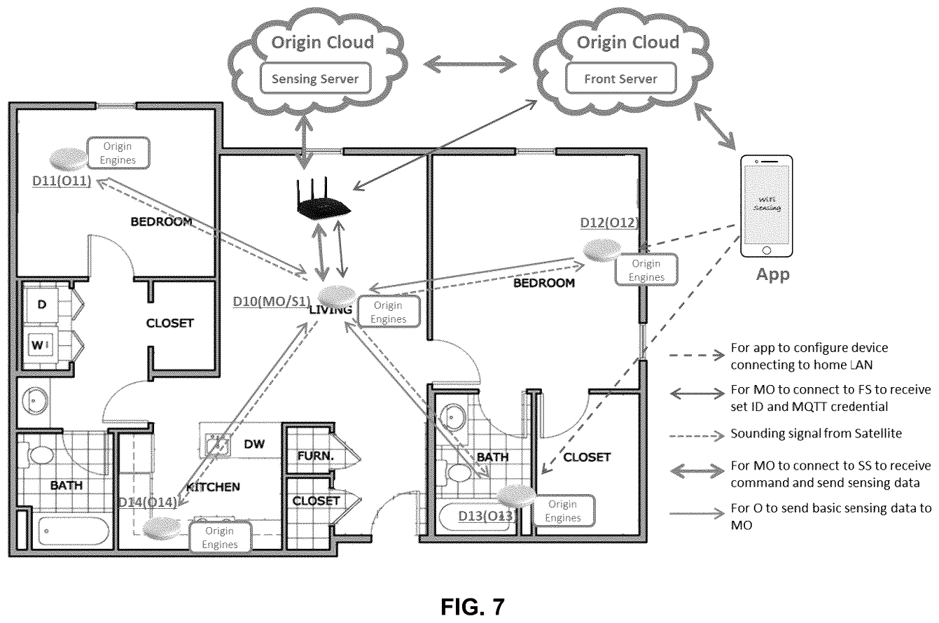

While FIG. 6 illustrates a per-room deployment for wireless sensing, FIG. 7 illustrates a whole-home deployment for wireless sensing. The per-room deployment may be suitable to sense fall detection, automation, and/or activity of daily living (ADL) on a per-room basis. The whole-home deployment may be suitable to sense home security and/or ADL on a whole-home basis. In some embodiments, a same system can support both deployment manners.

In some embodiments, all devices for wireless sensing are provisioned to a front server (FS) with UN/PW (password). One can extend FS or create an AS to support this development. All devices may be in softAP mode with known SSID/PW. As shown in FIG. 6, the set of devices at home includes: {D10, D11, D12, D20, D21, D22, D30, D31, D40, D41}.

During an onboarding process, an app can be used to scan QR codes and register devices to FS under a user account. FS then generates a set ID for the user and creates a sounder.conf file that contains the set ID. When a set is created in FS, FS can generate a default sounder.conf. It is similar to ABC or DEF with AS, where AS generates a set ID and creates dummy sounder.conf with the set ID. The file may be sent to a master Origin (MO) when it connects to AS.

In some embodiments, the app obtains the device credentials from FS. The app connects to the devices (using the device SSID/PW and credentials), provides them the home router SSID and PW for them to connect to the home router as clients. The app can select one device to be MO, e.g. D10. The app may connect to the device to: assign its role to MO, give MO the FS URL, and give MO credentials of other devices in MO network. MO may need credentials to connect to other devices. In some embodiments, the app connects to MO through home LAN.

In some embodiments, using its credential, MO connects to FS to receive: the sounder.conf file with the generated set ID (a.k.a. MO device ID); and sensing server (SS) MQTT credential and URL. A set ID generated by FS may allow changing/replacing MO device without losing sensing settings.

MO can connect to SS using the set ID and MQTT credential. The app may select devices for groups as follows {{D10, D11, D12}; {D20, D21, D22}; {D30, D31}; {D40, D41}} based on room setting. In some embodiments, the grouping can also apply to whole home setting, which includes a single group as shown in FIG. 7.

In some embodiments, the app sends to MO through SS the List-3 in groups, ex {MO ID, {D10, D11, D12}; {D20, D21, D22}; {D30, D31}; {D40, D41}}. For the scenario shown in FIG. 6, cloud and user do not know which one is Satellite or Origins in each group. They only know if these devices belong to which group. For the scenario shown in FIG. 7, the Satellite is in a specific location (e.g. middle of the house) to ensure motion localization performance. So the API should allow app to specify Satellite as well. Specifying Satellite devices could be an option.

In some embodiments, List-3 API will be modified to accommodate grouping. In some embodiments, format is in array and can be updated.

If Satellite is not specified, MO can compare the multicast list. The most recent multicast may be taken as the Satellite for that group. The other ones are the Origins in the group regardless if it is on or not. In this way, there is a device providing sounding.

MO may then build a sounder.conf and save it to FS. The system can modify FS or create an AS for this development. If an MO device is changed, the new MO device can go to FS to get the sounder.conf to restore the services. MO can return to SS the MO network. As such, the app can start the service.

In some embodiments, when receiving a start service command, MO already knows a device in MO network should be Satellite or Origin based on the onboarding. A Satellite can be chosen by MO or by user/app specification. Other devices are Origins.

For a device to be Origin, MO uses the device credential to connect to the Origin. MO provides the Origin the following: the ID and credential of the Satellite associated with the Origin; MO address for Origin to send basic engine output back; and the basic engine types for Origin to run. Origin will use the Satellite credential to connect to the Satellite.

Origin can look up in its multicast table to find the Satellite and its MAC address. Origin may use the Satellite credential to connect to the Satellite. Origin then sends the Satellite the start sounding command.

In some embodiments, Satellite starts the sounding signal if it has not started yet. After that. Origin runs the basic engines that MO requested. Origins send back to MO the basic engine outputs. MO runs fusion engine. MO then sends the fusion engine output to SS.

In some embodiments, when a user stops a service, the app sends MO the stop command. MO sends Origin a stop engine command. Origin stops its associated basic engines. If Origin has no other basic engine to run, Origin then sends the Satellite the stop sounding command.

For example, home security and sleep monitoring are running. Therefore, Origin needs to run motion and breathing. Then a user stops sleep monitoring. MO sends Origin stop breathing engine command. Because Origin still runs motion engine, Origin should not stop Satellite from sounding. In some embodiments, Satellite stops sounding if no other Origins need its sounding signal.

In some embodiments, during operation, MO may be offline or powered down. When resumed online, MO connects to FS to get: Sounder.conf file; SS MQTT credential and URL. MO may then connect to SS to receive service restoration information. If the service was running before MO was offline, MO starts the service. If the service was not running, MO waits to receive start service command.

In some embodiments, during operation, the user may add a device to the sensing network (assuming the device is not MO). Before proceeding adding/removing devices, the app should stop engines on MO. Adding a device is similar to onboarding a device. The device first needs to be provisioned to FS. As a neutral device, the device is in softAP mode with known SSID/PW. Before proceeding, app stops engines on MO. App scans QR codes and registers the device to FS under a user account. App obtains the device credential from FS. App connects to the device (using the device SSID/PW and credential), provides it the home router SSID and PW for it to connect to the home router as a client. App sends MO the new List-3 that includes the new device. MO then builds a sounder.conf and saves it to FS. MO returns to SS the MO network. App then can restart the service.

In some embodiments, during operation, the user may remove a device from the sensing network (assuming the device is not MO). Before proceeding adding/removing devices, app should stop the engines on MO. App stops the engines. App sends MO the new List-3 that excludes the removed device. MO then builds a sounder.conf and saves it to FS. MO returns to SS the MO network. App then can restart the service. After removal, the removed device is still in client mode to home router. Factory reset will neutralize the device. After factory reset, the device is in softAP mode with known SSID/PW. waiting to be configured to connect to home router.

In some embodiments, during operation, the user may replace MO. MO device may not be functional, or user wants to assign another device as MO. App attempts to stop engines on MO. If successful, MO then stops all engines on Origins, and Origins stop Satellite from sending sounding signal. App can deregister MO from user account in FS. Then MO is no longer able to connect to FS unless it gets registered again. FS revolts MQTT credential that MO uses. MO is no longer able to connect to SS. App selects another device to be MO. If the new MO is a neutral device, app connects to the device and makes it connect to home router.

App then connects to the device to: assign its role to MO; give MO the FS URL; and give MO credentials of other devices in MO network. MO may need credentials to connect to other devices. App connects to MO through home LAN. Using its credential, MO connects to FS to receive: the sounder.conf file with the existing set ID (a.k.a. MO device ID); and SS MQTT credential and URL. A set ID generated by FS allows changing/replacing MO device without losing sensing settings. MO connects to SS using the set ID and MQTT credential. MO receives restoration information from SS to resume the service. The old MO can be neutralized through factory reset.

In some embodiments, any device (MO, Origin, or Satellite) can be neutralized through factory reset. When neutralized, the device is in softAP mode with known SSID/PW, waiting to be configured to connect to home router.

In some embodiments, any device in the WiFi sensing network can be Satellite. A Satellite device can be chosen by MO or by user/app/cloud. MO can select a device to be Satellite by comparing the multicast list. MO takes the most recent multicast in a group as the Satellite for that group. Satellite keeps track of the start request from Origins. When an Origin requests sounding, if it is not in Satellite list, Satellite will add the Origin into its list. If an Origin is already in Satellite list requests sounding again, Satellite does not add the Origin into the list. In other words, Satellite list does not include duplicated Origins.

Periodically, Origin can tell Satellite to keep sending sounding signal if the Origin still runs its basic engines. If Satellite does not receive the keep going from an Origin, Satellite will remove the Origin from its list. This is to prevent Satellite from keeping sounding when engine is already stopped but Origin could not have a change to stop Satellite from sounding. An example is when an Origin is dead.

When an Origin stops all of its basic engines, the Origin will send the stop sounding to the Satellite. Satellite then removes the Origin from its list. When the list is empty, Satellite will stop sending out sounding signal. In some embodiments, Satellite does not maintain the list of Origins in persistent storage. When power-cycled, the list of Origin is empty, and thus Satellite does not send out sounding signal. If an Origin is running on the CSI from the Satellite, no CSI is received. Origin then sends the Satellite the request for start sounding. When Satellite is powered on and receives the start sounding, it resumes sending out the sounding signal.

In some embodiments, Origin is a device selected by MO. It is to provide basic engine data to MO to run fusion engines. MO can run multiple fusion engines.

MO should keep track which engine an Origin should run and tell the Origin to stop when no fusion engine requests the basic engine data. For example, soft security and ADL are running, where both requires basic motion engine. When stop Soft Security, MO should not send stop motion engine command to Origin because the ADL fusion engine still needs motion data from the Origin. In some embodiments, Origin does not keep track of the number of fusion engine consuming its output as in Linux system.

Periodically, MO sends Origin the start command for the needed basic engine. If Origin does not receive the start command from MO for a basic engine. Origin will stop the basic engine and thus possibly stops Satellite from sending sounding signal. This is to prevent Origin from running basic engines and Satellite from sending sounding signal forever when MO is dead.

In some embodiments, sample code for wireless sensing may include codes to: announce engine capabilities; provide connection among different devices in the sensing network; act in different roles (MO. Satellite, Origin) when assigned; provide connection to cloud; generate sounding signal and capture and parse CSI; send and receive control, command, and sensing data/detection; run engines in library, etc. In some embodiments, the library for wireless sensing may include core algorithms in basic engines and fusion engines, and produce sensing data and detection.

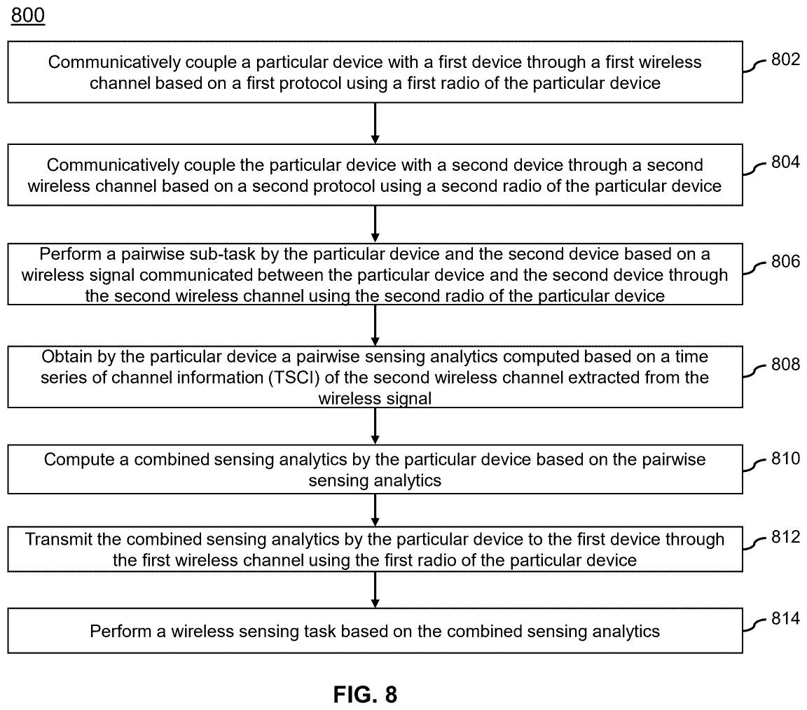

FIG. 8 illustrates a flow chart of an example method 800 for performing wireless sensing in a venue with multiple groups of devices, according to some embodiments of the present disclosure. In various embodiments, the method 800 can be performed by the systems disclosed above. At operation 802, a particular device is communicatively coupled with a first device through a first wireless channel based on a first protocol using a first radio of the particular device. At operation 804, the particular device is communicatively coupled with a second device through a second wireless channel based on a second protocol using a second radio of the particular device. In some embodiments, the first device, the second device, and the particular device are in a same wireless sensing system in a venue.

At operation 806, a pairwise sub-task is performed by the particular device and the second device based on a wireless signal communicated between the particular device and the second device through the second wireless channel using the second radio of the particular device. At operation 808, the particular device obtains a pairwise sensing analytics computed based on a time series of channel information (TSCI) of the second wireless channel extracted from the wireless signal. Each channel information (CI) may comprise at least one of: channel state information (CSI), channel impulse response (CIR) or channel frequency response (CFR). At operation 810, a combined sensing analytics is computed by the particular device based on the pairwise sensing analytics. At operation 812, the combined sensing analytics is transmitted by the particular device to the first device through the first wireless channel using the first radio of the particular device. At operation 814, a wireless sensing task is performed based on the combined sensing analytics. The order of the operations in FIG. 8 may be changed according to various embodiments of the present teaching.

The following numbered clauses provide examples for wireless sensing with multiple groups of wireless devices.

Clause 1. A method/device/system/software of a wireless sensing system, comprising: performing a wireless sensing task by a set of heterogeneous wireless devices in a venue, wherein a second particular heterogeneous wireless device comprises a first radio and a second radio; coupling communicatively the second particular device with a first heterogeneous wireless device of the set through a first wireless channel based on a first protocol using the first radio of the second particular device; coupling communicatively the second particular device with a second heterogeneous wireless device of the set through a second wireless channel based on a second protocol using the second radio of the second particular device; performing a pairwise sub-task of the wireless sensing task by the second particular device and the second device based on a wireless signal communicated between the second particular device and the second device through the second channel using the second radio of the second particular device; obtaining by the second particular device a pairwise sensing analytics computed based on a time series of channel information (TSCI) of the second wireless channel extracted from the received wireless signal, wherein each channel information (CI) comprises at least one of: channel state information (CSI), channel impulse response (CIR) or channel frequency response (CFR); computing a second combined sensing analytics by the second particular device based on the pairwise sensing analytics; transmitting the second combined sensing analytics by the second particular device to the first device through the first wireless channel using the first radio of the second particular device; performing the wireless sensing task based on the second combined sensing analytics.

In some embodiments, first radio and second radio may be same/different. First protocol and second protocol may be same/different. They may have same/different carrier frequency (e.g. 2.4 GHz/5 GHz/6 GHz/28 GHz/60 GHz), frequency channel/band (e.g. band 7 Vs band 23), bandwidth (e.g. 20/40/80/160/320 MHz), protocol (e.g. WiFi, IEEE 802.11n/ac/ax/ay/az/be/bf, 802.15.3/4UWB, Bluetooth, BLE, Zigbee, WiMax, 4G/LTE/5G/6G/7G/8G), protocol settings/parameters, modulation (ASK, PSK, QAM 16/64/256/1024/4096), signaling, etc.

Clause 2. The method/device/system/software of the wireless sensing system of clause 1. comprising: wherein one of the first radio, the first wireless channel, and the first protocol differs from a corresponding one of the second radio, the second wireless channel, and the second protocol in at least one of: carrier frequencies, frequency channel, frequency band, bandwidths, modulation, beamforming, standard protocol, protocol setting, or signaling scheme.

In some embodiments, carrier frequency of one may be higher than the other one, even if they both have the same protocol (e.g. both are WiFi with one being 2.4 GHz and the other 5 GHz, or 2.4 GHz/6 GHz, or 5 GHz/6 GHz; e.g. the second particular device may have dual-band, tri-band or quad-band WiFi). First radio may be 2.4 GHz WiFi. Second radio may be 5 GHz or 6 MHz WiFi. Bandwidth of second radio (e.g. 20/40/80/160/320 MHz) may/may not be higher than bandwidth of first radio (e.g. 20 MHz).

Clause 3. The method/device/system/software of the wireless sensing system of clause 2. comprising: wherein a carrier frequency of the second radio is higher than that the first radio.

Clause 4. The method/device/system/software of the wireless sensing system of clause 3, comprising: wherein a carrier frequency of the second radio is higher than 5 GHz; wherein a carrier frequency of the first radio is less than 4 GHz.

In some embodiments, the set of devices may form a network of networks. The network of networks may have two tiers. Some device may be in a Tier-1 network, a top-level network (e.g. both second particular device and first device are in Tier-1 network). Some may be in a Tier-2 network, a level lower than top level (e.g. second particular device and second device are in a Tier-2 network). A device may be in both the Tier-1 network and the Tier-2 network (e.g. second particular device). (A device may be in more than one Tier-2 networks.) Each network (Tier-1 or Tier-2, or Tier-K) may be used to perform wireless sensing (e.g. all or some devices in the current network may collaborate as a group to do pairwise (wireless sensing) subtask; each pair of devices may transmit/receive wireless signal between themselves; TSCI may be obtained from each received wireless signal; pairwise analytics may be computed based on each TSCI; pairwise analytics may be sent to a selected device (in current network) that perform fusion to compute a combined analytics based on all pairwise analytics and any combined analytics received from lower level networks linked to the current network; combined analytics may be sent to upper level network linked to current network). Each Tier-2 network may form a local wireless sensing subsystem. The Tier-1 network may form a main wireless sensing system.

A Tier-2 network may be linked/connected to a Tier-1 network by having one or more devices in the Tier-2 network to function as gateway devices between the two networks. Each gateway device (e.g. the second particular device) may have at least two radios and may use them both to connect/associate with the two networks (e.g. the second particular device may uses first radio to join the Tier-1 network and second radio to join the Tier-2 network). More than one Tier-2 networks may be linked/connected to the same Tier-1 network. The Tier-1 network (e.g. its AP) may have access to internet, some external network or some cloud server. The Tier-2 networks may access the internet, the external network or the cloud server via the Tier-1 network (and the corresponding gateway devices). A network-of-networks may have more than 2 tiers. A (or more than one) Tier-K network may be linked/connected to a Tier-(K−1) network (e.g. recursively) and may be communicatively coupled with upper level networks (i.e. Tier-(K−2) network, Tier-(K−3) networks, . . . . Tier-2 networks, Tier-1 network), internet, the external network and the cloud server via the Tier-(K−1) network. Recursively, a Tier-(K−1) network may link/connect one or more Tier-K networks. A Tier-(K−1) network may be associated with a zone/region/area (e.g. Tier-1 network may be associated with the whole venue), for any K>1. Each Tier-K network may be associated with a sub-zone/sub-region/sub-area (e.g. Tier-2 networks may be associated with living room, dining room, family room, kitchen, entrance, exit, garage, basement, bedroom1, bedroom 2, first floor, second floor, or some combination/grouping) of the zone/region/area associated with the Tier-(K−1) network. Two sub-zones/sub-regions/sub-areas may/may not overlap. The zone/region/area may comprise a union of more than sub-zones/sub-regions/sub-areas. A portion of the zone/region/area may not belong to any sub-zone/sub-region/sub-area.

For example, Tier-1 may be associated with the whole venue which may be a 2-floor house. A first Tier-2 network may be associated with the whole first floor (a first sub-zone of venue) and a second Tier-2 network may be associated with the whole second floor (a second sub-zone of venue). A first Tier-3 network, under the first Tier-2 network, may be associated with the kitchen (a first sub-sub-zone of first sub-zone) in first floor. A second Tier-3 network, under the first Tier-2 network, may be associated with the living room (a second sub-sub-zone of first sub-zone) in first floor. A third Tier-3 network (under first Tier-2 network) may be associated with the dining room (a third sub-sub-zone of first sub-zone) in the first floor. A fourth Tier-3 network (under second Tier-2 network) may be associated with a first bedroom (a first sub-sub-zone of second sub-zone) in the second floor. A fifth Tier-3 network (under second Tier-2 network) may be associated with a second bedroom (a second sub-sub-zone of second sub-zone) in the second floor. The entrance/foyer area of first floor may be a portion of first sub-zone that is not in any sub-sub-zone of first sub-zone.

Devices in a Tier-K network (called “Tier-K devices”) may be used in pairs to perform pairwise wireless sensing in the associated sub-zone/sub-region/sub-area, and corresponding TSCI in Tier-K (called “Tier-K TSCI”) may be obtained. Pairwise sensing analytics for Tier-K (called “Tier-K pairwise analytics”) may be computed based on the corresponding Tier-K TSCI. A Tier-K combined analytics may be computed based on the Tier-K pairwise analytics, the Tier-K TSCI and any Tier-(K+1) combined analytics obtained from any Tier-(K+1) networks linked/connected to the Tier-K network. The Tier-K combined analytics may be transmitted to the linked/connected Tier-(K−1) network via respective gateway device(s) between the Tier-K and the Tier-(K−1) networks. And this may be recursively performed for all K. In some examples, two or more devices in kitchen network (Tier-3 network, first sub-sub-zone of first sub-zone) in first floor (first sub-zone) may be used to perform pairwise wireless sensing to generate Tier-3 TSCI in the kitchen. Two or more devices in living-room network (Tier-3 network, second sub-sub-zone of first sub-zone) in first floor may be used to perform pairwise wireless sensing in the living room to generate Tier-3 TSCI in living room. Two or more devices in dining-room network (Tier-3 network, third sub-sub-zone of first sub-zone) in first floor may be used to perform pairwise wireless sensing in the dining room to generate Tier-3 TSCI in living room.

For each of the three sub-sub-zones of first sub-zone (say, the kitchen area), one or more Tier-3 pairwise analytics of/for/corresponding to the sub-sub-zone (e.g. kitchen) may be computed based on respective Tier-3 TSCI of the sub-sub-zone (e.g. kitchen or kitchen network). A Tier-3 combined analytics for the sub-sub-zone (e.g. kitchen) may be computed based on all the Tier-3 pairwise analytics and Tier-3 TSCI of the sub-sub-zone (e.g. kitchen area) (e.g. by a respective fusion algorithm). The three Tier-3 combined analytics of the three sub-sub-zones of the first sub-zone may be transmitted from the respective Tier-3 network (kitchen network, living-room network or dining-room network) to a first-floor network (Tier-2 network, first sub-zone) via the respective gateway device. In the first sub-zone (first floor), two or more devices in first-floor network (e.g. in entrance/foyer area, kitchen area, living room area, dining room area of first floor) may be used to perform pairwise wireless sensing to generate Tier-2 TSCI in the first floor. One or more Tier-2 pairwise analytics of the first floor may be computed based on respective Tier-2 TSCI of the first floor. A Tier-2 combined analytics for the first floor may be computed based on all the Tier-2 pairwise analytics and Tier-2 TSCI of the first floor and all the Tier-3 combined analytics from the three Tier-3 networks (e.g. by some respective fusion algorithm).

Different Tier-K network may have different radio, wireless channels, or protocols. E.g. One Tier-K network may be a 5 GHz WiFi network; a second Tier-K may be a 6 GHz WiFi. For example, a first Tier-2 network may be a first WiFi (e.g. 5 GHz), a second Tier-2 network may be a second WiFi (e.g. 6 Hz), a third Tier-2 network may be UWB, a fourth Tier-2 network may be Bluetooth, a fifth Tier-2 network may use millimeter wave (mmWave, e.g. 28 GHz, 60 GHz, 70+GHz). The first WiFi may use 11az for sensing while second WiFi may use 11bf for sensing. The first/second WiFi may have same/different carrier frequency, frequency channel/band, bandwidth, protocol, etc.

Tier-K network may have one or more access point (AP). The second particular device and/or second device may be AP. The wireless signal may be communicated in a trigger-based (TB) manner or non-TB manner. In TB sensing, a train (time series) of sounding signals (e.g. null-data-packet (NDP) may be sent from a first Tier-K device (e.g. AP, non-AP, and/or Type1 heterogeneous wireless device) to other Tier-K device(s) (e.g. non-AP, or another AP in mesh network) in the Tier-K network using uni-cast, multi-cast, and/or broadcast. A non-AP (or another AP) Tier-K device may transmit or receive a sounding signal in response to a trigger signal from a Tier-K AP device (e.g. transmit in response to a trigger frame (TF) in TF sounding, or receive in response to a NDP announcement frame (NDPA) in NDPA sounding). In peer-to-peer sounding, a non-AP Tier-K device may transmit a sounding signal to another non-AP Tier-K device. In non-TB sensing, a train of sounding signals (e.g. NDP) may be sent from a Tier-K AP device to a Tier-K non-AP (or another Tier-K AP) device, each sounding signal accompanied by another sounding signal sent in reverse direction, i.e. from non-AP to AP. In some embodiments, the first radio/wireless channel/protocol may be for Tier-(K−1) network (called “first wireless network”), for any K>1, such as 2, 3, 4 . . . . The second radio/wireless channel/protocol may be for Tier-K network (called “second wireless network”).

Clause 5. The method/device/system/software of the wireless sensing system of clause 1, comprising: performing the wireless sensing task by a first subset of the set of heterogeneous wireless devices using a first wireless network in the venue, wherein the first subset comprises the second particular device and the first device; performing the wireless sensing task by a second subset of the set of heterogeneous wireless devices using a second wireless network in the venue, wherein the second subset comprises the second particular device and the second device; wherein the first radio, the first wireless channel, and the first protocol are associated with the first wireless network; wherein the second radio, the second wireless channel, and the second protocol are associated with the second wireless network; wherein one of the first protocol or the second protocol comprises at least one of: a WiFi standard, a UWB standard, a WiMax standard, an IEEE standard, an IEEE 802 standard, an IEEE 802.11 standard, an IEEE 802.11bf standard, an 802.15 standard, an 802.15.4 standard, and an 802.16 standard.

Clause 6. The method/device/system/software of the wireless sensing system of clause 5. comprising: wherein the second particular device and first device are authenticated and associated in the first wireless network; wherein the second particular device and second device are authenticated and associated in the second wireless network.

In Case 1: wireless signal received by second particular device. Pairwise analytics computed by second particular device. In Case 1a: Non-TB sensing (TB=“trigger based”). No trigger signal may be needed.

Clause 7. The method/device/system/software of the wireless sensing system of clause 5, comprising: transmitting the wireless signal from the second device to the second particular device based on the second protocol; extracting the TSCI from the received wireless signal by the second particular device; computing the pairwise sensing analytics based on the TSCI by the second particular device.

In Case 1: Trigger based sensing. AP may sent trigger signal to non-AP before sounding signal (e.g. NDP) being received by non-AP (e.g. triggered by NDPA), or transmitted by non-AP (e.g. triggered by TF). In Case 1b: TB sensing with TF sounding. AP may be second particular device. Trigger signal may be TF. Alternatively, AP may be a third device. Both second particular device and second device may be peer devices. This may be peer-to-peer sensing. Transmission of wireless signal may be triggered.

Clause 8. The method/device/system/software of the wireless sensing system of clause 7, comprising: transmitting the wireless signal based on a trigger signal received by the second device from an access point device (AP) of the second wireless network, based on the second protocol.

Clause 9. The method/device/system/software of the wireless sensing system of clause 8, comprising: wherein the second particular device is the AP of the second wireless network.

In Case 1c: TB sensing with NDPA sounding. AP may be second device. Trigger signal may be NDPA. Alternatively, AP may be a third device. Both second particular device and second device may be peer devices. This may be peer-to-peer sensing. Reception of wireless signal may be triggered.

Clause 10. The method/device/system/software of the wireless sensing system of clause 7, comprising: receiving the wireless signal by the second particular device based on a trigger signal received by the second particular device from an access point device (AP) of the second wireless network, based on the second protocol.

Clause 11. The method/device/system/software of the wireless sensing system of clause 10, comprising: wherein the second device is the AP of the second wireless network.

In Case 2: Wireless signal received by second device. TSCI extracted in second device. Similar to Case 1, this may be non-TB sensing. TB-sensing with NDPA sounding or TB-sensing with TF sounding. In Case 2a: Pairwise analytics computed by second device and reported to second particular device.

Clause 12. The method/device/system/software of the wireless sensing system of clause 5. comprising: transmitting the wireless signal from the second particular device to the second device based on the second protocol; extracting the TSCI from the received wireless signal by the second device; computing the pairwise sensing analytics based on the TSCI by the second device; transmitting the pairwise sensing analytics from the second device to the second particular device.

In Case 2b: TSCI reported to second particular device. Pairwise analytics computed by second particular device.

Clause 13. The method/device/system/software of the wireless sensing system of clause 5, comprising: transmitting the wireless signal from the second particular device to the second device based on the second protocol; extracting the TSCI from the received wireless signal by the second device; transmitting the TSCI from the second device to the second particular device; computing the pairwise sensing analytics based on the TSCI by the second particular device.

In some embodiments, there may be other devices in Tier-K network. Two devices in the Tier-K network may perform a similar pairwise sensing sub-task, by communicating another wireless signal using the Tier-K network/second protocol/second wireless channel, extracting another TSCI from the received another wireless signal, obtaining another pairwise analytics (computed based on the another TSCI) by the second particular device, and computing the combined analytics based on both the pairwise analytics and the another pairwise analytics. Tier-K combined analytics may be computed based further on the TSCI and another TSCI. The Tier-K combined analytics may comprise the pairwise analytics, the another pairwise analytics, the TSCI and/or the another TSCI. The third device may/may not be the second particular device or the second device. The fourth device may/may not be the second particular device or the second device. Combined sensing analytics may be computed in/for the second network based on an aggregation of the pairwise sensing analytics and the second pairwise sensing analytics (and any additional pairwise analytics generated in the second network).

Clause 14. The method/device/system/software of the wireless sensing system of clause 5, comprising: performing a second pairwise sub-task of the wireless sensing task by a third heterogeneous wireless device in the second subset and a fourth heterogeneous wireless device in the second subset based on a second wireless signal transmitted from the third device to the fourth device through the second wireless channel in the second wireless network, wherein the two devices of the set of heterogeneous wireless devices are associated with the second wireless network; obtaining a second TSCI of the second wireless channel by the fourth device based on the received second wireless signal; obtaining by the second particular device a second pairwise sensing analytics computed based on the second TSCI; computing the second combined sensing analytics by the second particular device further based on the second pairwise sensing analytics.

In some embodiments, second pairwise sensing analytics computed by fourth device, then sent to second particular device (e.g. using the second wireless network/Tier-K network, or using the first wireless network/Tier-(K−1) network).

Clause 15. The method/device/system/software of the wireless sensing system of clause 14, comprising: computing the second pairwise sensing analytics by the fourth device based on the second TSCI; transmitting the second pairwise sensing analytics by the fourth device to the second particular device.

In some embodiments, second pairwise sensing analytics computed by second particular device based on second TSCI transmitted from fourth device to second particular device (e.g. using the second wireless network/Tier-K network, or using the first wireless network/Tier-(K−1) network).

Clause 16. The method/device/system/software of the wireless sensing system of clause 14, comprising: transmitting the second TSCI by the fourth device to the second particular device; computing the second pairwise sensing analytics by the second particular device based on the second TSCI.

In some embodiments, Tier-K combined sensing analytics may be computed based on combined analytics from Tier-(K+1) network, called “third wireless network”.

Clause 17. The method/device/system/software of the wireless sensing system of clause 14, comprising: obtaining a third combined sensing analytics associated with a third wireless network by the second particular device; computing the second combined sensing analytics by the second particular device further based on the third combined sensing analytics.

Clause 18. The method/device/system/software of the wireless sensing system of clause 17, comprising: performing the wireless sensing task further by a third subset of the set of heterogeneous wireless devices using the third wireless network in the venue; performing a third pairwise sub-task of the wireless sensing task by a fifth heterogeneous wireless device in the third subset and a sixth heterogeneous wireless device in the third subset based on a third wireless signal transmitted from the fifth device to the sixth device through a third wireless channel in the third wireless network, wherein the two devices of the third subset are associated with the third wireless network; obtaining a third TSCI of the third wireless channel by the sixth device based on the received third wireless signal; obtaining by a third particular heterogeneous wireless device in the third subset a third pairwise sensing analytics computed based on the third TSCI; computing the third combined sensing analytics by the third particular device based on the third pairwise sensing analytics; obtaining by the particular device the third combined sensing analytics from the third particular device.

Clause 19. The method/device/system/software of the wireless sensing system of clause 18. comprising: obtaining a fourth combined sensing analytics associated with a fourth wireless network by the particular device; computing the second combined sensing analytics by the particular device further based on the fourth combined sensing analytics.

Clause 20. The method/device/system/software of the wireless sensing system of clause 19, comprising: performing the wireless sensing task further by a fourth subset of the set of heterogeneous wireless devices using the fourth wireless network in the venue; performing a fourth pairwise sub-task of the wireless sensing task by a seventh heterogeneous wireless device in the fourth subset and a eighth heterogeneous wireless device in the fourth subset based on a fourth wireless signal transmitted from the seventh device to the eighth device through a fourth wireless channel in the fourth wireless network, wherein the two devices of the fourth subset are associated with the fourth wireless network; obtaining a fourth TSCI of the fourth wireless channel by the eighth device based on the received fourth wireless signal; obtaining by a fourth particular heterogeneous wireless device in the fourth subset a fourth pairwise sensing analytics computed based on the fourth TSCI; computing the fourth combined sensing analytics by the fourth particular device based on the fourth pairwise sensing analytics; obtaining by the particular device the fourth combined sensing analytics from the fourth particular device.

In some embodiments, there may be another Tier-K network, in parallel to the Tier-K network (second wireless network) described in clause 1/5, doing similar things. It may be associated with Tier-(K−1) network (first wireless network and may perform wireless sensing (sending wireless signals, obtaining TSCI, computing pairwise analytics, then computing combined analytics) and send its combined analytics to first device in Tier-(K−1) network.

Clause 21. The method/device/system/software of the wireless sensing system of clause 20, comprising: performing the wireless sensing task further by a fifth subset of the set of heterogeneous wireless devices using a fifth wireless network in the venue; performing a fifth pairwise sub-task of the wireless sensing task by a ninth heterogeneous wireless device in the fifth subset and a tenth heterogeneous wireless device in the fifth subset based on a fifth wireless signal transmitted from the ninth device to the tenth device through a fifth wireless channel in the fifth wireless network, wherein the two devices in the fifth subset are associated with the fifth wireless network; obtaining a fifth TSCI of the fifth wireless channel by the tenth device based on the received fifth wireless signal; obtaining by a fifth particular heterogeneous wireless device in the fifth subset a fifth pairwise sensing analytics computed based on the fifth TSCI; computing a fifth combined sensing analytics by the fifth particular device based on the fifth pairwise sensing analytics; obtaining the fifth combined sensing analytics by the first device from the fifth particular device; performing the wireless sensing task based on the fifth combined sensing analytics.

In some embodiments, Fifth subset=first subset. Fifth particular device=first device. First device may be in two (or more) networks: the first wireless network (e.g. 2.4 GHz) and the fifth wireless network (e.g. 5 GHz). The fifth wireless network may be for performing sensing measurement (sensing measurement setup, polling, sending wireless sounding signal/trigger signal, reporting raw sensing measurements/TSCI, sensing measurement termination). The first network may be for communicating any of: user/system wireless sensing parameters/setup/control, computed results based on raw measurements, pairwise analytics/combined analytics, etc.

Clause 22. The method/device/system/software of the wireless sensing system of clause 21, comprising: wherein the fifth subset is the first subset; wherein the fifth particular device is the first device.

Clause 23. The method/device/system/software of the wireless sensing system of clause 22, comprising: performing the wireless sensing task by the set of heterogeneous wireless devices using more than one wireless networks in the venue, with at least two of the heterogeneous wireless devices in each of the wireless networks in the venue; configuring the more than one wireless networks to have a multi-tier structure, comprising at least two tiers, wherein the first wireless network is a Tier-1 network comprising at least the second particular device, and the first device, wherein the second wireless network is a Tier-2 network comprising at least the second particular device, the second device, the third device and the fourth device, wherein the second particular device being in both the first and the second networks serves as a gateway device between the two networks such that sensing results can be transmitted from the second particular device via the first wireless network to the first device; configuring the heterogeneous wireless devices in a Tier-K network to report sensing results obtained in the Tier-K network to a heterogeneous wireless device in a Tier-(K−1) network via a gateway device between the two networks, wherein K is an integer greater than one, wherein sensing results comprise at least one of: combined sensing analytics, pairwise sensing analytics and TSCI.

Clause 24. The method/device/system/software of the wireless sensing system of clause 23, comprising: wherein the first wireless network further comprises the third particular device and the fourth particular device; wherein the third wireless network is a Tier-3 network, comprising at least the third particular device, the fifth device, and the sixth device, wherein the third particular device is a gateway device; wherein the fourth wireless network is a Tier-3 network, comprising at least the fourth particular device, the seventh device, and the eighth device, wherein the fourth particular device is a gateway device; wherein sensing results obtained in the third wireless network are transmitted from the third particular device via the first wireless network to the second particular device; wherein sensing results obtained in the fourth wireless network are transmitted from the fourth particular device via the first wireless network to the second particular device.

Clause 25. The method/device/system/software of the wireless sensing system of clause 24, comprising: wherein the first wireless network further comprises the fifth particular device; wherein the fifth wireless network is a Tier-2 network comprising the fifth particular device, the ninth device, and the tenth device, wherein the fifth particular device is a gateway device; wherein sensing results are transmitted from the fifth particular device via the first wireless network to the first device.

Clause 26. The method/device/system/software of the wireless sensing system of clause 25, comprising: associating the first wireless network with a zone of the venue; associating the second wireless network with a first sub-zone of the zone; associating the third wireless network with a first sub-sub-zone of the first sub-zone; associating the fourth wireless network with a second sub-sub-zone of the first sub-zone.

Clause 27. The method/device/system/software of the wireless sensing system of clause 26, comprising: performing the wireless sensing task for the zone based on at least one of: any pairwise sensing analytics associated with the first wireless network; the combined sensing analytics associated with the second wireless network, or a fourth combined sensing analytics associated with a fifth network in the venue; performing the wireless sensing task for the first sub-zone based on at least one of: the combined sensing analytics associated with the second wireless network, any pair-wise sensing analytics associated with the second wireless network, the second combined sensing analytics associated with the third wireless network, or the third combined sensing analytics associated with the fourth wireless network; associating the third wireless network with a first subzone of the zone; performing a wireless sensing subtask associated with the first subzone based on the third wireless network and the another combined sensing analytics, associating the fourth wireless network with a second subzone of the zone.

In some embodiments, the present teaching discloses systems and methods for a display of WLAN sensing motion statistics (MS)/motion information (MI)/analytics/spatial-temporal-information (STI) associated with more than one “regions” or “zones” in a venue.

In some embodiments, the regions or zones may be established and named by a user. For example, the venue may be a room; a zone or region may be “living room”, “dining room”, “kitchen”, “bedroom 1”, “bedroom 2”, . . . , “rest room 1”, “rest room 2”, . . . , “first floor”, “second floor”, “basement”, “garage”, “office 1”, “office 2”, etc. A region may be large, special or important s.t. more than one “sub-regions” of the region may be established and named by the user. For example, a living room may be a large region of a house s.t. the user established/named sub-regions such as “part of living room near kitchen”, “part of living room near front door”, “part of living room near back door”, “part of living room facing the street”, “part of living room near dining room”, “part of living room around the TV”, part of living room around the piano”, etc.

There may be multiple Type1 (Tx) devices and Type2 (Rx) devices in the venue such that TSCI may be obtained for each region/zone and/or sub-region. For each region or sub-region, one or more MS/MI/STI/analytics may be computed, and a magnitude/characteristics of such may be displayed graphically using graphical user-interface (GUI).

In some embodiments, some related MS may be grouped together in the GUI display. Some MS associated with same or neighboring region/sub-region may be grouped together in GUI. Some MS of same kind may be grouped together. For example, some or all breathing statistics (or fall-down statistics, or presence statistics or sleep analytics) may be grouped together.

In some embodiments, some grouped MS may be displayed in a number of ways. They may be displayed in a consecutive/connected/linked/chained manner, forming a line/ring, or spanning/scanning (e.g. zigzag spanning, or raster scanning) of a connected area of the GUI. MS that are grouped together may be displayed in a physically close proximity manner (e.g. forming a cluster).

The MS may be displayed in a number of ways. A MS may be displayed by itself. For example, it may be displayed as a figure/sliding figure/graph/plot/chart/bar/pie/circle/shape/histogram/histogram-like graph/animation. A magnitude of the MS and/or a function of the magnitude may be displayed/represented/coded/encoded as a number/numeral, a x-coordinate/y-coordinate of a figure/graph/plot, a coordinate/height/length (e.g. of a bar or bar chart), an area (e.g. of a circle, rectangle, or shape), a volume (e.g. of a 3D animation), a size (e.g. of a circle, rectangle, bar, shape, graph, figure, chart), an animation, animation characteristics, duration, timing, flashing, pattern, shading, effect, color, and/or light/color intensity. The function of the magnitude may be different for different MS.

Some MS may be displayed together (e.g. overlaid, stacked, staggered, and/or concentric). Each MS may be displayed as a figure and the multiple figures may be overlaid, stacked and/or staggered. Each MS may be displayed as a concentric “ring” (e.g. circular or rectangular) around a center point. The rings may/may not overlap. Two MS may be displayed as a two-dimensional shape (e.g. ellipse/rectangle).

The magnitude of MS may be a magnitude/phase of a complex number, value/absolute value/sign of a real number, a norm of a vector (e.g. L_1/L_2/ . . . . L_k/ . . . . L_infinity norm), a statistics, a mean/variance/correlation/covariance, and/or a thresholding/hard/soft thresholding. The function may be univariate, monotonic increasing, monotonic non-decreasing, piecewise linear, and/or an exponential/logarithmic/polynomial/trigonometric/hyperbola function, and/or a function of another function. The function may be a univariate function (e.g. as described) of a multivariate function (e.g. filtering, transform, moving average, weighted average, median/mean/mode, arithmetic/geometric/hyperbolic mean, maximum/minimum, statistics, ordered statistics, variance, percentile, histogram, probability function, cumulative distribution function, count) of a sliding window of MS. The function may be a multivariate function of univariate function(s) of the sliding window of MS. The function may also be univariate function of multivariate function of univariate function(s) of the sliding window of MS.

Different MS measuring different characteristics of motion may have different functions. For example, a function of breathing MS may be different from a function of fall-down MS. A function of an MS may be determined based on online/offline learning, or training/update using training/past data, and/or analysis of characteristics of motion.

Different MS measuring same characteristics of motion may have different functions. For example, breathing MS may have different functions for different regions/sub-regions. Alternatively, MS for some regions/sub-regions (e.g. some grouped MS) may be same, at least for a period of time. The function of a MS may be adaptively determined based on the MS (e.g. past MS or training MS from training data) and/or associated TSCI.

At least one statistics is wireless-sensing MS computed based on TSCI. Some statistics may be non-wireless-sensing statistics obtained in some ways. The statistics may be presented in some presentation device (e.g. displayed visually on a screen/monitor/smart phone/tablet, generate visual signal/animation using lamp/light bulb/panel, play sound on a speaker, generate vibration/motion/action).

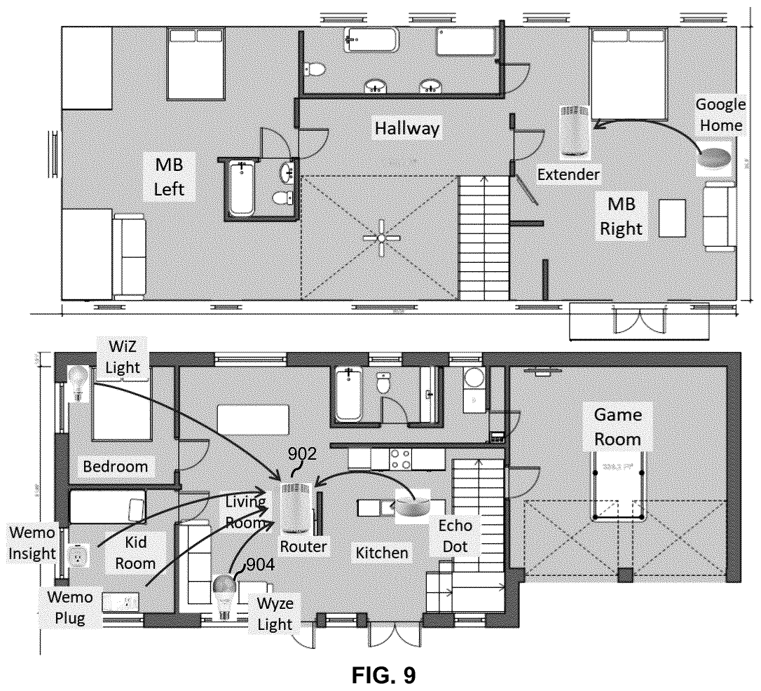

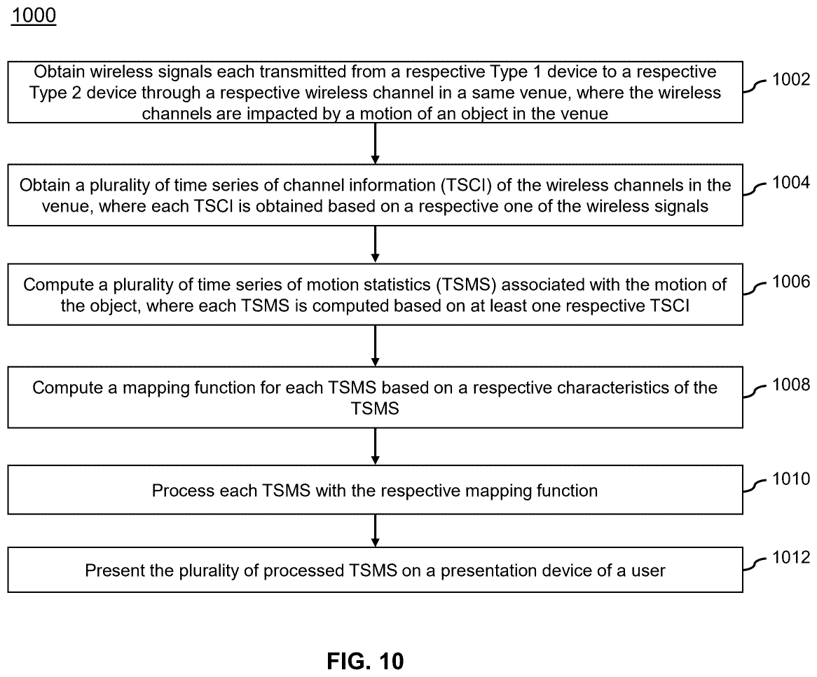

FIG. 9 illustrates an example floor plan for wireless sensing to display sensing motion statistics and analytics, according to some embodiments of the present disclosure. In some embodiments, a location name is assigned to each wireless device, e.g. a router, an extender, etc., based on its location, e.g. bedroom, living room, kitchen, etc. Then, devices with a same location name can be grouped together. For example, a router 902 and a Wyze light 904 in FIG. 9 may be grouped together because they have the same location name: Living Room.

In some embodiments, the grouping can enable a system to have multiple IoT devices in the same room to cover big rooms. There may be overlapping sensing zones. In some embodiments, the system may use the wireless sensing and detection to gate a display of motion statistics, e.g. in form of live-view bubbles in a graphical user interface. The system may display sensing motion statistics and analytics that are not the same as the original output of the detection. For example, the system can apply an exponential curve to amplify detections with strong motion statistics and subpress detections with weak motion statistics.

In some embodiments, the present teaching discloses systems and methods for wireless sensing using two-way sensing in which sounding signals are transmitted between two wireless devices in both ways: from a first device to a second device and from the second device to the first device such that sensing measurement results are obtained/generated in both devices. In one-way sensing, sounding signals are transmitted in one way only such that sensing results are generated in one device only. The sensing results may be used locally in the device or optionally reported to another device.

One disadvantage of one-way sensing is that, when sensing results are generated in a first device but is needed in a second device, undesirable reporting frames may be used by the first device to transmit/report the sensing results to the wirelessly second device. The use of reporting frames is undesirable because they tend to be very large/bulky and may take a long time and a lot of data bandwidth to transmit, and a lot of memory to store, especially when there are many antenna pairs between a TX (wireless transmitter) and a RX (wireless transmitter), many TX/RX pairs, many TX/RX pairs, and wide analog BW used to obtain sensing results (e.g. channel information/CI, such as CSI, CIR, CFR, etc.). An advantage of two-way sensing over one-way sensing is that, with sounding signals transmitted both ways, sensing results are generated in both the first device and the second device, and there may be no need to use the undesirable reporting frames to report the sensing results.

Wireless sensing may be performed in a wireless network based on a standard (e.g. IEEE 802.11, 802.11bf, 4G/5G/6G/7G/8G, 802.15, 802.16, UWB, Bluetooth, etc.), a specification and/or a protocol. In the wireless network, there may be one or more access point (AP) station (STA) (e.g. WiFi AP, mesh network AP, 4G/5G/6G/7G base station, cellular base station, repeater, etc.), and there may be one or more non-AP STA. WLAN or WiFi sensing may be performed based on WLAN/WiFi signal (e.g. compliant to IEEE 802.11, 802.11bf standard, WiFi Alliance).

Non-data packet (NDP) may be used as a sounding signal. A Sensing NDP Announcement (NDPA) frame may be defined that allows a STA to indicate the transmission of NDP frame(s) used to obtain sensing measurements. A Trigger frame variant may be defined that allows an AP STA to solicit NDP transmission(s) from STA(s) to obtain sensing measurements.

Non-TB Wireless Sensing. A non-AP STA may be the sensing initiator and an AP STA may be the sensing responder, and together they may perform non-triggered-based (non-TB or NTB) wireless sensing. The non-AP STA may send an NDPA frame to AP followed by two NDPs: an I2R NDP (initiator-to-responder NDP frame, for uplink sounding) from non-AP STA to AP and an R2I NDP (responder-to-initiator NDP frame, for downlink sounding) from AP to non-AP STA. For the I2R NDP. the non-AP STA is the Type1 device (TX) and the AP is the Type2 device (RX). For the R2I NDP, the AP is the Type1 device (TX) and the non-AP STA is the Type2 device (RX).

One-way non-TB sensing may be performed in which only one of the two NDPs may be used for generating sensing measurement results (e.g. CI, CSI, CIR, CFR, etc.) while the other NDP may not. For example, I2R NDP may be used for uplink sounding to generate sensing measurement results at the AP while the R2I NDP may not lead to sensing measurement results at the non-AP STA. The sensing responder (AP) may optionally report the sensing results to sensing initiator (non-AP STA). When the sensing results are generated, the MAC layer management entity (MLME) of AP may send a first signal/message/primitive to the Station management entity (SME) of AP to indicate the availability of the sensing measurement results. The AP may optionally use sensing measurement report frame to report the sensing results to the non-AP STA (initiator). To do so, the SME may send a second signal/message/primitive to the MLME to request the transmission of the sensing measurement report frame.

In another example, R2I NDP may be used for downlink sounding to generate sensing results at the non-AP STA (initiator). No sensing measurement report frame may be needed because the initiator already has the results. When the sensing results are generated, the MLME of non-AP STA may send the first signal/message/primitive to the SME of non-AP STA to indicate the availability of the sensing measurement results. The SME may not send the second signal/message/primitive to the MLME to request the transmission of the sensing measurement report frame.

TB Wireless Sensing. An AP STA may be the sensing initiator and a number (one or more) of STA(s) (e.g. other AP STA or non-AP STA) may be the sensing responders. They may jointly perform trigger-based (TB) sensing. There may be a polling phase in which the AP transmits a polling frame to check the availability of the number of STA(s) for TB sensing. If a STA is available, it may respond with a CTS-to-self. After the polling phase, there may be a one-way downlink sounding phase (e.g. NDPA sound phase), a one-way uplink sounding phase (e.g. trigger frame sounding phase), or a two-way uplink-downlink sounding phase.

One-way TB sensing. In the one-way downlink sounding phase, for each STA that is available, the AP may send an NDPA frame followed by an NDP frame as downlink sounding signal to the STA to generate sensing measurement results at the STA. A separate NDPA frame may be sent to each available STA, or a common/shared NDPA frame may be sent to multiple (e.g. some or all) available STA(s). Each STA (responder) may optionally use sensing measurement report frame to report its sensing results to the AP (initiator). When the sensing results are available at an STA, the MLME of the STA may send the first signal/message/primitive to the SME of the STA. If sensing results of the STA is optionally reported to the AP, the SME may send the second signal/message/primitive to the MLME of the STA to request the transmission of sensing measurement report frame to the AP (initiator).

In the one-way uplink sounding phase, for each STA that is available, the AP (initiator) may send a Trigger frame (TF) to the STA (responder), followed by the STA sending an NDP as uplink sounding signal to the AP to generate sensing measurement results at the AP (initiator). A separate Trigger frame may be sent to each available STA, or a common/shared Trigger frame may be sent to multiple (e.g. some or all) available STA(s). When sensing results are available at a STA, the MLME of the STA may send the first signal/message/primitive to the SME of the STA to indicate availability of the sensing results. No sensing measurement report frame may needed/used to transmit sensing results to the initiator, because the sensing results are already generated at the initiator. As such, the SME of the STA may not send the second signal/message/primitive to request transmission of sensing measurement report frame.

Peer-to-peer Wireless Sensing (P2P sensing). In peer-to-peer wireless sensing, one or more pairs of non-AP STA may be determined in a wireless network associated with an AP. With each pair, NDP(s) may be transmitted between a first non-AP STA and a second non-AP STA as sounding signal(s) to generate sensing results in non-AP STA(s). The NDP(s) transmission may/may not be transmitted with a help/signaling/trigger from an associated AP.

One-way P2P sensing. In one example of one-way P2P sensing, the AP may be the sensing initiator and both the first and second non-AP STA may be sensing responders. In another example, a non-AP STA may be a sensing-by-proxy (SBP) initiator that requests the AP (SBP responder) to perform one-way P2P sensing in which the AP may be the sensing initiator and both the first and second non-AP STAs may be sensing responders.

In both examples, the AP may configure/negotiate/arrange individually with the two non-AP STAs such that the two non-AP STAs can identify each other (each with at least one corresponding ID, e.g. identifiable network address, identifiable wireless network address/ID, AP assigned ID, initiator assigned ID, user defined ID, MAC address) and the first non-AP STA would send NDP as sounding signal to the second non-AP STA so that sensing measurement results may be obtained/generated in the second non-AP STA. The AP may send a first P2P-sensing-triggering frame to the pair of non-AP STAs. The first P2P-sensing-triggering frame may be a NDPA frame, a Trigger Frame, the special NDPA-Trigger frame (mentioned above), or another frame. A separate first P2P-sensing-triggering frame may be sent to each pair of non-AP STAs, or a common/shared first P2P-sensing-triggering frame may be sent to multiple (e.g. some or all) available STA(s). The first non-AP STA would then send the NDP to the second non-AP STA to generate sensing measurement results at the second non-AP STA. The sensing measurement results may be used/needed in the second non-AP STA, or the sensing results can optionally be transmitted from the second non-AP STA (sensing responder) to the AP (sensing initiator). In the SBP example, the AP (SBP responder) may further report the sensing results to the SBP initiator.

Multicast or Broadcast of sounding signals from AP to more than one sensing responders in SBP. An AP may be a sensing initiator and also a sensing transmitter (e.g. in sensing session, or in SBP). It may send a sounding signal (e.g. NDP) to each of a number of sensing responders separately (i.e. point-to-point sounding). Alternatively, it may send sounding signal (e.g. NDP) to more than one sensing responders using multicast or broadcast such that sensing measurement results may be generated in the more than one sensing responders simultaneously or contemporaneously. The sensing measurement results may optionally (i.e. may/may not) be reported to the AP. In the case of SBP, the AP may optionally (i.e. may/may not) report the sensing measurement results to the SBP initiator.

Selective SBP. A proxy-initiator (e.g. SBP-initiator) may send a request to a wireless access point (AP) which is a proxy-responder (e.g. SBP-responder), such that non-selective wireless sensing (e.g. SBP) is performed between the AP (acting as sensing initiator, on behalf of the proxy-initiator) with any available sensing responders (e.g. non-AP STAs/devices, another AP, mesh AP) in the AP's wireless network. Each of the available sensing responders may be assigned/associated with an identity (ID, e.g. MAC address). The proxy-initiator (e.g. SBP-initiator) may send another request to the AP to perform selective wireless sensing (e.g. selective SBP) with a group of selected sensing responders in the AP's wireless network. Each selected sensing responders may be identified by the respective ID. Same or different sensing settings may be used for different sensing responders. For a sensing responder, same or different sensing settings may be used for different target tasks (for the case of more than one target tasks) or different proxy-initiators (for the case of more than one proxy-initiators).

In some embodiments, the present teaching discloses systems and methods for Wireless Sensing in Network of Networks (WS-NoN) with tiered device grouping. A wireless sensing system may function as WS-NON in a venue to perform a wireless sensing task.

In some embodiments, the system may comprise a plurality of wireless (sensing) devices in a venue, which may be grouped into N+1 groups/tiers/levels (N>=1), namely, Group/Tier/Level 1, and similarly Group/Tier/Level 2 . . . , Group/Tier/Level N+1. N may be greater than or equal to 1. Some of the plurality of wireless sensing devices (e.g. Tier-k AP, or Tier-k Aggregator device, or Tier-k Control device, or Tier-k gateway device) may be associated, at least for a period of time, with a backbone wireless network (e.g. WLAN, WiFi, mesh, 2G/2.5G/3G/3.5G/4G/LTE/5G/6G/7G/8G, Bluetooth, ZigBee, UWB, Matter, etc.), and an associated backbone access point device (AP).

In some embodiments, the system may comprise a multi-tier hierarchical structure with N+1 tiers/levels/groups, i.e., a “main” tier/level/group (or Tier 1 or Level 1 or Group 1), and N additional higher tiers/levels/groups, namely, Tier 2 (or Group 2 or Level-2), Tier 3 (or Group 3, or Level 3), . . . , Tier N+1 (or Group N+1, or Level N+1). The Tier k may include Tier-k AP devices, Tier-k control devices, Tier-k aggregator devices, and/or Tier-k gateway devices.

In some embodiments, the “main” tier/level/group (or Tier 1 or Level 1 or Group 1) has Group-1/Tier-1/Level-1 (sensing) device(s) of the WS-NON forming (or being in) a Tier-1/Level-1/Group-1 wireless (sensing) network of the WS-NON. In some examples, in Tier 1, a particular Tier-1/Level-1/Group-1 device may be a control device (a “Tier-1 Control” device) of the Tier-1 sensing network. In some examples, a particular Tier-1 device may be an access point (AP, e.g. base station) of the Tier-1 network (a “Tier-1 AP” device). In some examples, a particular Tier-1 device may be a “Tier-1 Aggregator” device which aggregates (e.g. gather/receive/concentrate/process/analyze/combine/fuse/integrate) sensing results in/for/from Tier 1 (i.e. any Tier-1 devices/network) and/or any higher tiers (i.e. any Tier-k devices/networks, for any k>1). In some examples, a particular Tier-1 device may be a “Tier-1 Gateway” device to enable communicative coupling with other group/tier/level. Any two (or more) of: the Tier-1 AP device, the Tier-1 aggregator device, the Tier-1 control device, and/or the Tier-1 gateway device may be a same device.

In some embodiments, for any k>1, the Group-k/Tier-k/Level-k wireless (sensing) devices may form one or more Tier-k wireless (sensing) networks of the WS-NON. The Group-k/Tier-k/Level-k devices may be grouped/organized into one or more Tier-k/Level-k subgroups, each subgroup of devices associated with a respective Tier-k wireless network. In each Tier-k subgroup/network, a particular Tier-k device may be a Tier-k control device. In some examples, a particular Tier-k device may be an AP of the Tier-k wireless network (a “Tier-k AP” device). In some examples, a particular Tier-k control device may be a “Tier-k Aggregator” device which aggregates sensing results in/for/from the associated Tier-k wireless network, same tier (i.e. any other Tier-k wireless networks), and/or any higher tiers (i.e. any Tier-k2 devices/networks, for any k2>k). In some examples, a particular Tier-k device may be a “Tier-k Gateway” device to communicatively couple with other sensing networks in the WS-NON. Any two (or more) of: the Tier-k AP, the Tier-k Aggregator device, the Tier-k control device, and/or the Tier-k gateway device in the same Tier-k network may be a same device. There may be one or more Tier-k sensing networks/subgroups. In each Tier-k sensing network/subgroup, there may be one or more Tier-k control devices, one or more Tier-k aggregator devices, and/or one or more Tier-k gateway devices.

The aggregator devices may be configured for receiving from or transmitting to higher tiers/same tier/lower tiers. In a particular Tier-k wireless network, there may be one or more first Tier-k aggregator devices configured to receive/aggregate/analyze higher tier sensing results (generated non-locally in networks other than the current network) from a respective first set of higher-tier networks (i.e. a collection of “Tier-k1 sensing results” from respective Tier-k1 networks, with any k1>k). One or more first Tier-k aggregator devices may also receive/aggregate/analyze some (pairwise) sensing results generated locally by Tier-k devices in the particular Tier-k network.

The particular Tier-k wireless network may also include one or more second Tier-k aggregator devices configured to receive/aggregate/analyze same-tier sensing results (generated non-locally in other networks) from a respective second set of same-tier networks (i.e. a collection of Tier-k2 sensing results from respective other Tier-k2 networks, with any k2=k; e.g. from some aggregator devices in those networks). One or more second Tier-k aggregator devices may also receive/aggregate/analyze some sensing results generated locally by Tier-k devices in the same network (i.e. the current network, the particular Tier-k network).

The particular Tier-k wireless network may also include a third Tier-k aggregator device configured to (i) receive/aggregate/analyze any received/aggregated/analyzed sensing results (generated non-locally in other networks or locally in the same network) from any first Tier-k aggregator device, any second Tier-k aggregator device, and/or any Tier-k devices in the particular Tier-k network, (ii) construct/build a “Tier-k sensing result” based on all the received/aggregated/analyzed sensing results, and (iii) transmit/report the Tier-k sensing result to a Tier-k3 device (e.g. a Tier-k3 aggregate device) of a Tier-k3 network, with k3<=k. In particular, k3 may be k−1, or 1.

The Tier-k control device may be a first Tier-k aggregator device, a second Tier-k aggregator device, and/or the third Tier-k aggregator device. In particular, the Tier-k control device may be the third Tier-k aggregator device. A first Tier-k aggregator device, a second Tier-k aggregator device and/or the third Tier-k aggregator device may be a same device.

The configuration of Tier-k devices may be performed by configuring devices. In some embodiments, at least one configuring device (e.g. a sensing server, a cloud server, an edge server, a master device, cloud server, edge server, network server, a proxy/sensing-by-proxy/SBP initiator, Tier-1 control device, Tier-(k−1) control device, Tier-k control device) of the WS-NON may configure (e.g. interact/liaise/communicate with/control/command/instruct/setup) any Tier-k control device, any Tier-k AP device, any Tier-k aggregator device, any Tier-k gateway device, and/or any other Tier-k devices in the Tier-k network, either directly or indirectly, for any k<=(N+1). During a respective configuration operation, a Tier-k device being configured and the respective configuring device may send/receive/exchange/communicate/handshake at least one control or data message/command/request/response (e.g. via internet, via the backbone wireless network, via Tier-k network, or via a combination of wired/wireless communication links/networks). There may be more than one configuring devices.

In some embodiments, a sensing server may configure all the Tier-k control devices for all k directly. The sensing server may configure all the Tier-k aggregator devices directly. In some embodiments, the sensing server may configure Tier-1 control device. The configured Tier-1 control device may in turn configure the Tier-2 control device(s). Recursively, a configured Tier-k control device may configure one or more Tier-(k+1) control devices.

In some embodiments, there are two classes of sensing devices. There may be a sensing server (e.g. a cloud server) of the WS-NoN. The plurality of wireless sensing devices may be classified into two classes of sensing devices: active sensing devices and passive sensing devices. Active sensing devices are those sensing devices with some dedicated (special purpose) wireless sensing software/application/firmware installed or embedded particularly to perform (part of) the particular wireless sensing task(s). Passive sensing devices are those sensing devices with NO such dedicated wireless sensing software/application/firmware installed or embedded particularly to perform the particular wireless sensing task(s). Instead, the passive devices perform generic (general purpose) wireless sensing operations (for any wireless sensing tasks, not particularly/specially for the particular wireless sensing task(s)) according to one (or more) protocol associated with the wireless network (e.g. WLAN standard, WiFi, 802.11, 802.11bf, mobile standard, 3G/4G/5G/6G/7G/8G/9G/10G, Bluetooth, Zigbee, UWB. Matter, adhoc network, mesh network, etc).

All Tier-k Aggregator, Tier-k Control, and Tier-k Gateway devices are active sensing devices. A Tier-k AP be an active/passive sensing device. Active sensing devices (especially Tier-k Control, Tier-k Aggregator, and/or Tier-k Gateway) may/may not interact/communicate with the sensing server, while the passive sensing devices do not interact/communicate with the sensing server.

In some embodiments, the passive devices may be cooperating devices in the venue that are willing to contribute to/participate in obtaining/generating raw wireless sensing measurements using the generic (general purpose) wireless sensing operations, without any dedicated software/firmware to further participating in the computation of sensing results for sensing task based on the raw wireless sensing measurements. In particular, the passive sensing device may perform generic sensing operations to transmit/receive wireless sensing signals/signalings (e.g. request/response signals, sounding signal, NDP, ACK, trigger signal, report signals, etc.), and to obtain/report raw wireless sensing measurements (e.g. CI. CSI, CIR, CFR, RSSI) according to the protocol. Often passive Tier-k sensing devices may be associated with a Tier-k AP of a Tier-k network, and may be tested/discovered by the Tier-k AP (e.g. Tier-k Control) to be suitable for the raw wireless sensing measurements.

The Tier-k AP may be an active sensing device and may be configured (e.g. by sensing server or by Tier-k control device) to discover the passive/active Tier-k sensing devices (as opposed to non-sensing devices). The Tier-k AP may perform a sensing device discovery procedure by sending testing wireless sensing signals (e.g. NDP, wireless sounding signals) to each wireless device in the Tier-k wireless network (associated with the Tier-k AP). Alternatively, the Tier-k AP may send/transmit certain signaling to the wireless device such that it would send the wireless sensing signal/signaling to the Tier-k AP in reply/response. Raw wireless sensing measurements may be obtained by the receiver (whether it is the Tier-k AP or the device) based on the received wireless sensing signals. The Tier-k AP may obtain the raw wireless sensing measurements. It may perform a qualification/testing/analysis (e.g. by computing/testing/comparing some test analytics/statistics) based on the raw wireless sensing measurements and decide whether the wireless device is/is not a legitimate/suitable/qualified/capable/compatible passive/active device. Different qualification/testing/analysis may be performed for different tasks. A device may be qualified for one task, but not for another task. The Tier-k AP may report the presence and characteristics/capability of the Tier-k passive/active sensing devices in the Tier-k network to the sensing server. The sensing server may maintain a list of passive sensing devices, and a list of active sensing devices, both associated with the user account, the venue and the WS-NON.

In some embodiment, the generic sensing operation may comprise one or more of: function as any of: sensing initiator/responder/transmitter/receiver and/or SBP initiator/responder (e.g. as defined in IEEE 802.11bf), transmit/receive wireless sensing/sounding signals (e.g. NDP, or ACK signal in response to pinging/enquiry signals), obtain raw sensing measurements (e.g. TSCI, CSI, CIR, CFR) based on received sounding signal, transmit/receive reports of raw sensing measurements, initiate/terminate sensing/SBP sessions, etc.

In some embodiments, in addition to what the passive devices do (i.e. the generic sensing operations), an active device may interact with the sensing server or Tier-k AP or Tier-k/Tier-1 Control to do any of: report its presence, register on the list of active sensing devices, await instructions/task assignments/group assignment from the sensing server, being grouped/assigned into Tier k, associate with respective Tier-k AP to join respective Tier-k networks, function as Tier-k AP device to establish a Tier-k network, function as Tier-k control device, function as Tier-k aggregate device, function as Tier-k gateway device, load/download/install/update/execute/run respective components of sensing “engines” (software/firmware/configuration), compute/analyze/process some sensing results/analytics/statistics (e.g. pairwise sensing results such as ACF/motion/breathing information/statistics/features computed based on raw sensing measurements obtained from received wireless sensing signals/signalings, combined/aggregated sensing results, “Tier-k sensing results”) for some sensing tasks, to receive sensing results from upstream (e.g. from higher tiers), analyze/combine/aggregate/process all available sensing results, report sensing results downstream (towards Tier-1).

In some embodiments, a user may participate in the configuration of any Tier-k device using a user device (e.g. mobile phone, tablet, IoT device, smart device). The user may install a WS-NON for-user application/software/firmware/configuration/setup in the user device. The Tier-k device may have a respective WS-NON (for-device) application/software/firmware configuration installed. The user device may connect (e.g. via internet, broadband network, cellular network, wire/wireless LAN, the backbone network, via a webpage, by scanning a QR code to access some webpage, and/or by using the for-user application/software) to a sensing server (e.g. cloud server) of the WS-NoN. The user device may login to a user account of the user with credentials entered by the user. The user device may obtain access information for the Tier-k devices to connect to the sensing server (associated with the user account).

In some embodiments, an initial configuration of active Tier-k device is used to connect to sensing server. The user device may be configured to ask/prompt the user for permission to use a local wireless channel/protocol (e.g. Bluetooth/BLE/Zigbee, Matter) for the (initial) configuration of an active Tier-k sensing device (in a Tier-k network). Upon receiving approval by the user, the user device may wirelessly interact with the active Tier-k device using the user-permitted wireless channel/protocol and guide/instruct/configure the Tier-k device to associate with either (c1) the backbone AP in the backbone wireless network, or (c2) the Tier-k AP device in the Tier-k network which is communicatively coupled with the backbone network. The user device may provide to the Tier-k device any of: SSID, access credential, access code, and/or password, of either (c1) or (c2), stored or otherwise provided/entered/selected/chosen by the user. The Tier-k device may be guided/instructed/configured to connect to the sensing server via the backbone network using some user credentials related to the user account, and/or the access information obtained from sensing server by the user device. Upon connected to the sensing server as guided, the Tier-k sensing device may be registered/associated with the user account, and the venue (e.g. as identified by/associated with network address of the backbone network).

For further configuration of active Tier-k device, the active Tier-k device may reboot, associate with either (c1) the backbone AP in the backbone wireless network, or (c2) the Tier-k AP device in the Tier-k network which is communicatively coupled with the backbone network, and communicate with the sensing server via the backbone network. The sensing server may then perform further configuration of the Tier-k device. The user device may communicate with the sensing server (e.g. via the backbone wireless network) and help in the further configuration of the Tier-k device. Either at this time or in the future, the Tier-k device may download/install/update any of: system software/firmware/configurations (e.g. information of the hierarchical/tiered structure of WS-NON and/or other sensing devices in WS-NON), one or more sensing “engine” (e.g. sensing software/firmware/application), engine configurations/requirements, and/or any user preference/settings. For the case of (c1), the sensing server may guide/direct/cause the active Tier-k devices not designated as the Tier-k AP device to associate with the Tier-k AP device in the Tier-k network (e.g. by providing SSID, access credential, access code, and/or password of the Tier-k network). All active Tier-k devices may be configured to function in at least one role in the Tier-k network (e.g. the Tier-k AP device, the Tier-k control device, the Tier-k aggregator device, the Tier-k gateway device, Tier-k sensing device, sensing transmitter, sensing receiver, sensing responder, sensing initiator, SBP/proxy sensing initiator device, a sensing device on standby, etc.).

Formation of groups/tiers/levels; designation of Tier-k AP, control, aggregate and/or gateway devices are described herein. The sensing server map group the plurality of sensing devices into the N+1 groups/tiers/levels, and may designate some Tier-k devices to be Tier-k AP device, Tier-k control device, Tier-k aggregator device and/or Tier-k gateway device (e.g. based on the list of active sensing devices and the list of passive sensing devices). In some embodiments, the list of active and passive sensing devices may be presented to the user on the user device. The user may use the user device to direct/instruct the sensing server to form some or all of the N+1 groups/tiers/levels based on the list of the active sensing devices and the list of passive sensing devices. The user may use the user device to direct/instruct the sensing server to designate some devices to function as Tier-k AP device, Tier-k control device, Tier-k aggregate device, and/or Tier-k gateway device.

In some embodiments, to search for passive/active sensing devices from among non-yet-known devices, the Tier-k control device in an associated Tier-k network may be configured to ping any “not-yet-known” wireless devices in the network in search of passive/active sensing devices. The “net-yet-known” wireless devices may be wireless devices in the Tier-k network not yet known to the sensing server (and/or the Tier-k control device) with not-yet-known sensing capability/characteristics/quality/suitability/compatibility for/in the WS-NON, and/or wireless device not yet included in the two lists of active or passive Tier-k sensing devices.

In some embodiments, the Tier-k control device may be the Tier-k AP device of the Tier-k network. The respective configuring device of the Tier-k control device (e.g. user device, the sensing server, the Tier-1 control device or a Tier-(k−1) control device) may instruct/command/request/cause the Tier-k control device to test the not-yet-known devices in search for passive/active sensing devices. A not-yet-known device may be qualified/identified/designated/found as a passive/active sensing device based on at least one of: qualified/acceptable brand, qualified/acceptable model, supported frequency band, supported bandwidth, number of antenna, supported firmware version, supported software/application, available computing capability/capacity, available memory, available data bandwidth, available/supported timing, suitability/usability/compatibility/quality of CI, etc.).

The Tier-k device may select/choose a number of the qualified devices as passive/active sensing devices in the Tier-k network, especially if there are more than “sufficient” devices in the Tier-k network qualified as passive/active sensing devices.

The selection/choosing may be based on a limitation (e.g. capability/resource) of the Tier-k network. The Tier-k AP device, the Tier-k control device, the Tier-k aggregator device, and/or the Tier-1 gateway device may comprise limited available memory/buffer (e.g. to buffer locally/nonlocally generated raw sensing measurement and/or pairwise/aggregated/combined sensing results from itself and/or same-network devices; aggregated/Tier-k2 sensing results from other same-tier or higher-tier networks, k2>=k; Tier-k sensing results generated by the Tier-k aggregator device), limited available computing power (to process/preprocess/analyze/compute any pairwise raw sensing measurements and/or any pairwise/combined/aggregated/Tier-k2 sensing results), limited available analog bandwidth, limited available data bandwidth (e.g. only X1 percent of data traffic in the Tier-k network allocated to any sensing-related data communication/traffic/movement), limited available IO/internet bandwidth (e.g. only X2 percent of broadband/internet traffic allowed to any sensing-related data communication/traffic/movement), limited available system resources, and/or limited available network resources for sensing.

Because of the limitation, the Tier-k control device may have to limit/constrain the number of qualified devices to be selected/chosen as passive/active sensing devices. One or more of the Tier-k AP device, the Tier-k control device, the Tier-k aggregator device, the Tier-1 gateway device, any sensing initiator device, any sensing responder device, any sensing transmitter, any sensing receiver, and/or any proxy (e.g. SBP) initiator, may impose a limitation, either individually or jointly or both, on the amount of passive/active sensing devices allowable/supported/selected in the Tier-k network. For example, the Tier-k AP may support up to N1 passive/active sensing devices in certain pairing configurations. The Tier-k controller may support up to N2 passive/active sensing devices in certain pairing configuration. The Tier-k aggregator may support up to N3 passive/active sensing devices. The Tier-k gateway device may support up to N4 passive/active sensing devices. A sensing initiator may support up to N5 passive/active sensing devices. A sensing responder may support up to N6 passive/active sensing devices. A sensing transmitter may support up to N7 passive/active sensing devices. A sensing receiver may support up to N8 passive/active sensing devices. A proxy initiator device may support up to N9 passive/active sensing devices. The amount of qualified sensing devices to be selected as passive/active sensing devices in the Tier-k network, may be a function of N1, N2, N3, N4, N5, N6, N7, N8, and/or N9. The function may be minimum, maximum, percentile, or weighted average. Or, with coordination of multiple devices, the function may be larger than the minimum of N1, N2, N3 and N4.

The selection/choosing of qualified devices may be based on sensing “coverage” or performance. In one example, a particular qualified device may be the only qualified device located in a particular section/area/region of a facility (e.g. house/office/warehouse/station). In order to ensure “good” coverage, the particular qualified device may be selected/chosen as passive sensing device in the Tier-k network. To identify such qualified device with unique coverage or sensing range/performance, a user may walk around the facility. To test for good or not-so-good coverage, the system would perform a trial sensing task (e.g. motion detection, breathing detection, gait detection, fall down detection, activity recognition) while a user walks around the facility. The system may find that the particular qualified device gave good/stable/consistent sensing task results in the particular section of the facility (e.g. motion/breathing/gait/fall-down detected, activity recognized) but other qualified devices (when paired) gave poor/bad/not-so-good/unstable/inconsistent sensing task results (e.g. erratic or no motion/breathing/gait/fall-down detected, or erratic/no activity recognized).

In another example, two qualified devices, A and B, may be spatially adjacent to each other in the particular section/area/region of the facility. In the trial sensing task with the user walking around the facility, the two nearby qualified devices A and B. when paired with at least one same device C, may provide similar sensing task results. Similarity metric/score/measure (e.g. correlation) and/or dissimilarity metric/score/measure (e.g. mismatch score) between various pairs may be computed. Devices A and B may have high similarity (or low dissimilarity) with each other, but low similarity with other qualified devices. Such high similarity characteristics of devices A and B may be registered/recorded/stored (e.g. in Tier-k control device, or sensing server). The Tier-k control device may select/choose one of devices A and B, but not both, due to the “redundant”/similar sensing capability. Between the devices A and B, the unselected/not-chosen device may be marked/labeled as a “backup” device for the selected/chosen device that can be used when the selected/chosen device is down/power-off/malfunctioned. Device A may have better sensing results for a first sensing task and be selected for it. Device B may have better sensing results for a second sensing task and be selected for it. In some embodiments, for testing suitability of not-yet-known devices as passive/active sensing device, the Tier-k control device may cause each not-yet-known device (or a pair formed by the not-yet-known device and another device, the another device being either another not-yet-know device or a known device on the two lists of active/passive devices) to perform a respective trial sensing measurement operation and may decide whether the not-yet-known wireless device (or the device pair comprising the not-yet-known device) achieves a satisfactory/acceptable/suitable sensing performance.

In some embodiments, the Tier-k control device may send a (unicast) ping signal (e.g. null data frame/NDP; 802.11/802.11n/ac/ax/be/bf/WiFi/WiFi-4/WiFi-5/WiFi-6/WiFi-7/WiFi-8/WiFi-9 standard compliant/compatible, e.g. with ToDS=FromDS=0) to each not-yet-known wireless device and may receive a respective response frame (e.g. acknowledgement/ACK). The Tier-k control device may obtain/extract/capture respective raw sensing measurement (e.g. CI/CSI/CIR/CFR) based on the respective received response frame.

In some embodiments, for the case of device pair comprising the not-yet-known device, the Tier-k control device may cause the not-yet-known wireless device to communicate wireless signals (e.g. the NDP, the response frame) with the another device (e.g. another not-yet-known wireless device, or a “known” wireless sensing device of WS-NON) such that raw sensing measurement may be obtained/extracted/captured from the wireless signals or corresponding response signals.

In some embodiments, the Tier-k control device may compute (or cause to compute) a respective sensing test score based on the raw sensing measurement and compare it with a threshold. It may determine the sensing link between the not-yet-known device and the Tier-k control device, or between the not-yet-known device and the another device in the device pair, to be “usable” or “suitable” or “compatible” or “qualified” when the sensing test score exceeds the threshold, or vice versa. In other words, it may determine the two devices in each link to be “usable” or “suitable” or “compatible” or “qualified” when the test score exceeds the threshold.

In some embodiments, different test scores are computed for different tasks. The sensing test score may depend on a sensing task of the WS-NON. There may be more than one sensing tasks (e.g. motion detection, presence detection, breathing detection, sleep monitoring, activity detection, motion localization, fall-down detection, etc.) each to be performed/covered by a respective “engine” (e.g. software/application/firmware) of the WS-NON. Each “engine” may have respective requirement of/on “usability”, or “suitability”, or “compatibility” or “qualification” of/on the raw sensing measurement. Different sensing test scores (and different corresponding thresholds) may be computed/needed/used for different engines to assess/determine the usability/suitability/compatibility for the more than one sensing tasks. For example, the test score may be a first statistics for engine1 (e.g. motion statistics for a motion detection engine), and a second statistics for engine2 (e.g. breathing statistics for a breathing detection engine). The usability/suitability/compatibility may be determined individually for each task based on a respective sensing test score, or jointly for multiple tasks based on multiple respective sensing test scores.

For example, the Tier-k control device may be configured to decide, for each intended sensing task/engine, whether the raw sensing measurements (e.g. CI/CSI/CIR/CFR) obtained in the trial sensing operation is good/suitable/qualified/satisfactory enough (or not). There may be more than one intended sensing tasks/engines, each with different satisfaction/acceptance/suitability criteria on the raw sensing measurement. Based on the trial sensing operation and the associated sensing test scores, a link and/or device pair comprising a not-yet-known device may be determined/classified to be suitable/acceptable/satisfactory for a first task/engine but not suitable/acceptable/satisfactory for a second task. Or, the link and/or the device pair may be determined as suitable/acceptable/satisfactory for a first/“primary” role (e.g. sensing receiver) of a first task/engine but only for a second/“secondary” role (e.g. sensing transmitter) of a second task. A task may require different amount of sensing devices in different roles (e.g. N1 for first role, and N2 for second role).

In some embodiments, enlisted sensing devices/device-pairs are reported. After a not-yet-known wireless device is designated/enlisted/engaged/included as a Tier-k passive/active sensing device by the Tier-k control device, the Tier-k control device may transmit an information (e.g. identity/ID, MAC address, brand, model, capability, test score, hardware, processor, memory, software, firmware version) of it and/or the associated link/device pair to the sensing server. The sensing server may add the not-yet-known device to the lists of passive/active sensing devices, and/or add the link/device pair to a list of feasible (e.g. acceptable/suitable/qualified) links/device pairs.

In some embodiments, a similar suitability/qualification test may be performed for some/all of the active sensing devices. The associated link/device pair comprising an active sensing device may be reported to the sensing server to be added to the list of feasible links/device pairs.

In some embodiments, the user may be prompted in the user device and may select/choose some (or all) of the feasible links/device pairs for one or more (or all) sensing tasks to be performed. The user may be prompted to tag/label each active sensing device, passive sensing device and/or device pair (link). The user may be prompted to define zones within the venue (e.g. kitchen, living room, family room, dining room, toilet/rest room, garage, bedroom 1, bedroom 2, hallway, first floor, second floor, foyer, etc.) and/or a layout of the zones in the venue. The user may be prompted to associate a zone to each device and/or each device pair (link). The user may be prompted to enter a nature of use of the venue (e.g. primary residence, homestays service, hotel, rental, vacation house, etc.), a type of structure (e.g. multi-unit, single family), number of occupants, presence of any pets, scheduled events, daily/weekly/monthly/timed activities.

Using the user device, the user may designate/choose one or more allowable sensing tasks (e.g. motion detection, breathing detection, fall down detection, home monitoring, intrusion detection, locationing, tracking, etc.). For one or more tasks, the system may suggest/recommend a suggested system setup, comprising grouping of the devices (which devices to go to which group/subgroup/network), wireless interconnections among devices, suggested roles for the devices, suggested Tier-k AP, suggested Tier-k Aggregator, suggested Tier-k gateway, suggested Tier-k control device, etc. The system may present the suggestion/recommendation to the user on the user device. The system may also analyze the suggested system setup, and may compute/present one or more of: network usage analytics (e.g. for each Tier-k network, for backbone network), device capability/computing/memory/software/firmware/requirement (e.g. for one/some/each device; relative to available resources).

The user may accept/reject/modify/refine one/more/any/all suggested system setup items. The user-interface in the user device may allow the user to select/highlight/accept/confirm/reject/name/designate/deny/delete/add/merge/combine/split/modify/change the groups/groupings and/or wireless inter-connections, to include/exclude/constrain/change sensing devices and/or to select/accept/deny/reject/modify/add roles of each device for the sensing system. The user may highlight/select one (or more) device, group, grouping, and/or wireless inter-connection, and may perform any of the above mentioned operation on the highlighted item. The user may re-connect/re-direct an interconnection. The user may move a (highlighted/selected) device from one group to another. The user may designate/confirm/reject a highlighted/selected device to be any of: Tier-k AP, Tier-k Control, Tier-k Aggregator, Tier-k Gateway, sensing initiator, sensing responder, sensing transmitter or Type1 device, sensing receiver or Type2 device, SBP initiator, SBP responder, etc. The user may establish/setup constraints and get the system to refine/adjust the grouping, roles, interconnections, etc.

The user (or the sensing server) may choose some device (may/may not a Tier-k sensing device) for proximity and/or geo-fencing. For example, a mobile phone of the user's child may be used for geo-fencing such that when the backbone AP or any Tier-k AP senses it, the WS-NON may deduce that the user's child may be in proximity.

Some devices may be excluded to be a Tier-k sensing device (whether active or passive). For example, a robotic vacuum cleaner may be excluded because its location may be constantly changing. Some devices may be moved/relocated (e.g. by the user) to better locations/orientations/positionings before being enlisted/engaged as a sensing device (e.g. active, or passive). For example, some location/orientation/positioning may give better coverage for wireless sensing.

In some embodiments, the WS-NON may be part of a security system. Different responses may be needed for the security system when motion is detected by WS-NON under different contexts or situations. Different alert levels may be defined and may be assigned under different situations or contexts. For example, alert level=“1” may be defined to mean “very likely to be an accidental trigger, do nothing”. Alert level=“2” may be defined to mean “likely accidental”. Alert level=“3” may be defined to mean “may be accidental, worth checking”. Alert level=“4” may be defined to mean “concerned, definitely check”. Alert level=“5” may be defined to mean “intrusion seems likely, call police”.

A wireless device may be sensed/detected by or associated with one of the AP in the venue, such as backbone AP, or a Tier-k AP. The context (e.g. of a sensing task in a venue) may comprise whether the detected wireless device is a known device with known/registered/recorded MAC (e.g. mobile device/phone of user/user's children, or mobile device/phone of a frequent/regular visitor such as housekeeper/postman) or an unknown device (intruder's phone). The context may also comprise whether motion/activity is expected based on a time table/schedule/plan/sequence (e.g. children scheduled to arrive home at 4 pm Monday to Friday, housekeeper scheduled to come every other Saturday, robot cleaner scheduled/planned to clean at 10 am every day, online shopping delivery scheduled in the afternoon, user on a 3-week vacation, pet allowed to move freely in venue during the day, user wakes up and goes to bed at consistent time every day, user morning routine comprises waking up/getting off bed/going to kitchen/making/eating breakfast, neighbor walks in hallway for 10 seconds between lift and his flat, etc.). The context may also be that an event (e.g. being in a geo-fencing neighborhood of the venue) of a wireless device (e.g. children's phone) is reported (e.g. by a geolocation API).

In some embodiments, suppose motion is detected by WS-NON. If the context/situation is that motion is expected in venue based on time table/plan (e.g. it is time for children to come back from school) and a known wireless device (e.g. children's mobile phone) is detected in a proximity (e.g. in a neighborhood near venue), then alert level may be assigned/set as “1”. If the context is that motion is not expected in venue based on time table/plan (e.g. not yet time for children to come back from school) and the known wireless device is detected in the proximity, then the alert level may be set as “2”. If the context is that the detected motion by WS-NON is of an unknown type suggesting the motion is suspicious/alarming and motion is not expected in venue according to time table/plan and a positive report is received suggesting the motion is legitimate (e.g. report received saying that robot vacuum cleaner is cleaning the venue), then the alert level may be set as “2”. If motion is expected based on time table/plan (e.g. scheduled arrival of housekeeper) and an unknown wireless device is sensed/detected (e.g. presence of unknown phone), then the alert level may be set as “3”. If motion is not expected based on time table/plan (e.g. user being away on vacation) and unplanned presence of a known device (e.g. house keeper's phone) is detected, the Alert level may be set as “4”. If motion is not expected based on time table/plan (e.g. user being away on vacation) and an unknown wireless device (e.g. of intruder) is detected, the alert level may be set as “5”.

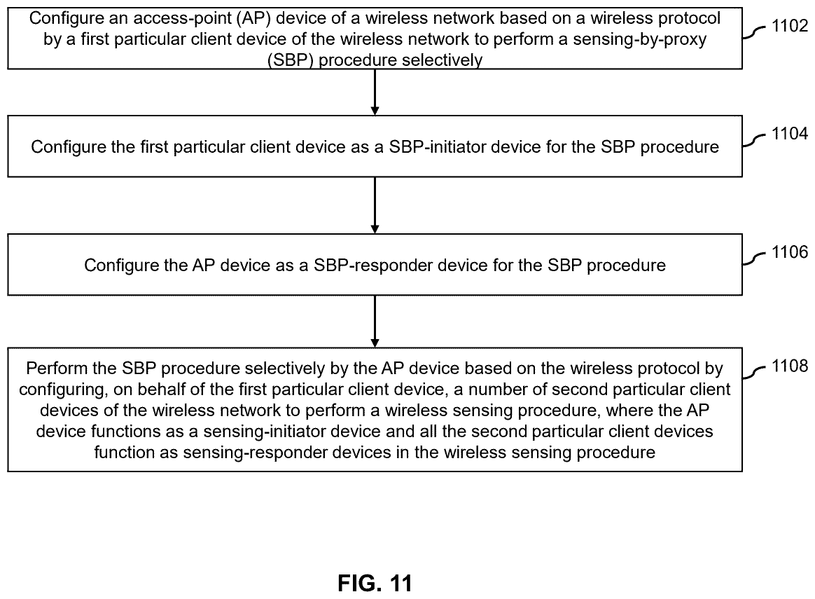

Different embodiments for Tier-k devices configuration are disclosed herein. In some embodiments, the sensing server may configure some/all/no Tier-k devices (e.g. passive/active sensing devices) indirectly, via the associated Tier-k control devices. For example, the sensing server may, or may configure/cause a Tier-k control device to (e.g. by functioning as a SBP/proxy sensing initiator in 1104 in FIG. 11), request the associated Tier-k AP device (e.g. functioning as SBP/proxy sensing responder) of the associated Tier-k network to function as sensing initiator to initiate a sensing session with the Tier-k devices such that wireless sensing measurements are performed in the Tier-k wireless sensing network (e.g. based on wireless sounding signals/NDP sent between sensing initiator and sensing responder, or between two sensing responders) as shown in 1106 of FIG. 11. The Tier-k devices may be configured directly by the Tier-k AP device, and indirectly by the Tier-k control device and the sensing server.

In some embodiments, the sensing server may configure some/all/no Tier-k devices (e.g. active sensing devices) directly to be associated with the respective Tier-k AP device to join the respective Tier-k wireless sensing network (e.g. the Tier-k AP device may be the Tier-k control device). In some embodiments, the sensing server may configure a Tier-k control device to (as sensing initiator) recruit/solicit/find/engage other Tier-k devices in the respective Tier-k network to join the WS-NON (at least temporarily, or during a sensing session of the WS-NON).

In some embodiments, a Tier-1 control device may configure Tier-2 control devices. The Tier-1 control device may be configured to configure (e.g. interact/liaise/communicative with/control/command/instruct/setup) the one or more Tier-2 control devices (and/or the associated Tier-2 wireless networks). The Tier-1 control device and each Tier-2 control device may send/exchange/communicate/handshake at least one control or data message/command/request/response (e.g. via a wired/wireless communication links/networks).

In some embodiments, a Tier-1 control device may configure higher-tier control devices directly or indirectly. In one example, the Tier-1 control device may configure higher-tier (e.g. Tier-2, Tier-3, etc.) control devices and/or associated higher-Tier wireless networks directly. In another example, the Tier-1 control device may configure the higher-tier control device(s) indirectly in a recursive manner via the Tier-2 control device(s)-in which recursively, as configured/intended/planned by the Tier-1 control device (whether directly or indirectly), a Tier-k control device may recursively configure (or interact with) one or more Tier-k2 control devices and/or the associated Tier-k2 networks, for any k>1, k2>=k. For example, a Tier-k control device may recursively configure one or more Tier-(k+1) control devices.

In some embodiments, Tier-k devices are configured by Tier-k control device. In one embodiment, each Tier-k control device may be configured to, functioning as sensing initiator, proxy sensing initiator and/or SBP initiator, configure directly or indirectly the Tier-k devices in the associated Tier-k wireless networks to perform pairwise wireless sensing measurements, with wireless sounding signals (e.g. NDP) being transmitted between a pair of sensing transmitter to a sensing receiver, and (pairwise) raw wireless sensing measurements (e.g. channel information, CI, channel state information, CSI, channel impulse response, CIR, channel frequency response, CFR. RSSI) being obtained/extracted from or based on the received wireless sounding signals by the sensing receiver. Some Tier-k devices (which may/may not comprise the Tier-k control device) transmit respective wireless sounding signals (e.g. to itself, to other Tier-k devices and/or some Tier-k2 devices, k2<≥>k) as sensing transmitters. Some Tier-k devices receive respective wireless sounding signals (e.g. from itself, from other Tier-k devices, and/or some Tier-k devices) as sensing receivers, and obtain respective pairwise raw wireless sensing measurements.

In some embodiments, pairwise sensing measurements and sensing results are computed, obtained and reported. Each sensing receiver may be configured (e.g. by sensing initiator, by Tier-k control device, or by sensing server, indirectly by SBP initiator/proxy initiator device) to compute respective pairwise sensing results based on the respective pairwise raw wireless sensing measurements. The pairwise sensing results may be computed based on one or more engines/modules/software/firmware modules installed in the sensing receiver, which may be chosen from a collection of wireless sensing engines/modules/software/firmware by the user via the user device, or a configuration of the sensing server. Different pairwise sensing results may be computed for different engines/modules/software/firmware based on the pairwise raw wireless sensing measurements. The sensing receiver may be configured to report the pairwise sensing results, and/or pairwise raw wireless sensing measurements to the sensing initiator, the Tier-k control device, the Tier-k Aggregate device, and/or the sensing server.

In some embodiments, the collection of wireless sensing engines may comprise motion engine, security engine, event engine, motion classification engine, motion recognition engine, presence engine, daily activity engine, rhythm engine, breathing engine, heart engine, sleep engine, gait engine, fall-down engine, location engine, tracking engine, navigation engine, fusion engine, etc. The pairwise sensing results may be transmitted from the sensing receiver to an associated Tier-k Aggregator device, which may combine/aggregate (some/all) pairwise sensing results generated in the Tier-k network.

In some embodiments, the pairwise sensing results (including pairwise sensing results or combined/aggregated sensing results) may comprise motion analytics such as any of: motion information (MI)/characteristics/statistics/indicator value, breathing statistics, presence statistics, location, speed, acceleration, and/or spatial-temporal information (STI), etc. Different engines may have different requirements (e.g. bandwidth such as 20/40/80/160/320/640 MHz, carrier frequency such as 2.4 GHz/5 GHz/6 GHz, antenna, spatial diversity stream, transmitter-receiver pair) on the received wireless sounding signals.

In some embodiments, the Tier-k Aggregator device may be configured to receive/collect any of: (1) higher-tier sensing results from higher tiers (Tier-k2, k2>k), (2) same-tier pairwise raw wireless sensing measurements, same-tier pairwise sensing results, and/or same-tier combined or aggregated sensing results from other Tier-k Aggregator device(s) in other Tier-k networks, and/or (3) same-network pairwise raw wireless sensing measurements, and/or same-network pairwise sensing results from other Tier-k devices in the Tier-k network. The Tier-k Aggregator device may compute (4) combined/aggregated sensing results by analyzing/processing/aggregating any received (1), (2) and/or (3). It may generate/assemble/aggregate/compute “Tier-k sensing results” which comprise any received (1), any received (2), any received (3) and/or any computed (4). It may transmit the “Tier-k sensing results” to another Tier-k Aggregator device in another Tier-k network, or to a Tier-k2 Aggregator device, with k2<k (e.g. Tier-(k−1) Aggregator device), or to Tier-1 Aggregator device, or to sensing server.

In some embodiments, the Tier-k control device may be configured to participate in performing sensing measurements (e.g. transmit or receive sounding signal, trigger sounding signal transmission, obtain/extract raw wireless sensing measurements from received sounding signal), and/or compute pairwise sensing results based on the raw wireless sensing measurements.

In some embodiments, there is complete configuration data in Tier-1 control device. In one embodiment, a complete configuration description of the multi-tier hierarchical structure of the WS NON may be obtained by the Tier-1 control device (e.g. from sensing server, or from user device via sensing server). The WS NON (comprising all the tiers, all the wireless (sensing) networks, all the control devices of the wireless networks, all the aggregator devices of the wireless networks, all the devices in the wireless sensing networks, all sensing roles of the devices, all sensing measurement configuration (e.g. bandwidth, antenna) for the wireless sensing signals, all the messaging, all the wireless sensing sounding/signaling, all the protocols, all compliance to standards such as WiFi/802.11/802.11bf/5G/6G/7G/8G, all the inter-connections/communications within and between the wireless networks, all the sensing data collection, all the sensing results computation to be performed, all the reporting and presentation of sensing results, etc.) may be constructed/established/configured based on the complete configuration description. Some or all of the complete configuration data may be obtained by the Tier-1 control device from the sensing server, or may be constructed by the Tier-1 control device according to some instruction/requirement from the sensing server.

In some embodiments, the complete configuration data may comprise a description, a textual description, a data structure, a directed structure, a link list, a blueprint, and/or a database, of the multi-tier hierarchical structure of the WS NON. It may comprise any of: a description of the tiers, the Tier-k networks, the available devices/the Tier-k sensing devices/the Tier-k AP device/the Tier-k control device/the Tier-k Aggregator device in each Tier-k network, identities (e.g. MAC address) of the devices, the sensing tasks, requirements/configurations for the sensing engines/modules/software/firmware, the (intra-network and inter-network) pairing of sensing devices to perform sensing measurements, the sensing transmitters, the sensing receivers, the sensing initiators, the sensing responders, the SBP/proxy initiator devices, the pairwise sensing results to be computed, the combined/aggregated sensing results to be computed, the composition and reporting of the Tier-k sensing results, etc.

In some embodiments, a Tier-1 control device distributes configuration data to Tier-k control device. In one embodiment, the sensing server may transmit some or all of the complete configuration data to the Tier-1 control device such that the Tier-1 network and all the higher tier networks can be configured by the Tier-1 control device. For each Tier-k network (k>2), the Tier-1 control device may compute a respective Tier-k configuration data and communicate it to the associated Tier-k control device. The respective Tier-k configuration data may comprise part of the complete configuration data in relation to the Tier-k network, the Tier-k control device, and any relevant Tier-k2 wireless network.

In some embodiments, there are configurations of tiers, intra-network pairing and inter-network pairing. In one embodiment, the designation/nesting/grouping of the tiers/groups/levels may be configured by the sensing server. In an embodiment, the intra-network pairing of sensing devices in a Tier-k network may be constructed by the Tier-k controller device of the network, and may be reported by the Tier-k controller device (e.g. to sensing server, to Tier-(k−1) controller device, or to Tier-1 controller device). In an embodiment, an inter-network pairing of sensing devices (e.g. between a Tier-k1 and a Tier-k2 network, k1<k2 or k1>k2, or between two different Tier-k networks) may be configured by the sensing server. In another embodiment, an inter-network pairing of a Tier-k1 sensing device and a Tier-k2 sensing device between a Tier-k1 network and a Tier-k2 network may be configured by: the Tier-k1 device, the Tier-k2 device, the associated Tier-k1 control device, the associated Tier-k2 control devices, the Tier-1 control device, the sensing server, and/or multiple of these devices.

In some embodiments, the sensing results are propagated in nested tiers. Wireless sensing may be performed in the wireless networks in the WS-NON. Raw (pairwise) wireless sensing measurements (such as Channel information (CI), CSI, CIR, CFR, RSSI, or time series of CI (TSCI) or any of CSI/CIR/CFR/RSSI) of the wireless channels of the wireless networks may be obtained and (pairwise) sensing results may be computed based on the raw wireless sensing measurements (e.g. CI or TSCI). The wireless networks in the WS-NON may be nested such that sensing results may be propagated/reported from higher Tiers towards lower Tiers, until they eventually reach Tier-1, from which they may be reported to a sensing server.

In some embodiments, there is inter-tier (cumulative) propagation of sensing results in adjacent tiers. In the WS-NON, each Tier-k network may be configured to be (recursively) nested/associated/linked with a respective Tier-(k−1) network (e.g. via a common gateway device, an inter-tier gateway device, a supervisory network or the backbone wireless network) or lower Tier network (e.g. Tier-(k−2), or Tier-(k−3), etc.) such that Tier-k sensing results obtained/collected/condensed/aggregated/generated/computed by the Tier-k network may be propagated/forwarded/transmitted/reported to the respective associated Tier-(k−1) (or lower Tier) network iteratively/recursively/asynchronously/progressively (e.g. via the common gateway device, inter-tier gateway device, supervisory network, or backbone network), towards the Tier-1 network. The Tier-k sensing results may comprise: any higher-tier sensing results transmitted from any higher Tier networks to the Tier-k network (e.g. Tier-(k+1) sensing results from any Tier-(k+1) networks, Tier-(k+2) sensing results from any Tier-(k+2) networks, Tier-(k+3) sensing results from any Tier-(k+3) networks, etc.), other Tier-k sensing results transmitted from any other Tier-k networks to the Tier-k network, local sensing results generated/computed locally in the Tier-k network based on (analyzing) Tier-k (pairwise) raw sensing measurement (e.g. CI/TSCI) obtained in the Tier-k network, and/or aggregated sensing results generated in the Tier-k network by aggregating/analyzing the local sensing results, the other Tier-k sensing results and/or higher-tier sensing results.

In some embodiments, there is intra-tier (horizontal) sensing result propagation in same tier. An exception may be that, a Tier-k network may be nested/associated/linked with another Tier-k network (e.g. via a common gateway device, an intra-tier gateway device, the supervisory network or backbone network), instead of a Tier-(k−1) network or lower Tier network, such that its Tier-k sensing results may be propagated/forwarded/transmitted/reported to the another Tier-k network (e.g. via the common gateway device, intra-tier gateway device, or the supervisory network), towards the Tier-1 network. In turn, the another Tier-k network may be nested/associated/linked with a Tier-(k−1) network (e.g. via inter-tier gateway device) or lower Tier network; or the another Tier-k network may be nested/associated/linked with yet another Tier-k network, towards the Tier-1 network. And in turn, the yet another Tier-k network may be nested/associated/linked with a Tier-(k−1) network (or a lower Tier network), or other Tier-k network. And so on.

In some embodiments, the networks may be heterogeneous such that different networks (e.g. in the same tier, or in different tiers) may be associated with different network or channel resources/characteristics. They may have different carrier frequency bands (e.g. 2.4 GHz, 5 GHz, 6 GHz, 7 GHz, 24 GHz, 28 GHz, 60 GHz, 70+GHz), or different bandwidth (e.g. 20/40/80/160/320/640 MHz), or different modulation, or different multiple access, or different signaling/standard/communication schemes (e.g. WiFi/WLAN, IEEE 802.11n/ac/ax/be/bn/bf, 4G/5G/6G/7G/8G, Bluetooth, WiMax, UWB, etc.), or different coverage (e.g. cells, micro-cells, pico-cells, room-level, house-level, floor-level, facility-level).

In some embodiments, two of the networks (e.g. two Tier-k networks; a Tier-k1 network and a Tier-k2 network) may have same SSID (service set ID), though each network may have its own AP and its own BSSID (basic service set ID). The two associated AP of the two networks may be mesh routers. Each network may be a basic service set (BSS) while together they may constitute an extended service set (ESS).

In some embodiments, each Tier-k wireless sensing network may have at least one Tier-k gateway device for communication with other wireless networks (i.e. other Tier-k network, higher tier network (Tier-k2 network, k2>k), and/or lower tier network (Tier-k3 network, k3<k). The Tier-k gateway device may use the backbone network to communicate with the other wireless networks. The Tier-k gateway device may be a common device in two networks, as a bridge between the two networks. A first Tier-k gateway device may be a common device between the Tier-k network and a lower tier network for the propagation/reporting/forwarding/transmitting of Tier-k sensing results from the Tier-k network to the lower tier network. A second Tier-k gateway device may be a common device between the Tier-k network and at least one higher tier network for the propagation/reporting of higher tier sensing results from the higher tier network to the Tier-k network. In some embodiments, the at least one Tier-k gateway device may be associated with the backbone AP of the backbone network and may communicative with other gateway device via the backbone network. The at least one Tier-k gateway device may be the same device. A Tier-k gateway device may be a Tier-k aggregator device.

In some embodiments, common devices function as gateway devices. Two networks may overlap by sharing a common device with a particular MAC address, effectively functioning as a gateway device for both networks. The common device may be configured to function/associate/communicate in the two networks (e.g. using 2.4 GHz in one network and 5 GHz in second network), either simultaneously, or contemporaneously. The common device may function as a gateway/linkage/inter-connecting device linking/connecting/nesting/associating the two or more overlapped networks.

In some embodiments, common device can function as intra-tier gateway device. A common device may be in (or associated with) multiple networks in the same tier. For example, it may be in a first Tier-k network (e.g. 2.4 GHz WiFi) and also in a second Tier-k network (e.g. 5 GHz WiFi), such that it may become an intra-tier gateway device between the two Tier-k networks allowing sensing results/messages/updates to be transmitted from any devices in the second Tier-k network to the common device using the second Tier-k network and then from the common device to other devices in the first Tier-k network using the first Tier-k network.

In some embodiments, common device can function as inter-tier gateway device. A common device may be in multiple networks in two or more tiers. For example, it may be in a Tier-k2 network (e.g. a WiFi network) and a Tier-k1 network (e.g. a UWB network). The common device may function as an inter-tier gateway device between the two tiers such that sensing results/messages of any device in the Tier-k1 network may be first transmitted to the common device using the Tier-k1 network, and then from the common device to other devices in the Tier-k2 network using the Tier-k2 network. Software/firmware/system updates may be propagated/transmitted in opposite direction-from Tier-k2 network to Tier-k1 network via the common device.

Software/firmware/system updates may be propagated/transmitted between first Tier-k network and second Tier-k network (e.g. a common device or via back-bone network), or between a Tier-k1 network and a Tier-k2 network (e.g. via a common device or via back-bone network).

In some embodiments, the Tier-1 AP device may be communicatively coupled with a sensing server (e.g. master device). The sensing server may comprise a server/device, remote/cloud/internet server, and/or local/edge/network server. The Tier-1 AP may communicate with the sensing server via a network, by sending/receiving/exchanging/handshaking messages/frames/signals/notification/request/instruction/command to/from/with the sensing server. The data network may comprise an access network, PAN, WPAN, LAN, WLAN, WiFi, Bluetooth, Zigbee, MAN, WMAN, cellular network, 4G/5G/6G/7G/8G, WiMax, broadband network, cable network, optical network, microwave network, a series/combination of networks, and/or internet.

In some embodiments, for initialization based on sensing plan, the WS-NON (including all Tier-k AP devices, associated Tier-k devices in respective Tier-k networks, and associated wireless sensing measurement sessions/settings/inter-connections/signalings) may be initiated/configured/constructed/built/setup by the sensing server (e.g. directly, or indirectly via the Tier-1 AP) or by the Tier-1 AP, based on a sensing plan (e.g. plan/information/description/list/instruction/configuration/setup, complete configuration description) for the WS-NON. The Tier-1 AP and/or the sensing server may have/possess/obtain/receive/transmit/formulate/establish/execute/implement/perform the sensing plan. The sensing plan may comprise information/description/design/plan/list/instruction/configuration/setup to construct/build/establish/set up the WS-NON. The sensing plan may be pre-stored in memory of the Tier-1 AP or the sensing server, or exchanged between the Tier-1 AP and the sensing server (e.g. from sensing server to Tier-1 AP, or vice versa), or obtained/received/configured from a user using a user/local device.

In some embodiments, some/all of the Tier-k networks, including the Tier-1 network, may be formed/initialized/established based on the sensing plan. Some Tier-k network may be an existing network. Some Tier-k network may be newly created/initiated. Based on the sensing plan, the AP of the Tier-k network may be configured/setup/initiated (e.g. by sensing server, by master device, by Tier-1 AP, or by a Tier-(k−1) AP) to be the Tier-k AP of the Tier-k network of the WS-NON. Some devices in the network (whether associated or not) may be configured (e.g. by sensing server; by master device; or by Tier-1 AP; or by Tier-k AP of the Tier-k network) to be Tier-k sensing devices to perform wireless sensing measurements in the WS-NON, and/or to collect/compute/combine/analyze/propagate any Tier-k sensing results to/towards a nested/associated Tier-(k−1) network (or an nested/associated Tier-k network), towards the Tier-1 network/Tier-1 AP. Some other devices may not be admitted to be a Tier-k device of the WS-NON. Still some other devices in the network may decline/refuse to be a Tier-k sensing device of the WS-NON. After the Tier-k network is initialized, new devices may join the Tier-k network and may be added to be Tier-k sensing devices of the Tier-k network of the WS-NON. An existing Tier-k sensing device may be removed/paused/stopped/quarantined in the Tier-k network, or moved to another Tier-k2 network. In some embodiments, the “some devices” configured to be Tier-k sensing devices may comprise any of: admissible/allowable devices as described in the sensing plan, pre-identified devices with certain MAC addresses; pre-identified/updated classes of devices known/qualified to be compatible with the WS-NON; specific types of devices such as brand ABC smart speaker, or brand DEF smart TV, or brand GHI smart plugs; smart devices currently in, or added later to, the network that respond in certain way when prompted; smart devices that passed some qualification trial test; devices trusted/recognized/owned/used/allowed/installed by a user; devices compliant to some standards such as WiFi 6/7/8/9, IEEE 802.11bf. In some embodiments, the “some other devices” not admitted as Tier-k sensing devices may comprise any of: non-admissible/disallowed/forbidden/to-be-avoided/suspicious devices identified/described in the sensing plan, devices not trusted/recognized/owned/used/allowed/installed by user, devices that are faulty/erratic/unreliable/noisy/compromised/black-listed, devices not compatible with WS-NON, devices that fail a qualification trial test, and/or devices that fail a WS-NON requirement on any of: computing ability, memory/storage/speed/bus, response time, software/firmware/application, chip/hardware/accessory capability, wireless capability/characteristics/signaling, antenna, availability, power source/endurance, and/or standard compliance.

In some embodiments, for an 802.11bf implementation, the Tier-k AP devices may be compliant to IEEE 802.11bf, or another wireless sensing standard. Any Tier-k AP device may be configured by a configuring device to perform wireless sensing measurements (e.g. based on IEEE 802.11bf, and/or the another standard) in at least one role (e.g. as sensing initiator, as SBP responder, as sensing transmitter, as sensing receiver, as another SBP initiator, as AP, as Tier-k local coordinator/server/concentrator/aggregator). The configuring device may comprise/may be a sensing server, a cloud server, an edge server, a local server, a Tier-1 AP, a Tier-(k−1) AP and/or a sensing-by-proxy (SBP) initiator. The configuring device and the Tier-k AP may perform a (wireless/wired) request/response/configuration/setup handshake or signaling (e.g. configuring device sends SBP request or “Tier-k AP request”, Tier-k AP sends SBP response or “Tier-k AP response”) to request/agree/decline/negotiate on any requested configuration for the Tier-k AP.

The requested configuration may comprise any of the following configuration items: (1) identification/configuration/requirement for the Tier-k wireless network to be established/formed/used by the Tier-k AP for the wireless sensing measurement, (2) requirement/selection/identification/designation/configuration of Tier-k wireless devices in the Tier-k network to be used/approached/engaged/configured for the wireless sensing measurement, (3) pairing of two Tier-k devices (in same or different Tier-k networks) and associated sounding signal configuration for each pair of devices, and/or sensing measurement coordination between the two Tier-k devices (and between the two different Tier-k networks), (4) pairing of a Tier-k1 device in a Tier-k1 network with a Tier-k2 device in a Tier-k2 network (e.g. k2=k1, or k2>k1, or k2<k1), and/or sensing measurement coordination between the Tier-k1 device and the Tier-k2 device, and between the Tier-k1 network and the Tier-k network, (5) identification/selection/designation/configuration/requirement of a Tier-k aggregator device (which may be the Tier-k AP) to collect/receive/aggregate/compute/generate/analyze/fuse/report/transmit sensing results/motion information (MI)/motion statistics (MS)/spatial-temporal information (STI) (e.g. compute/aggregate Tier-k sensing results/MI/MS/STI, receive Tier-(k+1) sensing results/MI/MS/STI), (6) identification/designation/configuration of a first gateway device (as a first bridge) between the Tier-k network and a higher tier (e.g. Tier-(k+1)) network, and a second gateway device (as a second bridge) between the Tier-k network and a lower tier (e.g. Tier-(k−1)) network, and/or (7) computing/analyzing/reporting/routing of any sensing results/MI/MS/STI by the aggregator device.

In some embodiments, the configuration of Tier-k devices in configuration item (2), the coordination in configuration item (4), and/or computing/analyzing/reporting/routing of any sensing results/MI/MS/STI by the Tier-k aggregator device in configuration item (5) and/or configuration item (7) may comprise any of: (a) local reporting of raw wireless sensing measurements (e.g. Tier-k TSCI) in Tier-k sensing receiver (e.g. any Tier-k devices/Tier-k AP in the Tier-k network), or nonlocal reporting of them from the sensing receiver to sensing initiator (e.g. Tier-k AP, the Tier-k aggregator device) (The sensing initiator may be in another network e.g. another same-tier network or a higher-tier or a lower-tier network.); (b) computing of local Tier-k sensing results/MI/MS/STI (e.g. by the Tier-k sensing receiver and/or sensing initiator) based on the Tier-k TSCI, and/or reporting of the local Tier-k sensing results/MI/MS/STI to the Tier-k aggregator device; (c) reception/collection of sensing result/MI/MS/STI (or even TSCI) by the Tier-k aggregator device from another aggregator device in higher Tier or another same-Tier (i.e. another Tier-k) network; (d) computing of Tier-k sensing results/MI/MS/STI (e.g. aggregation/reorganizing of any sensing results/MI/MS/STI) by the Tier-k aggregator device based on analysis/aggregation of any of: local Tier-k sensing results/MI/MS/STI/TSCI, or the received sensing results/MI/MS/STI/TSCI; (e) reporting of higher-tier sensing results/MI/MS/STI wirelessly from higher-tier or another same-tier devices (e.g. another Tier-k AP/device, Tier-(k+1) AP/device or Tier-(k+2) AP/device) to the Tier-k AP or the aggregator device in the Tier-k network; (f) reporting of Tier-k sensing results/MI/MS/STI/TSCI from the Tier-k AP/aggregator device to lower-tier devices (e.g. Tier-(k−1)/Tier-(k−1) device/AP/aggregator device).

In some embodiments, the configuring device may designate the Tier-k AP as the Tier-k aggregator device and/or the first gateway device and/or the second gateway device. A software/firmware/application/a set of instruction stored in the Tier-k device (e.g. Tier-k AP, the aggregator device, the gateway device) may be executed by a memory of the Tier-k device to perform any of the above. The sensing result/motion information computed by the Tier-k device may be associated with a task. The configuring device may be associated with the task.

In some embodiments, a Tier-k AP device may form/establish/create the Tier-k network (e.g. WiFi), and may coordinate/configure some (e.g. zero, one or more) devices in the Tier-k network (e.g. associated or not associated) to become a Tier-k device of the WS-NON to perform wireless sensing measurements. The Tier-k AP may function as a (local) Tier-k sensing initiator to establish/initiate a Tier-k sensing session (with associated pairing of the Tier-k devices and reporting of local Tier-k sensing results/MI/MS/STI) in the Tier-k network for the WS-NoN. In the process, it may approach any wireless device in the Tier-k network to join the Tier-k sensing session (and/or joining a joint sensing session of the WS-NoN) to perform sensing measurements based on some respective sensing configurations (e.g. bandwidth, roles of sensing transmitter/receiver, local/nonlocal reporting). Different wireless devices in the Tier-k network may have different sensing configurations.

In some embodiments, pairwise wireless sensing measurements may be performed. Pairing may be performed among the plurality of wireless devices of WS-NON (or some exterior device(s) exterior to WS-NON). Many pairs of devices may be identified and configured (e.g. based on sensing plan; by sensing server/master device/Tier-1 AP/Tier-k AP/Tier-k control device) to perform pairwise wireless sensing measurements. Within each pair (called “sensing pair”), a first device (e.g. Type-1 device, transmitter, TX) transmits a wireless (sounding) signal (e.g. null-data packet/NDP, a training of NDP) through a wireless channel (e.g. WiFi, 4G/5G/6G/7G/8G) to the second device (e.g. Type-2 device, receiver, RX). The second device obtains/extracts raw wireless sensing measurements (e.g. CI/TSCI) of the wireless channel based on the received wireless (sounding) signal. Wireless sensing task(s) may be performed (e.g. by the second device, or another device, or jointly by more than one devices) based on the TSCI.

In some embodiments, either or both intra-network sensing and inter-network sensing may be performed. While pairwise wireless sensing measurements may be performed within each Tier-k network (intra-network sensing), they may also be performed between two or more networks (inter-network sensing). For example, inter-network wireless sensing measurements may be performed between a Tier-k1 network and a Tier-k2 network (e.g. k2>k1, or k2<k1, or k2=k1), or between the Tier-k network and an “exterior” network not in the WS-NON (i.e. exterior to the WS-NON). For a (intra-network) sensing pair with both devices in a particular Tier-k network, one of the devices may be the Tier-k AP device in the particular Tier-k network, which may be the transmitter or the receiver of the wireless sounding signal. Alternatively, an intra-network sensing pair may have both devices being NOT the Tier-k AP and the wireless (sounding) signal may be transmitted in a peer-to-peer manner (e.g. non-infrastructure mode). For an inter-network sensing pair, additional coordination (synchronization, sounding, triggering, reporting) between the pair of devices and/or between the different networks may be performed.

In some embodiment, within a Tier-k network, intra-network sensing may be performed by an active sensing device and a plurality of passive sensing devices. A plurality of pairing/pairs may be performed/established/formed/designated, each respective pair comprising the active sensing device and a respective one of the plurality of passive sensing device. Within each pair, the active device may transmit a trigger/probe signal (e.g. a unicast packet such as NDP, with “fromDS” flag=0, “toDS” flag=0) to each passive device to trigger/induce the passive device to send a response/ACK signal (e.g. a unicast ACK with “fromDS”=0, “toDS”=0) back to the active device. The response/ACK signal may be used by the active device as sensing/sounding signal to probe the wireless channel and obtain/extract/capture raw (pairwise) wireless sensing measurements (e.g. CI, CSI, CIR, CFR, RSSI) based on the received response/ACK signal. The active device may compute/analyze/process one or more respective (pairwise) analytics/statistics based on the respective raw sensing measurements for some sensing tasks. It may compute one or more joint analytics/statistics, each based on respective two or more (e.g. some or all) of the pairwise analytics/statistics.

The respective wireless sensing signal may be a respective response signal (e.g. ACK) transmitted in response to reception of a respective initial signal (e.g. NDP, trigger signal, request signal, a signal that requires a response signal such as ACK, and/or a unicast signal) sent/transmitted from the active device to the respective passive device before the respective wireless sensing signal. The respective wireless sensing signal from the respective passive device may comprise a respective destination address but not a respective source address such that, upon receiving the respective wireless sensing signal, the active device may have difficulty identifying/knowing which of the plurality of passive devices sent it.

To enable the active device to identify which passive device transmits which wireless sensing signals, the active device may create/use/design/construct/customize/tailor-make a respective special/customized initial signal for each passive device (e.g. the trigger/probe signal with a respective special coded source address of the active device-specially created/customized for each passive device) to be transmitted to the passive device such that the respective wireless sensing signal (the response/ACK signal) transmitted by the passive device to the active device in response to the respective special/customized initial signal would be recognizable/recognized by the active device and the active device may identify the passive device as its source/originator based on the (destination address of) respective wireless sensing signal. For example, instead of using its own MAC address (of active device) as the source address of the special/customized initial signal, the active device may use a respective coded MAC address as the source address for each passive device. The active device may associate/map each coded MAC address with the respective passive device and store/keep/maintain the association/mapping in a memory (e.g. in a database, a look-up table, a list, a mapping). The active device may function in/work in/enter a “sniffer” mode, “monitor” mode or “promiscuous” mode in the Tier-k network (at least temporarily after transmitting the special/customized initial signals). It may monitor all the wireless communications/packets in the Tier-k network in search of any packets/wireless sensing signals with any of the coded MAC addresses as destination address (e.g. by comparing destination address in each packet with the coded MAC address stored in the memory). When a wireless sensing signal/packet with a recognized coded MAC address is received, the active device may use the database/lookup table/list/mapping to identify the originating passive device associated with the coded MAC address, obtain the raw wireless sensing measurement (e.g. CI, CSI, CIR, CFR) and associate it with the identified passive device. Multiple raw wireless sensing measurement associated with the same identified passive device can be gathered/together to form/construct/build/assemble a time series of measurement (e.g. a time series of CI/CSI/CIR/CFR).

When the active device does not receive the wireless sensing signal from the passive device in a time-out period after sending the initial signal to the passive device, the active device may transmit another initial signal.

The active device may be the Tier-k control device of the Tier-k network and the plurality of passive devices may be searched/found/identified/designated by the active device.

Alternatively, the active device may not be the Tier-k control device of the Tier-k network. The plurality of passive devices may be searched/found/identified/designated by the Tier-k control device. The pairing of the active device and each of the plurality of passive devices may be established/formed/designated by the Tier-k control device.

The active device may/may not be the Tier-k AP device, or the Tier-k Control device.

In some embodiments, a synchronization wireless signal (e.g. an announcement signal) may be communicated before the wireless sounding signal is transmitted from the sensing transmitter to the sensing receiver, or before raw sensing measurements/sensing results are reported. The synchronization wireless signal may be transmitted/received by any of: the sensing transmitter, the sensing receiver, sensing initiator, sensing responder, SBP/proxy sensing initiator device, associated Tier-k1 AP, associated Tier-k2 AP, Tier-k1/Tier-k2 control device, Tier-k1/Tier-k2 aggregator device, or another device.

In one embodiment, the WS-NON may be terminated. The sensing server may signal the Tier-1 Control (e.g. by sending a termination signal, possibly via internet/back-bone network) to terminate. The Tier-1 Control may signal one or more Tier-2 Control (e.g. by sending respective termination signal, possibly via Tier-1/Tier-2 Aggregators) to terminate. Recursively, a Tier-k Control may signal one (or more) Tier-(k+1) Control to terminate (e.g. by sending respective termination signal, possibly via Tier-k/Tier-(k+1) Aggregators). In another embodiment, the sensing server may signal all the Tier-k Control to terminate (by sending respective termination signal). Any Tier-k Control of a Tier-k network receiving the termination signal may signal other Tier-k sensing devices in the Tier-k network to terminate the sensing operations.

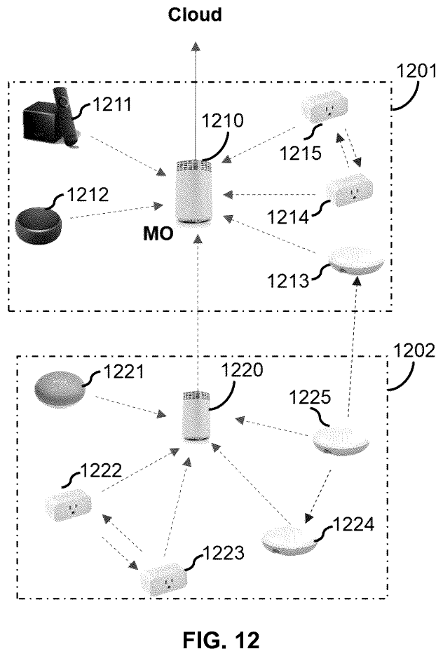

FIG. 12 illustrates an example system for performing wireless sensing in network of networks with inter-network sounding, according to some embodiments of the present disclosure.

As shown in FIG. 12, there may be a “Master Origin” (MO) device 1210 functioning/designated/configured as Tier-1 aggregator device. The MO device 1210 may/may not function as Tier-1 AP. The MO device 1210 may be configured by a sensing server in the cloud, or a Tier-1 AP if the MO device is not the Tier-1 AP. In some embodiments, the MO device 1210 may also function as a Tier-1 control device, a Tier-1 aggregator device, and/or a Tier-1 gateway device.

In the example shown in FIG. 12, there are five client devices (or bots) 1211, 1212, 1213, 1214, 1215 associated with the MO device 1210, forming a star configuration in a first wireless network 1201. The devices in the first wireless network 1201 may communicate with each other under a first set of network settings. An intra-network sounding may be performed between devices within the first wireless network 1201, e.g. between the MO device 1210 and one of the client devices 1211, 1212, 1213, 1214, 1215, or between two client devices in the first wireless network 1201, e.g. between the client device 1214 and the client device 1215.

In the example shown in FIG. 12, there is a second Origin 1220 functioning as the Tier-2 AP. Tier-2 control device, Tier-2 aggregator device and/or Tier-2 gateway device. The second Origin 1220 can ping the MO device 1210. There are five client devices (or bots) 1221, 1222, 1223, 1224, 1225 associated with the second Origin 1220, forming another star configuration in a second wireless network 1202. The devices in the second wireless network 1202 may communicate with each other under a second set of network settings different from the first set of network settings. For example, the first set of network settings and the second set of network settings may be different because they include at least one of: different carrier frequency bands, different bandwidths, different modulations, different standards, or different coverages. An intra-network sounding may be performed between devices within the second wireless network 1202, e.g. between the second Origin 1220 and one of the client devices 1221, 1222, 1223, 1224, 1225, or between two client devices in the second wireless network 1202, e.g. between the client device 1222 and the client device 1223.

In the example shown in FIG. 12, the Tier-2 client device 1225 in the second wireless network 1202 sends a sounding signal to the Tier-1 client device 1213 in the first wireless network 1201. This is an inter-network sounding between the two networks 1201, 1202 having different settings.

In some examples, a sensing server may know all the networking setting details (e.g. carrier frequency/frequency band/bandwidth) of the first wireless network 1201. The sensing server may inform the Tier-2 client device 1225 (associated with the second wireless network 1202) the networking setting details of the first wireless network 1201. With these networking setting details of the first wireless network 1201, the Tier-2 client device 1225 can listen to traffic of the first wireless network 1201. When the first wireless network 1201 has no traffic or a low traffic (lower than a predetermined threshold), the Tier-2 client device 1225 can ping the Tier-1 client device 1213 using the networking setting details of the first wireless network 1201.

In addition, a same device can perform both inter-network sounding and intra-network sounding. For example, the Tier-2 client device 1225 can send an inter-network sounding signal to the Tier-1 client device 1213, and can also send an intra-network sounding signal to the Tier-2 client device 1224.

In some embodiments, there may be multiple Origin devices (such as D10(MO), D21(O21), D22(O22), D31(O31), D41(O41) in FIG. 6) functioning/designated/configured as Tier-k AP/control/aggregator/gateway devices, for any k>=1. That is, for any k>=1, the WS-NON may comprise one or more Tier-k Origin devices, each being the Tier-k AP, Tier-k control device, Tier-k aggregator device and/or Tier-k gateway device in a respective Tier-k network.

While different Tier-k networks have different network settings for different k values, the WS-NON supports not only intra-network sounding within a same network, but also inter-network sounding between different networks. In some examples, a Tier-k client device can ping a Tier-(k−1) client device using the Tier-(k−1) network setting. In some examples, a Tier-(k−1) client device can ping a Tier-k client device using the Tier-k network setting.

In some embodiments, an intra-network sounding in links in a first network may cover a first zone in the venue very well, and an intra-network sounding in links in a second network may cover a second zone in the venue very well. However, some zones or areas between the first zone and the second zone may not be sensed well by either intra-network sounding. Instead, the in-between zones or areas may be better sensed using the inter-network sounding disclosed herein.

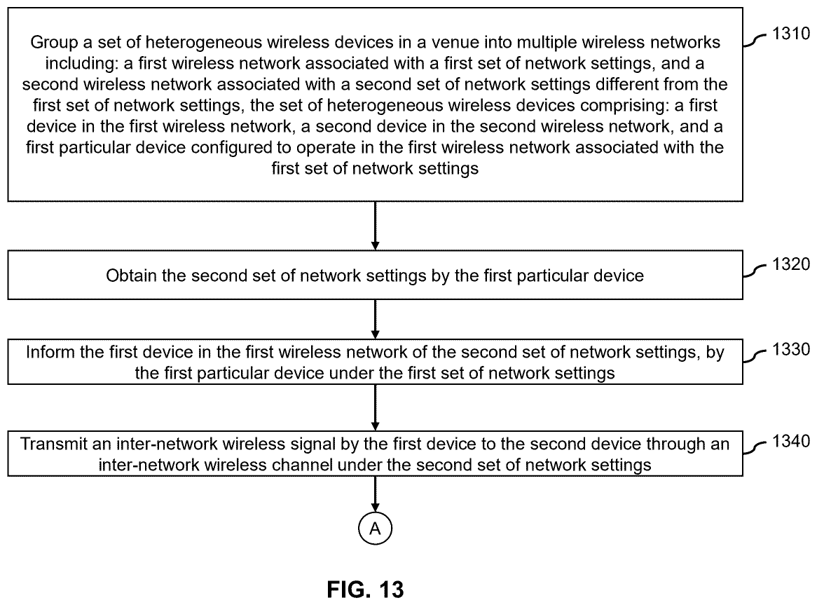

FIG. 13 illustrates a flow chart of an example method 1300 for performing inter-network sounding, according to some embodiments of the present disclosure. In various embodiments, the method 1300 can be performed by the systems disclosed above. At operation 1310, a set of heterogeneous wireless devices in a venue are grouped into multiple wireless networks including: a first wireless network associated with a first set of network settings, and a second wireless network associated with a second set of network settings different from the first set of network settings. The set of heterogeneous wireless devices comprise: a first device in the first wireless network, a second device in the second wireless network, and a first particular device configured to operate in the first wireless network associated with the first set of network settings. At operation 1320, the second set of network settings is obtained by the first particular device. At operation 1330, the first device in the first wireless network informed of the second set of network settings, by the first particular device under the first set of network settings. At operation 1340, an inter-network wireless signal is transmitted by the first device to the second device through an inter-network wireless channel under the second set of network settings. The order of the operations in FIG. 13 may be changed according to various embodiments of the present teaching.

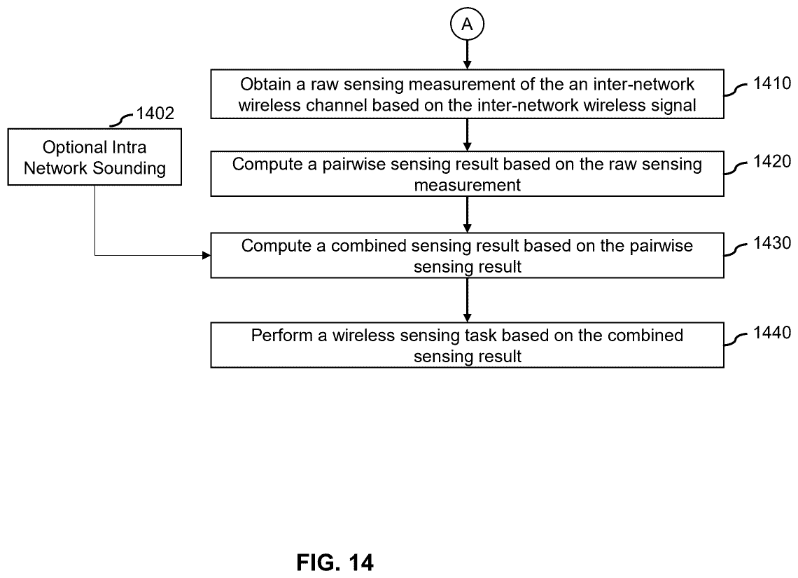

FIG. 14 illustrates a flow chart of an example method 1400 for performing wireless sensing in network of networks with inter-network sounding, according to some embodiments of the present disclosure. In various embodiments, the method 1400 can be performed by the systems disclosed above. At operation 1410, a raw sensing measurement of the inter-network wireless channel is obtained based on the inter-network wireless signal. At operation 1420, a pairwise sensing result is computed based on the raw sensing measurement. At operation 1430, a combined sensing result is computed based on the pairwise sensing result. Optionally, the combined sensing result is computed based on both the pairwise sensing result from the inter-network sounding following the process in FIG. 13, and a pairwise sensing result from an intra-network sounding 1402, which may follow the process in FIG. 8 (e.g. operations 802˜808). At operation 1440, a wireless sensing task is performed based on the combined sensing result. The order of the operations in FIG. 14 may be changed according to various embodiments of the present teaching.

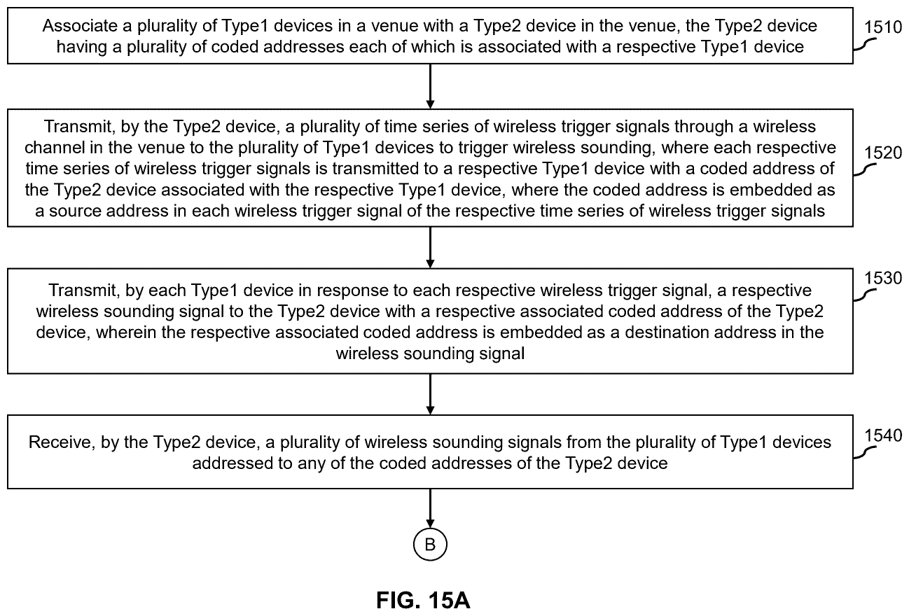

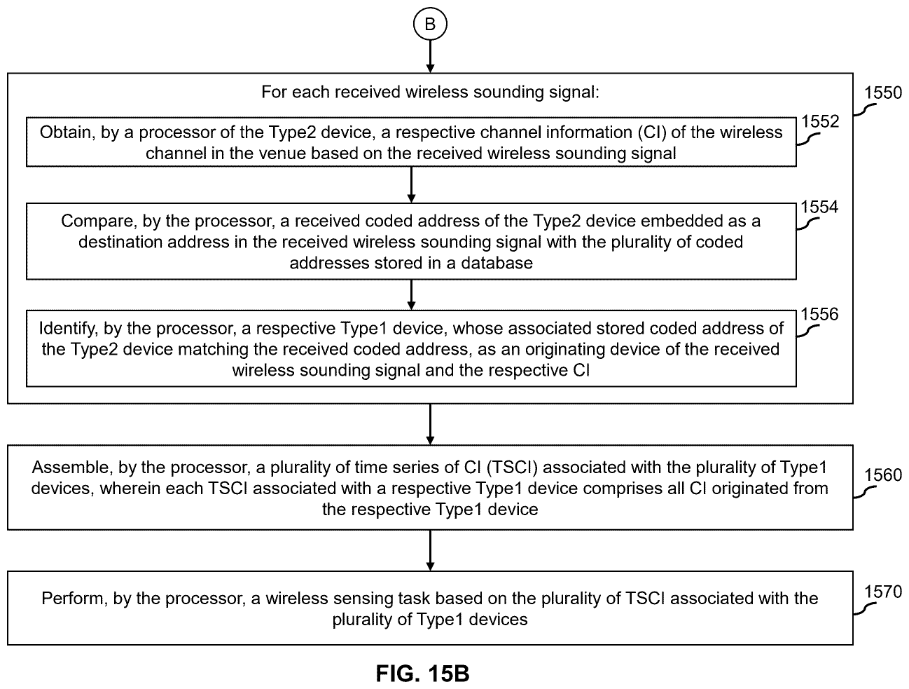

FIG. 15A and FIG. 15B illustrate a flow chart of an example method 1500 for performing wireless sensing with coded addresses, according to some embodiments of the present disclosure. In various embodiments, the method 1500 can be performed by the systems disclosed above. At operation 1510, a plurality of Type1 devices (each with a respective “real” address) in a venue is associated with a Type2 device (with a “real” address) in the venue. The Type2 device has/maintains a plurality of coded (i.e. not real) addresses for itself, which are different from its real address, and associates each with a respective Type1 device. At operation 1520, the Type2 device transmits a plurality of time series of wireless trigger signals through a wireless channel in the venue to the plurality of Type1 devices to trigger wireless sounding from the Type1 devices. Each respective time series of wireless trigger signals is transmitted to a respective Type1 device with a respective destination address being the real/unmodified address of the respective Type1 device and a respective source address being a respective coded/modified address of the Type2 device associated with the respective Type1 device. At operation 1530, each Type1 device transmits, in response to each respective wireless trigger signal, a respective wireless sounding signal to the Type2 device with respective destination address being the coded/modified address of the Type2 device (which is the respective source address in the respective wireless trigger signal). The wireless sounding signal may be a signal packet without source address (e.g. an ACK packet). In the absence of source address in the wireless sounding signal, the Type2 device may need a way to identify which of the Type1 devices is the source/originating Type1 device transmitting the wireless sounding signal (e.g. in order to identify/assemble/construct the TSCI associated with the source Type1 device). The Type2 device may decode the received coded/modified address to find out the source Type1 device. At operation 1540, the Type2 device receives a plurality of wireless sounding signals from the plurality of Type1 devices addressed to any of the coded addresses of the Type2 device.

The operation 1550 includes multiple sub-operations 1552˜1556 performed for each received wireless sounding signal, in this embodiment. At sub-operation 1552, a respective channel information (CI) of the wireless channel is obtained by a processor of the Type2 device in the venue based on the received wireless sounding signal. At sub-operation 1554, the processor compares the destination address embedded in the received wireless sounding signal, which is a received coded address of the Type2 device, with the plurality of coded addresses stored in a database. At sub-operation 1556, the processor identifies a respective Type1 device, whose associated stored coded address of the Type2 device matching the received coded address, as an originating/source device of the received wireless sounding signal and the respective CI. At operation 1560, the processor assembles a plurality of time series of CI (TSCI) associated with the plurality of Type1 devices. Each TSCI associated with a respective Type1 device comprises all CI originated from the respective Type1 device. At operation 1570, the processor performs a wireless sensing task based on the plurality of TSCI associated with the plurality of Type1 devices.

The following numbered clauses provide examples for wireless sensing in network of networks with inter-network sounding.

Clause F1. A system for wireless sensing, comprising: a set of heterogeneous wireless devices in a venue, wherein: the set of heterogeneous wireless devices comprise: a first device, a second device, and a first particular device, the first device in a first wireless network associated with a first set of network settings, the second device in a second wireless network associated with a second set of network settings different from the first set of network settings, the first particular device is configured to: operate in the first wireless network associated with the first set of network settings, obtain the second set of network settings, and inform the first device in the first wireless network of the second set of network settings under the first set of network settings, the first device is further configured to transmit an inter-network wireless signal to the second device through an inter-network wireless channel under the second set of network settings; and a processor configured for: obtaining a raw sensing measurement of the an inter-network wireless channel based on the an inter-network wireless signal, computing a pairwise sensing result based on the raw sensing measurement, and computing a combined sensing result based on the pairwise sensing result, wherein the set of heterogeneous wireless devices is configured to perform a wireless sensing task based on the combined sensing result.

Clause F2. The system of clause F1, wherein the first particular device is configured to: operate in the second wireless network associated with the second set of network settings.

Clause F3. The system of clause F2, wherein: the set of heterogeneous wireless devices further comprise a second particular device configured to operate in the second wireless network associated with the second set of network settings; and the first particular device is configured to obtain the second set of network settings from the second particular device.

Clause F4. The system of clause F3, wherein: the first set of network settings and the second set of network settings include at least one of: different carrier frequency bands, different bandwidths, different modulations, different standards, or different coverages.

Clause F5. The system of clause F4, wherein the first device is further configured to: listen to a traffic of the second wireless network under the second set of network settings; compare the traffic of the second wireless network to a predetermined threshold; and transmit the an inter-network wireless signal to the second device through the an inter-network wireless channel in accordance with a determination that the traffic of the second wireless network is lower than the predetermined threshold.

Clause F6. The system of clause F5, wherein: the first wireless network is associated with a first zone of the venue; the second wireless network is associated with a second zone of the venue; and the wireless sensing task is performed for a zone between the first zone and the second zone in the venue.

Clause F7. The system of clause F6, wherein: the set of heterogeneous wireless devices further comprise a third device in the first wireless network; the first device is further configured to transmit a first intra-network wireless signal to the third device through a first intra-network wireless channel under the first set of network settings; the third device is configured to obtain a first intra-network sensing measurement of the first intra-network wireless channel, and obtain a first intra-network sensing result computed based on the first intra-network sensing measurement; and the combined sensing result is computed based on the pairwise sensing result and the first intra-network sensing result.

Clause F8. The system of clause F7, wherein: the set of heterogeneous wireless devices further comprise a fourth device in the second wireless network; the fourth device is configured to transmit a second intra-network wireless signal to the second device through a second intra-network wireless channel under the second set of network settings; the second device is configured to obtain a second intra-network sensing measurement of the second intra-network wireless channel, and obtain a second intra-network sensing result computed based on the second intra-network sensing measurement; and the combined sensing result is computed based on an aggregation of: the pairwise sensing result, the first intra-network sensing result, and the second intra-network sensing result.

Clause F9. The system of clause F8, wherein: a protocol of the first wireless network or the second wireless network comprises at least one of: a WiFi standard, a UWB standard, a WiMax standard, an IEEE standard, an IEEE 802 standard, an IEEE 802.11 standard, an IEEE 802.11bf standard, an 802.15 standard, an 802.15.4 standard, or an 802.16 standard.

Clause F10. The system of clause F9, wherein: the inter-network wireless signal is transmitted based on a trigger signal received from an access point (AP) in the first wireless network, based on the protocol.

Clause F11. The system of clause F9, wherein: the inter-network wireless signal is transmitted based on a trigger signal received from an access point (AP) in the second wireless network, based on the protocol.

Clause F12. The system of clause F9, wherein: the set of heterogeneous wireless devices are grouped into N+1 groups, each group comprising a respective subset of the set of heterogeneous wireless devices; N is an integer greater than or equal to one; each heterogeneous wireless device is in at least one of the N+1 groups; the N+1 groups are arranged in a multi-tier group structure such that each group is associated with a respective wireless network at a corresponding tier; and each tier is associated with at least one group.

Clause F13. The system of clause F12, wherein: heterogeneous wireless devices in any Tier-k network are configured to report sensing results obtained in the Tier-k network to a respective heterogeneous wireless device in a Tier-(k−1) network via a gateway device between the Tier-k network and the Tier-(k−1) network; k is an integer greater than one; and the reported sensing results comprise at least one of: a combined sensing result, a pairwise sensing result, or a raw sensing measurement.

Clause F14. The system of clause F13, wherein: the first wireless network is associated with a Tier-k group of the N+1 groups; and the second wireless network is associated with a Tier-(k−1) group of the N+1 groups.

Clause F15. The system of clause F14, wherein the first particular device serves as at least one of: a Tier-k AP of the first wireless network associated with the Tier-k group; a Tier-k control device configured to search for and designate an unknown and available wireless device as a Tier-k sensing device in the first wireless network associated with the Tier-k group; a Tier-k aggregator device configured to aggregate sensing results from Tier-k and any tier higher than k; or a Tier-k gateway device configured to enable a communicative coupling of a device in the first wireless network associated with the Tier-k group with another device in another tier.

Clause F16. The system of clause F13, wherein: the first wireless network is associated with a Tier-(k−1) group of the N+1 groups; and the second wireless network is associated with a Tier-k group of the N+1 groups.

Clause F17. The system of clause F16, wherein the first particular device serves as at least one of: a Tier-(k−1) AP of the first wireless network associated with the Tier-(k−1) group; a Tier-(k−1) control device configured to search for and designate an unknown and available wireless device as a Tier-(k−1) sensing device in the first wireless network associated with the Tier-(k−1) group; a Tier-(k−1) aggregator device configured to aggregate sensing results from Tier-(k−1) and any tier higher than (k−1); or a Tier-(k−1) gateway device configured to enable a communicative coupling of a device in the first wireless network associated with the Tier-(k−1) group with another device in another tier.

Clause F18. The system of clause F13, wherein: a synchronization wireless signal is communicated between the first device in the first wireless network and the second device in the second wireless network, before the inter-network wireless signal is transmitted.

Clause F19. The system of clause F18, wherein: a synchronization wireless signal is communicated between the first wireless network and the second wireless network, before the sensing results are reported.

Clause F20. The system of clause F19, wherein the synchronization wireless signal is transmitted by one of: a sensing transmitter, a sensing receiver, a sensing initiator, a sensing responder, a proxy sensing initiator device, an associated AP, an associated control device, or an associated aggregator device.

Clause F21. The system of clause F20, wherein the first particular device is configured by at least one of: a cloud server or an AP of the first wireless network.

Clause A1. A method of wireless sensing using coded addresses to identify originating devices: generating and storing, by a processor of a Type2 heterogeneous wireless device in a venue, a plurality of coded addresses of the Type2 device; associating the plurality of coded addresses of the Type2 device with a plurality of Type1 heterogeneous wireless device in the venue, each coded address being associated with a respective Type1 device; transmitting, by the Type2 device, a plurality of wireless trigger signals through a wireless channel in the venue to the plurality of Type1 devices to trigger transmission of wireless sounding signals from the Type1 devices to the Type2 device, each wireless trigger signal transmitted to a respective Type1 device with a respective coded address of the Type2 device associated with the respective Type1 device embedded as respective source address in the wireless trigger signal; transmitting, by each Type1 device in response to respective wireless trigger signal, a respective wireless sounding signal to the Type2 device with the respective associated coded address of the Type2 device embedded as destination address in the wireless sounding signal; receiving, by the Type2 device, a plurality of wireless sounding signals from the plurality of Type1 devices addressed to any of the coded addresses of the Type2 device; for each received wireless sounding signal: obtaining, by the processor, a respective channel information (CI) of a wireless channel of the venue based on the received wireless sounding signal, comparing, by the processor, a received coded address of the Type2 device embedded as destination address in the received wireless sounding signal with the stored coded addresses of the Type2 device, and identifying, by the processor, a respective Type1 device, whose associated stored coded address of the Type2 device matching the received coded address, as an originating device of the received wireless sounding signal and the respective CI; performing, by the processor, a wireless sensing task based on the plurality of CI associated with the plurality of respective Type1 device.

Clause A2. The method of wireless sensing using coded addresses to identify originating devices of clause A1, further comprise: computing, by the processor, a plurality of pairwise sensing analytics associated with the plurality of Type1 devices based on the plurality of TSCI, each pairwise sensing result based on a respective TSCI; and performing the wireless sensing task based on the plurality of pairwise sensing analytics.

Clause A3. The method of wireless sensing using coded addresses to identify originating devices of clause A1, further comprising: storing in a database the association between each coded address of the Type2 device and an identity (ID) of the associated Type1 device.

Clause A4. The method of wireless sensing using coded addresses to identify originating devices of clause A1, wherein: different coded addresses are used for different passive devices.

Clause A5. The method of wireless sensing using coded addresses to identify originating devices of clause A1: wherein each of the wireless trigger signals and the wireless sounding signals is a unicast signal.

Clause A6. The method of wireless sensing using coded addresses to identify originating devices of clause A1, further comprising: transmitting, by the Type2 device, a plurality of time series of wireless trigger signals to the plurality of Type1 devices, each time series of wireless trigger signal transmitted to a respective Type1 device with the coded address of the Type2 device associated with the respective Type1 device embedded as source address in each wireless trigger signal in the time series of wireless trigger signals; transmitting, by each Type1 device in response to each respective wireless trigger signal, a respective wireless sounding signal to the Type2 device with the respective associated coded address of the Type2 device embedded as destination address in the wireless sounding signal; assembling, by the processor, a plurality of time series of CI (TSCI) associated with the plurality of Type1 devices, each TSCI associated with a respective Type1 device comprising all CI with identified originating Type1 device being the respective Type1 device; performing, by the processor, a wireless sensing task based on the plurality of TSCI associated with the plurality of respective Type1 device.

Clause A7. The method of wireless sensing using coded addresses to identify originating devices of clause A1, further comprising: generating the plurality of coded addresses of the Type2 device based on a reference address of the Type2 device.

Clause A8. The method of wireless sensing using coded addresses to identify originating devices of clause A7, further comprising: generating, by the processor, a plurality of encoding keys for encoding the reference address; and generating the plurality of coded addresses of the Type2 device by encoding the reference address with the plurality of encoding keys, each coded address generated by encoding the reference address with a respective encoding key.

Clause A9. The method of wireless sensing using coded addresses to identify originating devices of clause A8, wherein: the reference address is a MAC address of the Type2 device.

Clause A10. The method of wireless sensing using coded addresses to identify originating devices of clause A9, wherein: each coded address is a MAC address.

Clause A11. The method of wireless sensing using coded addresses to identify originating devices of clause A10, wherein: each coded address is a legitimate MAC address in proper MAC address format.

Clause A12. The method of wireless sensing using coded addresses to identify originating devices of clause A11, wherein: the Type2 device is configured to operate in an operating mode such that it monitors all the communications in a wireless network, wherein the operating mode comprises at least one of: a sniffer mode, a monitor mode, or a promiscuous mode.

Clause A13. The method of wireless sensing using coded addresses to identify originating devices of clause A12, wherein the Type2 device is configured to: monitor the destination address of each packet being communicated in the wireless network in search of communications to any of the coded addresses of the Type2 device; compare the destination address of the packet with all the stored coded addresses used as source addresses in the wireless trigger signals transmitted from the Type2 device to the plurality of Type1 devices; recognize the destination address as a particular coded address among those used for the Type1 devices based on the comparing.

Clause A14. The method of wireless sensing using coded addresses to identify originating devices of clause A13, wherein the Type2 device is configured to: for each stored coded address of the Type2 device generated using a respective encoding key, compute a testing decoded address by decoding the destination address based on a respective decoding key associated with the respective encoding key, compare the testing decoded address with the reference address of the Type2 device, recognize the particular coded address when the testing decoded address matches the reference address.

Clause A15. The method of wireless sensing using coded addresses to identify originating devices of clause A14, wherein: a part of an encoding key is generated randomly.

Clause A16. The method of wireless sensing using coded addresses to identify originating devices of clause A14, wherein: the respective decoding key is the respective encoding key.

Clause A17. The method of wireless sensing using coded addresses to identify originating devices of clause A11, wherein: one coded address is the reference address.

Clause A18. The method of wireless sensing using coded addresses to identify originating devices of clause A8, wherein: each coded address of the Type2 device is obtained by a reversible transformation of the reference address of the Type2 device based on the encoding key.

Clause A19. The method of wireless sensing using coded addresses to identify originating devices of clause A18, wherein: the reversible transformation comprise any of: a basic logical operation comprising one of: AND, OR, XOR, or negation, a grouping operation comprising one of: rotation, shifting, permutation, combination, scrambling, an addition, a subtraction, a multiplication, a division, an arrangement, a permutation, a combination, a bit-wise logical operation, a byte-wise logical operation, a word-wise logical operation, or a multi-byte logical operation.

Clause A20. A method of wireless sensing using coded addresses to identify originating devices: determining a reference address of a Type2 heterogeneous wireless device in a venue by a processor of the Type2 device based on a set of instructions; generating, by the processor, a plurality of encoding keys for encoding the reference address; generating, by the processor, a plurality of coded addresses of the Type2 device by encoding the reference address with the plurality of encoding keys, each coded address generated by encoding the reference address with a respective encoding key; associating the plurality of coded addresses of the Type2 device with a plurality of Type1 heterogeneous wireless device in the venue, each coded address being associated with a respective Type1 device; storing in a database the association between each coded addresses and an identity (ID) of the associated Type1 device; transmitting, by the Type2 device, a plurality of time series of wireless trigger signals through a wireless channel in the venue to the plurality of Type1 devices to trigger transmission of wireless sounding signals from the Type1 devices to the Type2 device, each time series of wireless trigger signals transmitted to a respective Type1 device with the coded address of the Type2 device associated with the respective Type1 device embedded as source address in each wireless trigger signal in the time series of wireless trigger signals; transmitting, by each Type1 device in response to each respective wireless trigger signal, a respective wireless sounding signal to the Type2 device with the respective associated coded address of the Type2 device embedded as destination address in the wireless sounding signal; receiving, by the Type2 device, a plurality of wireless sounding signals from the plurality of Type1 devices addressed to any of the coded addresses of the Type2 device; for each received wireless sounding signal: obtaining, by the processor, a respective channel information (CI) of a wireless channel of the venue based on the received wireless sounding signal, comparing, by the processor, a received coded address of the Type2 device embedded as destination address in the received wireless sounding signal with the stored coded addresses of the Type2 device in the database, and identifying, by the processor, a respective Type1 device, whose associated stored coded address of the Type2 device in the database matching the received coded address, as an originating device of the received wireless sounding signal and the respective CI; assembling, by the processor, a plurality of time series of CI (TSCI) associated with the plurality of Type1 devices, each TSCI associated with a respective Type1 device comprising all CI with identified originating Type1 device being the respective Type1 device; performing, by the processor, a wireless sensing task based on the plurality of TSCI associated with the plurality of respective Type1 device.

Clause B1. A method/system/device of device selection for wireless sensing, comprising: in a device selection phase, selecting for a wireless sensing task a first number of heterogeneous wireless sensing devices from a second number of heterogeneous wireless candidate devices based on a selection criterion by: communicating a first plurality of wireless sounding signals among the second number of candidate devices and a heterogeneous wireless active device in a wireless network, wherein each wireless sounding signal is transmitted either from a respective candidate device to the active device or from the active device to the respective candidate device, wherein any active device communicates with a sensing server, obtaining by a control device of the wireless network a first plurality of raw wireless sensing measurements of the wireless channel of the wireless network based on the first plurality of received wireless sounding signals, computing a task-specific selection score associated with the wireless sensing task for each of the second number of candidate devices based on the plurality of raw wireless sensing measurements, and comparing the second number of task-specific selection scores of all candidate devices, and selecting the first number of sensing devices from the second number of candidate devices based on a selection criterion associated with the comparison of the second number of task-specific selection scores of all candidate devices, wherein the first number is not greater than the second number; in a wireless sensing phase, performing the wireless sensing task using the active device and the first number by: communicating a second plurality of wireless sounding signals between the first number of sensing devices and the active device, wherein each wireless sounding signal is transmitted either from a respective sensing device to the active device or from the active device to the respective sensing device, obtaining a second plurality of raw wireless sensing measurements of the wireless channel of the wireless network based on the second plurality of received wireless sounding signals, computing a respective plurality of motion statistics based on raw wireless sensing measurements associated with each sensing device, perform the wireless sensing task based on all the motion statistics.

In some embodiments, device selection is decided by a control device (e.g. Tier-k control device) of the wireless network (e.g. Tier-k wireless network).

Clause B2. The method of device selection for wireless sensing of clause B1, further comprising: selecting the first number of sensing devices by a control device in the wireless network based on the selection criterion in the device selection phase.

Clause B3. The method of device selection for wireless sensing of clause B1 or clause B2, further comprising: selecting the first number of sensing devices based on a limitation of one of: the network, the active device, the candidate devices, the control device, or an access point of the network.

Clause B4. The method of device selection for wireless sensing of clause B3, further comprising: determining a quantity of the sensing devices to be the first number based on the limitation of the network.

Clause B5. The method of device selection for wireless sensing of clause B2, further comprising: discovering the second number of candidate devices in the wireless network by the control device.

Clause B6. The method of device selection for wireless sensing of clause B5, further comprising: discovering a network address of each of second number of candidate devices in the wireless network by the control device.

Clause B7. The method of device selection for wireless sensing of clause B5, further comprising: discovering an information of a particular candidate devices in the wireless network by the control device, wherein the information comprises at least one of: a network address, a MAC address, an internet protocol (IP) address, an identifier (ID), a network ID, a multicast ID, a service set ID (SSID), an association ID (AID), a unique ID (UID), a universally unique ID (UUID), a globally unique ID (GUID), an ASID, a USID, a label, a tag, a representation, an index, a name, a device product name, a host name, a client name, a identifying number, an alphanumeric ID, a brand, a model, a device ID, a vendor ID, a vendor class ID, a serial number, a host ID, or a client ID.

Clause B8. The method of device selection for wireless sensing of clause B2, further comprising: pairing each of the first number of sensing devices with the active device for the wireless sensing task by the control device; wherein each motion statistics associated with each sensing device is a pairwise motion statistics associated with the sensing device paired with the active device.

Clause B9. The method of device selection for wireless sensing of clause B8, further comprising: recording the pairing of each sensing device with the active device in a database by the control device.

Clause B10. The method of device selection for wireless sensing of clause B6, further comprising: configuring the active device by the control device to pair with each of the first number of sensing devices in the wireless sensing phase.

Clause B11. The method of device selection for wireless sensing of clause B8, further comprising: reporting the pairing of each sensing device with the active device to a sensing server.

Clause B12. The method of device selection for wireless sensing of clause B2, wherein: the active device is the control device.

Clause B13. The method of device selection for wireless sensing of clause B1, wherein: the active device is an access point device (AP) of the wireless network.

Clause C1. A system for wireless sensing, comprising: a set of heterogeneous wireless devices in a venue, wherein: the set of heterogeneous wireless devices comprise: a first device, and a second device, the first device is associated with a first wireless network and communicates with other devices in the first wireless network through a first wireless channel using a first set of channel settings of the first wireless network, the second device associated with a second wireless network and communicates with other devices in the second wireless network through a second wireless channel using a second set of channel settings of the second wireless network different from the first set of channel settings, the second device is not associated with the first wireless network, the second device in the second wireless network is configured to: obtain the first set of channel settings, and transmit an inter-network wireless signal directly to the first device in the first wireless network through the first wireless channel using the first set of channel settings, the first device in the first wireless network is configured to: receive the inter-network wireless signal directly from the second device through the first wireless channel, wherein the transmitted and received inter-network wireless signals are different due to a multipath environment of the first wireless channel and a motion of an object in the venue, obtain a first raw sensing measurement of the first wireless channel based on the received inter-network wireless signal, compute a first pairwise sensing result based on the first raw sensing measurement, and perform a wireless sensing task by monitor the motion of the object individually based on the first pairwise sensing result.

Clause C2. The system of clause C1, wherein: the set of heterogeneous wireless device further comprise a first particular device associated with the first wireless network; the first particular device of the first wireless network is configured to: receive pairwise sensing results computed locally by devices in the first wireless network based on respective raw sensing measurements of the first wireless channel obtained by the devices, compute a first combined sensing result based on the received pairwise sensing results computed locally in the first wireless network, wherein the received pairwise sensing results comprise the first pairwise sensing result, and perform the wireless sensing task by monitoring the motion of the object jointly based on the received pairwise sensing results computed locally in the first wireless network and the first combined sensing result.

Clause C3. The system of clause C2, wherein: the received pairwise sensing results comprise a pairwise sensing result computed by the first particular device based on raw sensing measurement of the first wireless channel obtained by the first particular device based on a received wireless signal.

Clause C4. The system of clause C2, wherein: any combined sensing result comprises a respective collection of respective sensing analytics.

Clause C5. The system of clause C2, wherein: the first particular device is further configured to: perform an analysis of the received pairwise sensing results computed locally in the first wireless network, and compute the combined sensing result of the first wireless network based on the analysis.

Clause C6. The system of clause C2, wherein: the first particular device is further configured to: receive other combined sensing results computed in a first set of other wireless networks, compute a first cumulative combined sensing result based on the received pairwise sensing results computed locally in the first wireless network, the first combined sensing result, and the received other combined sensing results computed in the first set of other wireless networks, perform the wireless sensing task by monitoring the motion of the object jointly based on the received pairwise sensing results computed locally in the first wireless network, the first combined sensing results, the received other combined sensing results computed in the first set of other wireless networks, and the first cumulative combined sensing result.

Clause C7. The system of clause C6, wherein: the set of heterogeneous wireless device further comprise a second particular device associated with the second wireless network; the second particular device of the second wireless network is configured to: receive pairwise sensing results computed locally by devices in the second wireless network based on respective raw sensing measurements of the second wireless channel obtained by the devices, and other combined sensing results computed in a second set of other wireless networks, compute a second combined sensing result based on the received pairwise sensing results computed locally in the second wireless network, compute a second cumulative combined sensing result based on the received pairwise sensing results computed locally in the second wireless network, the second combined sensing result, and the received other combined sensing results computed in the second set of other wireless networks, perform the wireless sensing task by monitoring the motion of the object jointly based on any of: the received pairwise sensing results computed locally in the second wireless network, the second combined sensing results, the received other combined sensing results computed in the second set of other wireless networks, and the second cumulative combined sensing result.

Clause C8. The system of clause C6, wherein: the second set of other wireless networks comprise the first wireless network, the other combined sensing results computed in the second set of other wireless networks comprise at least one of: the first combined sensing results or the first cumulative combined sensing results, the first particular device is further configured to report the first combined sensing results or the first cumulative combined sensing results to the second particular device.

Clause C9. The system of clause C6, wherein: the first set of other wireless networks comprise the second wireless network, the other combined sensing results computed in the first set of other wireless networks comprise at least one of: the second combined sensing results or the second cumulative combined sensing results, the second particular device is further configured to report the second combined sensing results or the second cumulative combined sensing results to the first particular device.

Clause C10. The system of clause C4, wherein: the first particular device is further configured to: perform an analysis of the received pairwise sensing results computed locally in the first wireless network, the first combined sensing result, and the received other combined sensing results computed in the other wireless networks, and compute the first cumulative combined sensing result based on the analysis.

Clause C11. The system of clause C2, wherein: the set of heterogeneous wireless devices comprise: a third device and a fourth device, both the third device and the fourth devices are associated with the second wireless network, the third device is configured to transmit an intra-network wireless signal to the fourth device through the second wireless channel using the second set of channel settings. the fourth device is configured to: receive the intra-network wireless signal from the third device through the second wireless channel, wherein the transmitted and received intra-network wireless signals are different due to the multipath environment of the second wireless channel and the motion of the object in the venue, obtain a second raw sensing measurement of the second wireless channel based on the received intra-network wireless signal, compute a second pairwise sensing result based on the second raw sensing measurement, and perform a wireless sensing task by monitor the motion of the object individually based on the second pairwise sensing result, the second pairwise sensing result is one of the any other pairwise sensing results computed by devices in the second wireless network such that the combined sensing result is computed based on the second pairwise sensing results.

Clause C 12. The system of clause C6, wherein: the second device is one of: the third device or the fourth device.

Clause C13. The system of clause C2, wherein: the set of heterogeneous wireless devices comprise: a fifth device and a sixth device, both the fifth device and the sixth devices are associated with the first wireless network, the fifth device is configured to transmit an intra-network wireless signal to the sixth device through the first wireless channel using the first set of channel settings, the sixth device is configured to: receive the intra-network wireless signal from the fifth device through the first wireless channel, wherein the transmitted and received intra-network wireless signals are different due to the multipath environment of the first wireless channel and the motion of the object in the venue, obtain a third raw sensing measurement of the first wireless channel based on the received intra-network wireless signal, compute a second pairwise sensing result based on the second raw sensing measurement, and perform a wireless sensing task by monitor the motion of the object individually based on the second pairwise sensing result, the second pairwise sensing result is one of the any other pairwise sensing results computed by devices in the second wireless network such that the combined sensing result is computed based on the second pairwise sensing results.

Clause C 14. The system of clause C6, wherein: the first device is one of: the fifth device or the sixth device such that it participates in wireless sensing using both inter-network sound and intra-network.

Clause C15. The system of clause C1, further comprises a first particular device associated with the first wireless network, wherein: a processor of the first particular device is configured to: compute a combined sensing result based on the pairwise sensing result computed by the second device and any other pairwise sensing results computed by devices in the second wireless network based on respective raw sensing measurements of the second wireless channel obtained by the devices, and perform the wireless sensing task by monitoring the motion of the object jointly based on all the pairwise sensing results computed in the second wireless network and the combined sensing results.

Clause C16. The system of clause C1, wherein: the first set of channel settings and the second set of channel settings include at least one of: different carrier frequency bands, different bandwidths, different modulations, different standards, or different coverages.

Clause C17. The system of clause C11, wherein the first device is further configured to: listen to a traffic of the second wireless network under the second set of network settings; compare a quantity of the traffic of the second wireless network to a predetermined threshold; and transmit the inter-network wireless signal to the second device through the second wireless channel in accordance with a determination that the quantity of the traffic of the second wireless network is lower than the predetermined threshold.

Clause C18. The system of clause C12, wherein: the venue is partitioned into zones associated with the wireless networks; the first wireless network is associated with a first zone of the venue for which the wireless sensing task is performed based on the pairwise sensing results computed by devices in the first wireless network; the second wireless network is associated with a second zone of the venue for which the wireless sensing task is performed based on pairwise sensing results computed by devices in the second wireless network; and the first device of the first wireless network and the second device of the second wireless network is associated with a third zone of the venue, between the first zone and the second zone, for which the wireless sensing task is performed based on the pairwise sensing results computed based on the inter-network wireless signal communicated between the first device and the second device.

Clause C19. The system of clause C13, wherein: the venue is partitioned into overlapping zones; the first zone and the second zone overlap in the third zone.

Clause C20. The system of clause C7, further comprising: a sensing server, wherein: the first device, the second device, the first particular device and the second particular device are active sensing devices that are communicatively coupled with the sensing server, and are configured by the sensing server.

Clause C21. The system of clause C20, wherein: the first device is configured to report the first pairwise sensing result to a first particular device in the first wireless network.

Clause C22. The system of clause C20, wherein: a respective sensing software is downloaded from the sensing server into each of the first and second devices.

Clause C23. The system of clause C22, wherein: the respective downloaded sensing software in each of the first and second devices is updated by the sensing server.

Clause C24. The system of clause C7, further comprising: a sensing server, wherein: both first device, the second device, the first particular device and the second particular device are communicatively coupled with the sensing server, both the first and second devices and both the first and second particular devices are configured by the sensing server.

Clause C25. The system of clause C1, wherein: a protocol of the first wireless network or the second wireless network comprises at least one of: a WiFi standard, a UWB standard, a WiMax standard, an IEEE standard, an IEEE 802 standard, an IEEE 802.11 standard, an IEEE 802.11bf standard, an 802.15 standard, an 802.15.4 standard, or an 802.16 standard.

Clause C26. The system of clause C1, wherein: the inter-network wireless signal is transmitted based on a trigger signal received from one of: an access point (AP) or a controller device of the system in one of: the first wireless network, or the second wireless network, based on the protocol.

Clause C27. The system of clause C1, wherein: the set of heterogeneous wireless devices are grouped into N+1 groups, each group comprising a respective subset of the set of heterogeneous wireless devices; N is an integer greater than or equal to one; each heterogeneous wireless device is in at least one of the N+1 groups; the N+1 groups are arranged in a multi-tier group structure such that each group is associated with a respective wireless network at a corresponding tier; and each tier is associated with at least one group.

Clause C28. The system of clause C27, wherein: heterogeneous wireless devices in any Tier-k network are configured to report sensing results obtained in the Tier-k network to a respective heterogeneous wireless device in a Tier-(k−1) network via a gateway device between the Tier-k network and the Tier-(k−1) network; k is an integer greater than one; and the reported sensing results comprise at least one of: a combined sensing result, a pairwise sensing result, or a raw sensing measurement.

Clause C29. The system of clause C28, wherein: the first wireless network is associated with a Tier-k group of the N+1 groups; and the second wireless network is associated with a Tier-(k−1) group of the N+1 groups.

Clause C30. The system of clause C29, wherein the first particular device serves as at least one of: a Tier-k AP of the first wireless network associated with the Tier-k group; a Tier-k control device configured to search for and designate an not-yet-known wireless device as a Tier-k sensing device in the first wireless network associated with the Tier-k group; a Tier-k aggregator device configured to aggregate sensing results from Tier-k and any tier higher than k; or a Tier-k gateway device configured to enable a communicative coupling of a device in the first wireless network associated with the Tier-k group with another device in another tier.

Clause C31. The system of clause C28, wherein: the first wireless network is associated with a Tier-(k−1) group of the N+1 groups; and the second wireless network is associated with a Tier-k group of the N+1 groups.

Clause C32. The system of clause C31, wherein the first particular device serves as at least one of: a Tier-(k−1) AP of the first wireless network associated with the Tier-(k−1) group; a Tier-(k−1) control device configured to search for and designate a not-yet-known wireless device as a Tier-(k−1) sensing device in the first wireless network associated with the Tier-(k−1) group; a Tier-(k−1) aggregator device configured to aggregate sensing results from Tier-(k−1) and any tier higher than (k−1); or a Tier-(k−1) gateway device configured to enable a communicative coupling of a device in the first wireless network associated with the Tier-(k−1) group with another device in another tier.

Clause C33. The system of clause C28, wherein: a synchronization wireless signal is communicated between the first device in the first wireless network and the second device in the second wireless network, before the inter-network wireless signal is transmitted.

Clause C34. The system of clause C33, wherein: a synchronization wireless signal is communicated between the first wireless network and the second wireless network, before the sensing results are reported.

Clause C35. The system of clause C34, wherein the synchronization wireless signal is transmitted by one of: a sensing transmitter, a sensing receiver, a sensing initiator, a sensing responder, a proxy sensing initiator device, an associated AP, an associated control device, or an associated aggregator device.

Clause C36. The system of clause C35, wherein the first particular device is configured by at least one of: a cloud server or an AP of the first wireless network.

Clause C37. A method for wireless sensing, comprising: grouping a set of heterogeneous wireless devices in a venue into multiple wireless networks including: a first wireless network associated with a first set of network settings, and a second wireless network associated with a second set of network settings different from the first set of network settings, wherein: the set of heterogeneous wireless devices comprise: a first device in the first wireless network, a second device in the second wireless network, and a first particular device configured to operate in the first wireless network associated with the first set of network settings; obtaining the second set of network settings by the first particular device; informing the first device in the first wireless network of the second set of network settings, by the first particular device under the first set of network settings; transmitting an inter-network wireless signal by the first device to the second device through an inter-network wireless channel under the second set of network settings; obtaining a raw sensing measurement of the an inter-network wireless channel based on the an inter-network wireless signal; computing a pairwise sensing result based on the raw sensing measurement; computing a combined sensing result based on the pairwise sensing result; and performing a wireless sensing task based on the combined sensing result.

The features described above may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language (e.g., C. Java), including compiled or interpreted languages, and it may be deployed in any form, including as a stand-alone program or as a module, component, subroutine, a browser-based web application, or other unit suitable for use in a computing environment.

Suitable processors for the execution of a program of instructions include, e.g., both general and special purpose microprocessors, digital signal processors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

While the present teaching contains many specific implementation details, these should not be construed as limitations on the scope of the present teaching or of what may be claimed, but rather as descriptions of features specific to particular embodiments of the present teaching. Certain features that are described in this specification in the context of separate embodiments may also be implemented in combination in a single embodiment. Conversely, various features that are described in the context of a single embodiment may also be implemented in multiple embodiments separately or in any suitable sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

Particular embodiments of the subject matter have been described. Any combination of the features and architectures described above is intended to be within the scope of the following claims. Other embodiments are also within the scope of the following claims. In some cases, the actions recited in the claims may be performed in a different order and still achieve desirable results. In addition, the processes depicted in the accompanying figures do not necessarily require the particular order shown, or sequential order, to achieve desirable results. In certain implementations, multitasking and parallel processing may be advantageous.

We claim:

1. A method for wireless sensing using coded addresses to identify originating devices, comprising:
associating a plurality of Type1 devices in a venue with a Type2 device in the venue, wherein:
each of the plurality of Type1 devices is a heterogeneous wireless device having a first type,
the Type2 device is a heterogeneous wireless device having a second type different from the first type,
the Type2 device has a plurality of coded addresses each of which is associated with a respective Type1 device of the plurality of Type1 devices;
transmitting, by the Type2 device, a plurality of time series of wireless trigger signals through a wireless channel in the venue to the plurality of Type1 devices to trigger wireless sounding, wherein:
each respective time series of wireless trigger signals is transmitted to a respective Type1 device with a coded address of the Type2 device associated with the respective Type1 device,
the coded address is embedded as a source address in each wireless trigger signal of the respective time series of wireless trigger signals;
transmitting, by each Type1 device in response to each respective wireless trigger signal, a respective wireless sounding signal to the Type2 device with a respective associated coded address of the Type2 device, wherein the respective associated coded address is embedded as a destination address in the wireless sounding signal;
receiving, by the Type2 device, a plurality of wireless sounding signals from the plurality of Type1 devices addressed to any of the coded addresses of the Type2 device;
for each received wireless sounding signal:
obtaining, by a processor of the Type2 device, a respective channel information (CI) of the wireless channel in the venue based on the received wireless sounding signal,
comparing, by the processor, a received coded address of the Type2 device embedded as a destination address in the received wireless sounding signal with the plurality of coded addresses stored in a database, and
identifying, by the processor, a respective Type1 device, whose associated stored coded address of the Type2 device matching the received coded address, as an originating device of the received wireless sounding signal and the respective CI;
assembling, by the processor, a plurality of time series of CI (TSCI) associated with the plurality of Type1 devices, wherein each TSCI associated with a respective Type1 device comprises all CI originated from the respective Type1 device; and
performing, by the processor, a wireless sensing task based on the plurality of TSCI associated with the plurality of Type1 devices.

2. The method of claim 1, further comprising:
generating the plurality of coded addresses of the Type2 device based on a reference address of the Type2 device.

3. The method of claim 2, further comprising:
generating, by the processor, a plurality of encoding keys for encoding the reference address; and
generating the plurality of coded addresses of the Type2 device by encoding the reference address with the plurality of encoding keys, wherein each coded address is generated by encoding the reference address with a respective encoding key.

4. The method of claim 3, wherein:
the reference address is a MAC address of the Type2 device.

5. The method of claim 4, wherein:
each coded address is a legitimate MAC address in a proper MAC address format.

6. The method of claim 5, further comprising:
configuring the Type2 device to operate in an operating mode to monitor all communications in a wireless network,
wherein the operating mode comprises at least one of: a sniffer mode, a monitor mode, or a promiscuous mode.

7. The method of claim 6, further comprising:
monitoring, by the Type2 device, a destination address of each packet being communicated in the wireless network in search of communications to any of the coded addresses of the Type2 device;
comparing, by the Type2 device, the destination address of the packet with all stored coded addresses that are used as source addresses in the wireless trigger signals transmitted from the Type2 device to the plurality of Type1 devices; and
recognizing, by the Type2 device, the destination address as a particular coded address among those coded addresses used as the source addresses based on the comparing.

8. The method of claim 7, further comprising:
for each stored coded address of the Type2 device generated using a respective encoding key,
computing, by the Type2 device, a testing decoded address by decoding the destination address based on a respective decoding key associated with the respective encoding key,
comparing, by the Type2 device, the testing decoded address with the reference address of the Type2 device, and
recognizing, by the Type2 device, the particular coded address when the testing decoded address matches the reference address.

9. The method of claim 8, wherein:
at least a part of an encoding key is generated randomly.

10. The method of claim 8, wherein:
the respective decoding key is the same as the respective encoding key.

11. The method of claim 3, wherein:
each coded address of the Type2 device is generated by a reversible transformation of the reference address of the Type2 device based on the respective encoding key.

12. The method of claim 11, wherein the reversible transformation comprises at least one of:
a basic logical operation comprising one of: AND, OR, XOR, or negation,
a grouping operation comprising one of: rotation, shifting, permutation, combination, scrambling,
an addition, a subtraction, a multiplication, a division, an arrangement, a permutation, a combination, a bit-wise logical operation, a byte-wise logical operation, a word-wise logical operation, or a multi-byte logical operation.

13. The method of claim 1, wherein:
each of the wireless trigger signals and the wireless sounding signals is a unicast signal.

14. A wireless device in a venue, comprising:
a data storage storing a plurality of coded addresses of the wireless device, wherein:
the wireless device is associated a plurality of Type1 devices in the venue,
each of the plurality of Type1 devices is a heterogeneous wireless device having a first type,
the wireless device is a Type2 device having a second type different from the first type,
each of the plurality of coded addresses is associated with a respective Type1 device of the plurality of Type1 devices;
a transmitter configured to transmit a plurality of time series of wireless trigger signals through a wireless channel in the venue to the plurality of Type1 devices to trigger wireless sounding, wherein:
each respective time series of wireless trigger signals is transmitted to a respective Type1 device with a coded address of the Type2 device associated with the respective Type1 device,
the coded address is embedded as a source address in each wireless trigger signal of the respective time series of wireless trigger signals;
a receiver configured to receive a plurality of wireless sounding signals from the plurality of Type1 devices addressed to any of the coded addresses of the Type2 device, wherein:
a respective wireless sounding signal is received, from each Type1 device in response to each respective wireless trigger signal, with a respective associated coded address of the Type2 device,
the respective associated coded address is embedded as a destination address in the respective wireless sounding signal; and
a processor communicatively coupled to the data storage, the transmitter and the receiver, and configured to:
for each received wireless sounding signal:
obtain a respective channel information (CI) of the wireless channel in the venue based on the received wireless sounding signal,
compare a received coded address of the Type2 device embedded as a destination address in the received wireless sounding signal with the plurality of coded addresses stored in the data storage, and
identify a respective Type1 device, whose associated stored coded address of the Type2 device matching the received coded address, as an originating device of the received wireless sounding signal and the respective CI,
assemble a plurality of time series of CI (TSCI) associated with the plurality of Type1 devices, wherein each TSCI associated with a respective Type1 device comprises all CI originated from the respective Type1 device, and
perform a wireless sensing task based on the plurality of TSCI associated with the plurality of Type1 devices.

15. The wireless device of claim 14, wherein the processor is configured to:
generate a plurality of encoding keys for encoding a reference address of the Type2 device; and
generate the plurality of coded addresses of the Type2 device by encoding the reference address with the plurality of encoding keys, wherein:
each coded address is generated by encoding the reference address with a respective encoding key,
the reference address is a MAC address of the Type2 device, and
each coded address is a legitimate MAC address in a proper MAC address format.

16. The wireless device of claim 15, wherein the processor is configured to:
operate in an operating mode to monitor all communications in a wireless network, wherein the operating mode comprises at least one of: a sniffer mode, a monitor mode, or a promiscuous mode;
monitor a destination address of each packet being communicated in the wireless network in search of communications to any of the coded addresses of the Type2 device;
compare the destination address of the packet with all stored coded addresses that are used as source addresses in the wireless trigger signals transmitted from the Type2 device to the plurality of Type1 devices; and
recognize the destination address as a particular coded address among those coded addresses used as the source addresses based on the comparing.

17. The wireless device of claim 15, wherein:
each coded address of the Type2 device is generated by a reversible transformation of the reference address of the Type2 device based on the respective encoding key; and
the reversible transformation comprises at least one of:
a basic logical operation comprising one of: AND, OR, XOR, or negation,
a grouping operation comprising one of: rotation, shifting, permutation, combination, scrambling,
an addition, a subtraction, a multiplication, a division, an arrangement, a permutation, a combination, a bit-wise logical operation, a byte-wise logical operation, a word-wise logical operation, or a multi-byte logical operation.

18. A system for wireless sensing, comprising:
a plurality of Type1 devices in a venue, wherein each of the plurality of Type1 devices is a heterogeneous wireless device having a first type; and
a Type2 device in the venue, wherein:
the Type2 device is a heterogeneous wireless device having a second type different from the first type,
the Type2 device has a plurality of coded addresses each of which is associated with a respective Type1 device of the plurality of Type1 devices,
the Type2 device is configured to transmit a plurality of time series of wireless trigger signals through a wireless channel in the venue to the plurality of Type1 devices to trigger wireless sounding,
each respective time series of wireless trigger signals is transmitted to a respective Type1 device with a coded address of the Type2 device associated with the respective Type1 device,
the coded address is embedded as a source address in each wireless trigger signal of the respective time series of wireless trigger signals,
each Type1 device is configured to transmit, in response to each respective wireless trigger signal, a respective wireless sounding signal to the Type2 device with a respective associated coded address of the Type2 device,
the respective associated coded address is embedded as a destination address in the respective wireless sounding signal,
wherein the Type2 device is configured to:
receive a plurality of wireless sounding signals from the plurality of Type1 devices addressed to any of the coded addresses of the Type2 device,
for each received wireless sounding signal:
obtain a respective channel information (CI) of the wireless channel in the venue based on the received wireless sounding signal,
compare a received coded address of the Type2 device embedded as a destination address in the received wireless sounding signal with the plurality of coded addresses stored in a database, and
identify a respective Type1 device, whose associated stored coded address of the Type2 device matching the received coded address, as an originating device of the received wireless sounding signal and the respective CI,
assemble a plurality of time series of CI (TSCI) associated with the plurality of Type1 devices, wherein each TSCI associated with a respective Type1 device comprises all CI originated from the respective Type1 device, and
perform a wireless sensing task based on the plurality of TSCI associated with the plurality of Type1 devices.

19. The system of claim 18, wherein the Type2 device is configured to:
generate a plurality of encoding keys for encoding a reference address of the Type2 device; and
generate the plurality of coded addresses of the Type2 device by encoding the reference address with the plurality of encoding keys, wherein:
each coded address is generated by encoding the reference address with a respective encoding key,
the reference address is a MAC address of the Type2 device,
each coded address is a legitimate MAC address in a proper MAC address format,
each coded address of the Type2 device is generated by a reversible transformation of the reference address of the Type2 device based on the respective encoding key, and
the reversible transformation comprises at least one of:
a basic logical operation comprising one of: AND, OR, XOR, or negation,
a grouping operation comprising one of: rotation, shifting, permutation, combination, scrambling,
an addition, a subtraction, a multiplication, a division, an arrangement, a permutation, a combination, a bit-wise logical operation, a byte-wise logical operation, a word-wise logical operation, or a multi-byte logical operation.

20. The system of claim 18, wherein the Type2 device is configured to:
operate in an operating mode to monitor all communications in a wireless network, wherein the operating mode comprises at least one of: a sniffer mode, a monitor mode, or a promiscuous mode;
monitor a destination address of each packet being communicated in the wireless network in search of communications to any of the coded addresses of the Type2 device;
compare the destination address of the packet with all stored coded addresses that are used as source addresses in the wireless trigger signals transmitted from the Type2 device to the plurality of Type1 devices; and
recognize the destination address as a particular coded address among those coded addresses used as the source addresses based on the comparing.
